(19) United States
(12) Patent Application Publication
(10) Pub. No.: US 2024/0167348 A1
(43) Pub. Date: May 23, 2024

(54) SMART SOLIDS CONTROL SYSTEM

(71) Applicant: Derrick Corporation, Buffalo, NY (US)

(72) Inventors: David A. Iiams, Katy, TX (US); Michael Dykalski, Cypress, TX (US)

(21) Appl. No.: 18/426,697

(22) Filed: Jan. 30, 2024

Related U.S. Application Data
(63) Continuation-in-part of application No. 16/931,242, filed on Jul. 16, 2020.
(60) Provisional application No. 62/874,853, filed on Jul. 16, 2019.
(60) Provisional application No. 63/442,740, filed on Feb. 1, 2023.

(51) Int. Cl. E21B 21/06; E21B 44/00; E21B 49/00

(52) U.S. Cl. CPC E21B 21/065; E21B 44/00; E21B 49/005

(57) ABSTRACT

A system for identifying a potential current or future issue in a well drilling system includes one or more sensors on a material separation system that processes materials generated by the well drilling system. The material separation system may include a vibratory screening machine. A sensor of the system may be configured to measure an acceleration of a portion of a machine that separates solids from liquids. Alternatively, the sensor of the system may be configured to measure a property of the solid-liquid mixture, the first solids-containing component and/or the shaker effluent. The system attempts to correlate well drilling operations to changes in the conditions experienced by the material separation system. When well drilling operations do not correlate to sensed changes in the conditions experienced by the material separation system, an alert is issued.

This application is a continuation-in-part of U.S. application Ser. No. 16/931,242, filed Jul. 16, 2020, which itself claims priority to the Jul. 16, 2019 filing date of U.S. Provisional Application No. 62/874,853. This application also claims priority to the Feb. 1, 2023 filing date of U.S. Provisional Patent Application No. 63/442,740. The contents of all of the foregoing applications are incorporated herein by reference.

### BACKGROUND

The invention relates to systems and methods for identifying when actual problems are occurring in a drilling operation, or when conditions indicate that a potential future problem may arise in a well drilling operation.

In the past, well drilling operators were provided with some guidelines or algorithms that could be used to determine when a well drilling problem has arisen or when a potential problem might soon arise. The input to those guidelines and algorithms typically included data relating to the drilling rig itself, such as rotational speed, pressure on the drill bit and various other parameters. The input to the guidelines and algorithms sometimes also included general observations made regarding the quantity and quality of the cuttings or material being pumped out of the well as drilling operations occur.

The point of comparing drilling operations to the cuttings and material arriving at the surface is to determine if an anomalous or problem condition has occurred or is soon likely to occur. If the cuttings and material arriving at the surface do not correlate well to the drilling operations, this can be an indication that there is a problem with the well drilling operations.

Because of the delay that occurs between when a drill bit cuts material at the bottom of the well and when that material arrives at the surface, it is often difficult to correlate the cuttings and material arriving at the surface when the drilling operations that occurred when the cuttings were made. Also, it can be difficult for well drilling operators to make reliable judgments about the quantity and quality of the material and cuttings leaving the well. These factors, together, make it difficult to correlate the well drilling operations that give rise to certain cuttings and material and the actual cuttings and material arriving at the surface.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 illustrates a perspective view of a vibratory screening machine with installed replaceable screen assemblies, according to an example embodiment.

FIG. 2 illustrates a perspective view of a vibratory screening machine with installed replaceable screen assemblies, according to an example embodiment.

FIG. 3 shows a schematic illustration of a centrifuge with an automatic sampling and control system, according to an example embodiment.

FIG. 4 is a schematic illustration of a solids control system including vibratory shaker machines and a centrifuge, according to an example embodiment.

FIG. 5 is a matrix of measured properties in relation to various cost metrics, according to an example embodiment.

FIG. 6 is a matrix of measured properties in relation to various cost metrics, according to an example embodiment.

FIG. 7 is a matrix of external input data in relation to various cost metrics, according to an example embodiment.

FIG. 8 illustrates a sub-system for measuring fluid effluent of a vibratory shaker component of a solids control system, according to an example embodiment.

FIG. 9 illustrates a sub-system for measuring fluid effluent of a centrifuge component of a solids control system, according to an example embodiment.

FIG. 10 illustrates a combined sub-system including the sub-systems shown in FIGS. 8 and 9, according to an example embodiment.

FIG. 11 illustrates a sub-system for measuring solids removed from a shaker component of a solids control system, according to an example embodiment.

FIG. 12 illustrates a sub-system for measuring solids removed from a centrifuge component of a solids control system, according to an example embodiment.

FIG. 13 illustrates a combined sub-system including the subsystems shown in FIGS. 11 and 12, according to an example embodiment.

FIG. 14 illustrates a complete solids control system, according to an example embodiment.

FIG. 15 is a flowchart illustrating a processor implemented method, according to an example embodiment.

FIG. 16 is a block diagram of an example computer system, in which disclosed embodiments may be implemented, according to an embodiment.

FIG. 17 is a transparent perspective view of an eccentric vibrator apparatus, according to an example embodiment.

FIG. 18 is a transparent side view of an eccentric vibrator apparatus, according to an example embodiment.

FIG. 19 is a side view of a vibratory system, according to an example embodiment.

FIG. 20 is a diagram of a vibratory system, according to an example embodiment.

FIG. 21 is a schematic illustration of an eccentric vibrator apparatus coupled to a control system, according to an example embodiment.

FIG. 22 is a schematic illustration of an eccentric vibrator apparatus coupled to a control system, according to an example embodiment.

FIG. 23 is a schematic illustration of a vibrator apparatus coupled to a control system, according to an example embodiment.

FIG. 24 illustrates time-dependent forces between mass members of an eccentric vibrator apparatus for a first mode of vibration, according to an example embodiment.

FIG. 25 illustrates time-dependent forces between mass members of an eccentric vibrator apparatus for a second mode of vibration, according to an example embodiment.

FIG. 26 illustrates time-dependent forces between mass members of an eccentric vibrator apparatus for a third mode of vibration, according to an example embodiment.

FIG. 27 illustrates time-dependent forces between mass members of an eccentric vibrator apparatus for a fourth mode of vibration, according to an example embodiment.

FIG. 28 illustrates a schematic representation of a system configured to generate data and visual representations associated with drilling mud quality and efficiency, in accordance with some embodiments.

FIG. 29 is a schematic representation of computing resources configured to generate data and visual representations associated with drilling mud quality and efficiency, in accordance with some embodiments.

FIG. 30 illustrates a sample data flow schematic, according to some embodiments.

FIG. 31 illustrates an example process flow for the system, according to some embodiments.

FIG. 32 illustrates an example user interface for a solids control system, in accordance with some embodiments.

FIG. 33 illustrates an example user interface for a solids control system, in accordance with some embodiments.

FIG. 34 illustrates an example user interface for a solids control system, in accordance with some embodiments.

FIG. 35 illustrates an example user interface for a solids control system, in accordance with some embodiments.

FIG. 36A illustrates a perspective view of a vibratory screening machine with installed replaceable screen assemblies and acceleration sensors, according to an example embodiment.

FIG. 36B shows a schematic illustration of a centrifuge with an automatic sampling and control system and acceleration sensors, according to an example embodiment.

FIG. 37 shows a solids control system including vibratory screening machines and centrifuges that illustrates how the flow of materials through the solids control system can be balanced based on accelerometer signals and information on the torque being applied to the centrifuges.

FIG. 38 is a block diagram of an example system for training a machine learning model to make inferences regarding well performance, in accordance with some embodiments.

FIG. 39 is a block diagram of an example system for making inferences regarding well performance using a trained machine learning model, in accordance with some embodiments.

FIG. 40 is a flow diagram of an example method for training a machine learning model to make inferences regarding well performance, in accordance with some embodiments.

FIG. 41 is a diagram of a system that analyzes trends in data to identify anomalous or problematic conditions in a well drilling rig.

FIG. 42 is a table that illustrates correlations between anomalous or problematic drilling conditions and trends in reported sensor data.

FIG. 43 illustrates a cycle of reporting sensor data, analyzing the data to identify and report problems in a well drilling rig and to identify corrective action, and taking corrective actions based on the identified problems.

FIG. 44 illustrates steps of a first method of identifying an actual or potential problem with a well drilling operation.

FIG. 45 illustrates steps of a second method of identifying an actual or potential problem with a well drilling operation.

### DETAILED DESCRIPTION

This disclosure generally relates to methods and systems that control material separation systems. Materials to be separated may include solid-liquid mixtures that include liquid materials having various particulates disbursed therein. Vibratory screening machines and centrifuges are used in the mining and oil and gas industries, for example, to separate such materials. When drilling an oil well, for example, a slurry material (also known as “drilling mud”) may be used to lubricate drill bits and to remove cuttings. One or more shaker machines may be used to remove cuttings and sediment that may accumulate in the slurry. As material flows over a screen of a vibratory screening machine, particles that are smaller than screening openings pass through the screen along with liquid contained in the slurry. Thus, a first vibratory screening machine may be used to remove particles having sizes greater than screen openings. As such, a vibratory screening machine may be used to alter a particle size distribution in a slurry. In one or more additional stages, additional vibratory shaker machines may be used to further alter the particle size distribution of the slurry by removing further particles according to a size of screen openings.

For some operations, it may be advantageous to remove still smaller particles that cannot be removed using a vibratory shaker machine. In such a situation, a centrifuge may be used to further remove smaller particulate materials. In an example, a slurry may contain both low-gravity solids (LGS) and high-gravity solids (HGS). The LGS may have a density of approximately 2.6 g/cm3, and may correspond to cuttings and material that is ground by a drill bit. The LGS may include a particle distribution that may be specified in terms of a size threshold. For example, the LGS may include a first component having particles that are larger than or equal to 75 μm, and a second component having particles that are smaller than 75 μm. According to an embodiment, the first component of the LGS may be removed using a vibratory shaker machine. The second component of the LGS may be removed using a centrifuge. Additional material, including HGS, may also be removed using a centrifuge.

HGS include dense solids that may be added to the slurry to increase its density. For example, HGS may include barite (i.e., BaSO₄), having a density of approximately 4.2 g/cm³, or hematite (i.e., Fe₂O₃), having a density of approximately 5.5 g/cm³. Barite and hematite particles, as used to adjust the density of a slurry, are typically ground to have a particle size in a range from approximately 3 μm to 74 μm. In a barite recovery operation, a centrifuge may be used to remove barite while leaving other smaller-sized particles. Given a particle size distribution including barite and other lower-gravity materials, a centrifuge may be run at first rotational speed that is effective in removing barite particles. In a further operation, the centrifuge may then be run at a second speed, which is greater than the first speed, to remove smaller particles including LGS. In an example embodiment, barite particles having 53 μm, 45 μm, 38 μm, etc., particle sizes may be removed using a first rotational speed of a centrifuge. Smaller particles may then be removed by operating the same centrifuge at a higher rotational speed. In alternate embodiments, a second centrifuge may be utilized to remove still further particles from the slurry.

According to one or more embodiments, a separation system may include one or more vibratory shaker devices and/or one or more centrifuges. Each device may be used to remove a specific component of the slurry. As described in greater detail below, such a multi-component system has a number of parameters that may be controlled to produce desired results in terms of the quality of separated material, operating costs, etc. According to embodiments, a control system for a separation system is provided. The control system identifies and measures a plurality of operating parameters and adjusts control parameters to optimize operation of the system according to various metrics. Operation metrics may include overall cost in terms of power consumption, material costs, waste removal costs, labor costs, repair costs, etc., as described in greater detail below.

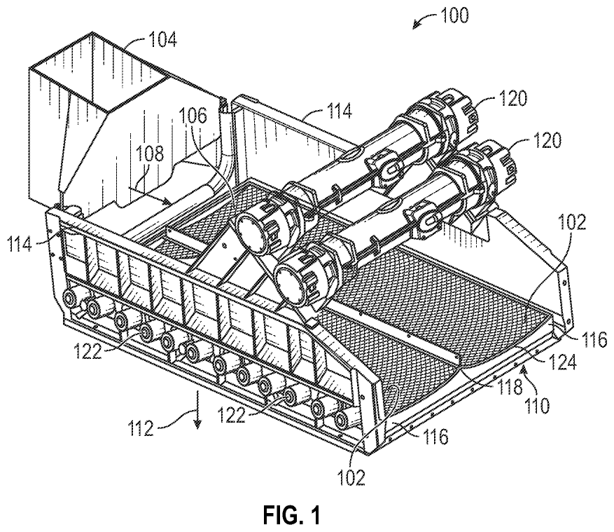

FIG. 1 illustrates a perspective view of a vibratory screening machine 100 with installed replaceable screen assemblies 102, according to an example embodiment. In this example, material is fed into a feeder 104 and is thereby directed onto a top surface 106 of the screen assemblies 102. The material travels in a flow direction 108 toward an end 110 of vibratory screening machine 100. Material flowing in direction 108 is contained within the concave configuration provided by the screen assemblies 102 and is prevented from exiting the sides of screen assemblies 102.

Material that is undersized and/or fluid passes through screen assemblies 102 onto a separate discharge material flow path 112 for further processing by another vibratory screening machine, by a centrifuge, etc. Materials that are oversized exit end 110. The material to be screened may be dry, a slurry, etc., and screen assemblies 102 may be pitched downwardly from the feeder 104 toward opposite end 110 in direction 108 to assist with the feeding of the material. In further embodiments, screen assemblies 102 may be pitched upwardly from feeder 104 and/or feeder 104 may provide material at a different location along screen assemblies 102. For example, feeder 104 may be positioned to deposit material in a middle portion of screen assemblies 102 or to deposit material in another location on screen assemblies 102 in other embodiments.

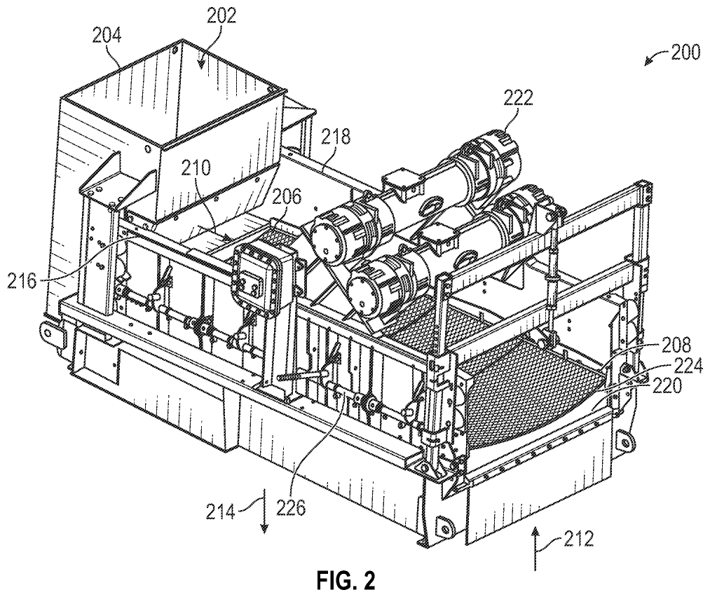

In this example, vibratory screening machine 100 includes wall members 114, concave support surfaces 116, a central member 118, vibrational motors 120, and compression assemblies 122. Support surfaces 116 may have a concave shape and include similarly shaped mating surfaces 124. Compression assemblies 122, which in this example are attached to an exterior surface of wall members 114, may impart a compressive force to screen assemblies 102, to thereby hold screen assemblies 102 in place, in contact with support surfaces 116. Vibrational motors 120 may impart a vibrational motion to screen assemblies 102 that acts to enhance the screening process. Central member 118 divides vibratory screening machine 100 into two concave screening areas. In other embodiments, vibratory screening machines 100 may have one concave screening area with compression assemblies 122 arranged on one wall member as shown, for example, in FIG. 2 and described in greater detail below.

Vibrational motors 120 may include various eccentric vibrator systems that may produce substantially linear, elliptical, and/or circular vibrations, as disclosed in U.S. patent application Ser. No. 16/279,838, the contents of which is incorporated herein by reference in its entirety. Such systems may generate respective substantially linear sinusoidal forces that cause substantially linear vibrations or may change an angle of motion and an acceleration of a screening machine. In one example, a slurry (e.g., a semi-liquid mixture) may be dewatered and/or conveyed along a vibrating screen of the screening machine under the influence of vibratory motion. The slurry may be transformed from a liquid-solid mixture to a dewatered solid. To increase dryness of the material, disclosed embodiments allow a conveyance angle of the system to be adjusted, which increases liquid removal from the mixture.

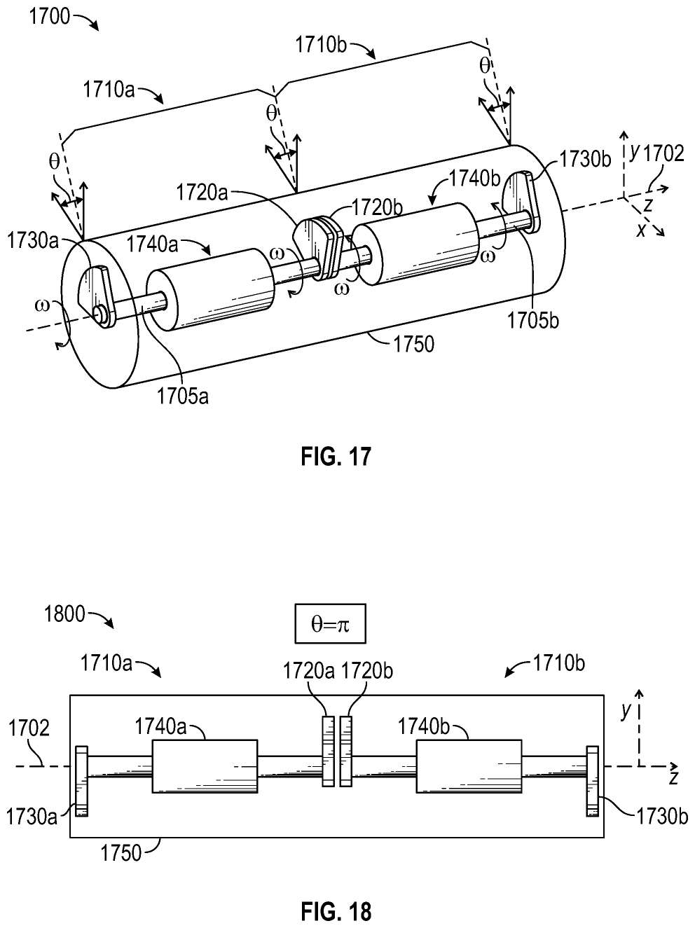

For example, the conveyance angle may be increased from 45° to 60°. An increased angle may reduce a flow rate of material moving upward on a screening surface, thereby allowing more time for liquid to be driven from the mixture. Similarly, vibrational acceleration of the system may be increased to increase removal of the liquid. Alternatively, vibrational acceleration may be decreased, causing less liquid to be removed, if a wetter discharge is desired. In dry screening applications, vibration of the material may also be increased to reduce an occurrence of stuck particles in the vibrating surface (i.e., to reduce screen blinding). In further embodiments, it may be advantageous to change a vibrational motion from a linear motion, to an elliptical motion, to a circular motion, etc., as described in greater detail below with reference to FIGS. 17 to 27.

FIG. 2 shows a perspective view of a vibratory screening machine 200 with installed replaceable screens assemblies having a single concave screening area, according to an example embodiment. Material 202 to be screened may be fed into a feeder 204 which directs the material onto a top surface 206 of screen assemblies 208. Material deposited by feeder 204 travels in flow direction 210 toward an end 212 of vibratory screening machine 200. Material is prevented from exiting the sides of screen assemblies 208 by the concave shape of screen assemblies 208 and by wall members 216 and 218, as described in greater detail below.

Material that is undersized and/or fluid passes through the screen assemblies 208 onto a separate discharge material flow path 214 for further processing. Materials that are oversized exit end 212. Material to be screened may be dry, a slurry, etc., and screen assemblies 208 may be pitched downwardly from the feeder 204 toward opposite end 212 in the direction 210 to assist with feeding of the material. In further embodiments, screen assemblies 208 may be pitched upwardly from feeder 204 and/or feeder 204 may provide material at a different location along screen assemblies 208. For example, feeder 204 may be positioned to deposit material in a middle portion of screen assemblies 208 or to deposit material in another location on screen assemblies 208 in other embodiments.

Vibratory screening machine 200 includes a first wall member 216, a second wall member 218, concave support surfaces 220, a vibratory motor 222, screen assemblies 208, and a compression assembly 226. Support surfaces 220 have a concave shape and include mating surfaces 224. Compression assemblies 226, which in this example are attached to an exterior surface of wall member 216, may impart a compressive force to screen assemblies 208 to thereby hold screen assemblies 208 in place in contact with mating surface 224 of support surfaces 220.

Vibratory motor 222 may be configured to cause screen assemblies 208 to vibrate to enhance screening. Compression assembly 226 may be attached to an exterior surface of the first wall member 216 or second wall member 218. Vibratory screening machine 200, shown in FIG. 2, has a single concave screening area. In further embodiments, vibratory screening machines may have multiple concave screening areas. While vibratory screening machine 200 is shown with multiple longitudinally oriented screen assemblies 208 creating a concave material pathway, screen assemblies 208 are not limited to such a configuration and may be otherwise oriented. Additionally, multiple screening assemblies 208 may be provided to form a concave screening surface, as shown in FIGS. 1 and 2.

FIGS. 1 and 2 illustrate two example vibratory screening machines. Further embodiments may be configured for use with various vibratory screening machines and parts thereof, including machines designed for wet and dry applications, machines having multi-tiered decks and/or multiple screening baskets, and machines having various screen attachment arrangements such as tensioning mechanisms (e.g., under-mount and over-mount tensioning mechanisms), compression mechanisms, clamping mechanisms, magnetic mechanisms, etc. For example, embodiments may include vibratory screening machines as described in U.S. Pat. Nos. 7,578,394; 6,820,748; 6,669,027; 6,431,366; and 5,332,101.

Screen assemblies may include: side portions or binder bars including U-shaped members configured to receive over-mount type tensioning members, for example, as described in U.S. Pat. No. 5,332,101; side portions or binder bars including finger receiving apertures configured to receive under-mount type tensioning, for example, as described in U.S. Pat. No. 6,669,027; side members or binder bars for compression loading, for example, as described in U.S. Pat. No. 7,578,394; or may be configured for attachment and loading on multi-tiered machines, for example, such as the machines described in U.S. Pat. No. 6,431,366. Screen assemblies and/or screening elements may also be configured to include features described in U.S. Pat. No. 8,443,984, including guide assembly technologies described therein and pre-formed panel technologies described therein. Screen assemblies and screening elements may further be configured to be incorporated into embodiments including pre-screening technologies that are compatible with the mounting structures and screen configurations described in U.S. Pat. No. 8,439,203.

The disclosure of each of U.S. Pat. Nos. 8,439,984; 8,439,203; 7,578,394; 7,228,971; 6,820,748; 6,669,027; 6,431,366; 5,332,101; 4,882,054; and 4,857,176, and the patents and patent applications referenced in these documents, is hereby incorporated by reference in its entirety. Various other screening machines may be included in other embodiments as needed for specific applications.

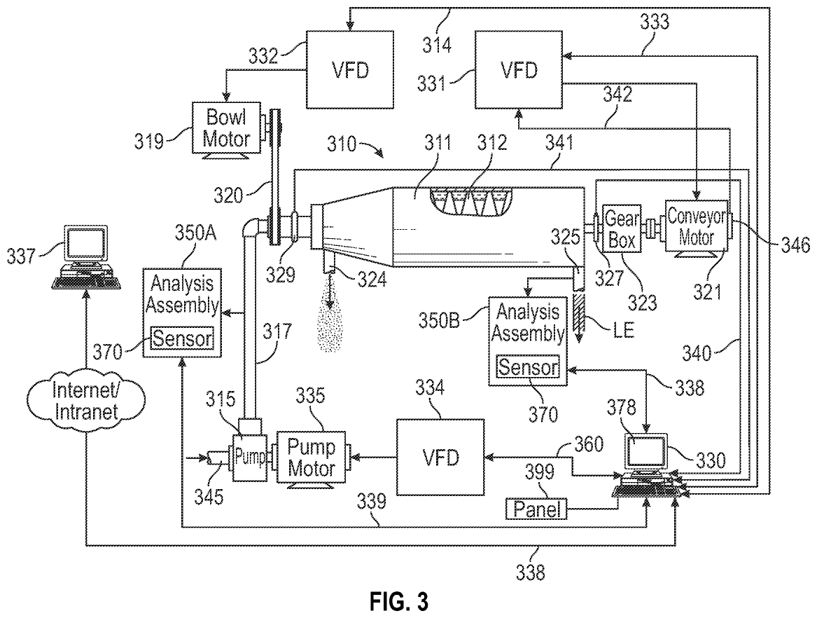

FIG. 3 is a schematic representation of a centrifuge 310 with an automatic sampling and control system, according to an example embodiment. Centrifuge 310 may be a decanter style centrifuge. In this example, centrifuge 310 includes a bowl 311, a screw conveyor 312, a pump 315, a bowl drive motor 319, a screw conveyor drive motor 321, and a pump motor 335. Centrifuge 310 may further include a bowl variable frequency drive (VFD) system 332 that is operatively arranged to drive bowl drive motor 319; a conveyor VFD system 331 that is operatively arranged to drive screw conveyor drive motor 321; a pump VFD system 334 that is operatively arranged to drive the pump drive motor; and at least one computer or processor circuit 330 electrically and operationally connected to bowl VFD 332, conveyor VFD 331, and the pump VFD 334.

Conveyor drive motor 321 may be coupled to conveyor 312 via gearbox 323. Centrifuge 310 may be configured to receive a slurry via conduit 345 connected to pump 315. Pump 315 may be configured to pump the slurry to bowl 311 via conduit 317. Bowl 311 may be driven by bowl motor 319 via pulley arrangement 320, and screw conveyor 312 may be driven by conveyor motor 321 via gear box 323. HGS, which are separated from the slurry, may be discharged from centrifuge 310 through conduit 324. The remaining portions of the slurry (liquid effluent LE) may be ejected from centrifuge 310 via conduit 325. Bowl 311 may be supported by bearings 327 and 329, which may have sensors in communication with computer or processor circuit 330 via lines 340 and 341, respectively.

A speed of conveyor motor 321 and direction information may be calculated by VFD 331 and may be communicated to conveyor VFD 331 via line 342. Line 333 provides a communication link between conveyor VFD 331 and computer or processor circuit 330. Conveyor VFD 331, bowl VFD 332, and pump VFD 334 may communicate with computer or processor circuit 330 over a communication network, for example, using lines 333, 314, and 360, respectively. Many different types of wired and wireless communication networks may be used. A remote computer 337 may be linked to computer 330 by a communication channel, including, but not limited to hardwire line 338 or by a wireless channel. In this regard, troubleshooting or operation of centrifuge 310 may be monitored and controlled from a remote location.

In an example embodiment, a computer or processor circuit 330 may include a display device 378. Computer or processor circuit 330 may be configured to provide control signals to centrifuge 310 and to control various parameters of centrifuge 310 such as a recommended liquid level (i.e., a pond level) of centrifuge 310. Various parameters and operating status data may be displayed on display device 378. In certain embodiments, an operator may interface directly with computer 330, via a local operator control panel 399, or via remote computer 337 with a remote internet or intranet connection to computer or processor circuit 330. In this way, an operator may monitor and control centrifuge 310 while on site or to monitor centrifuge 310 remotely from an off-site location. Additional hardware may allow remote visual monitoring of centrifuge 310 from an off-site location or from an on-site in situations where components of the apparatus may be difficult to access.

Centrifuge 310 may include an analysis assembly 350A connected to conduit 317 that connects pump 315 and bowl 311. Analysis assemblies 350A and 350B may include sensors 370 that are electrically and operationally connected to computer or processor circuit 330, for example, via lines 339. Analysis assembly 350A may be configured to automatically sample a slurry that is pumped through conduit 317 to bowl 311, and to automatically transmit data, characterizing the sampled slurry, to computer or processor circuit 330. Similarly, analysis assembly 350B may be configured to automatically sample an effluent flowing through conduit 325, and to automatically transmit data, characterizing the sampled effluent, to computer or processor circuit 330.

Disclosed embodiments may include a centrifuge and centrifuge control systems such as the embodiments described in U.S. Pat. No. 9,283,572, the disclosure of which is incorporated by reference herein in its entirety. Further embodiments may combine a vibratory shaker machine, such as shown in FIG. 1 or 2, with a centrifuge, such as shown in FIG. 3, as described in greater detail below.

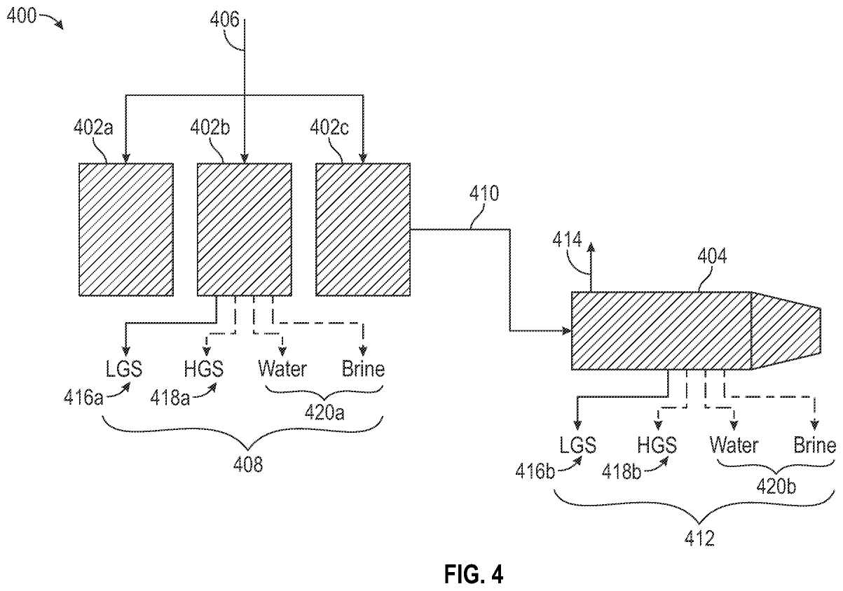

FIG. 4 is a schematic illustration of a solids control system 400 including shaker machines 402a, 402b, and 402c, and a centrifuge 404, according to an example embodiment. A slurry (e.g., a drilling mud) may be fed to shaker machines 402a, 402b, and 402c along an input path 406. Various solids may be removed by shaker machines 402a, 402b, and 402c along a first output path 408 (for simplicity, an output path is only shown for shaker machine 402b). A shaker liquid effluent, including a liquid and solids not removed by shaker machines 402a, 402b, and 402c, may leave shaker machines 402a, 402b, and 402c along a second output path 410. Further solids may be removed by centrifuge 404 and may leave centrifuge 404 along a third output path 412. A centrifuge liquid effluent, including a liquid and solids not removed by centrifuge 404, may leave centrifuge 404 along a fourth output path 414.

Various parameters of shaker machines 402a, 402b, and 402c and centrifuge 404 may be adjusted to optimize performance of solids control system 404 according to various metrics, as described in greater detail below. For example, solids control system 400 may be used to remove some solids and liquids from a slurry while leaving other solids and liquids that may be recovered as the shaker liquid effluent and/or the centrifuge liquid effluent. For example, it may be desirable to remove LGS (416a and 416b) while leaving HGS (418a and 418b).

As described above, LGS 416a and 416b, may have a density of approximately 2.6 g/cm³, and may correspond to cuttings and material that is ground by a drill bit. LGS may include a first component 416a having particles that are larger than or equal to 75 μm, and a second component 416b having particles that are smaller than 75 μm. According to an embodiment, first component 416a of the LGS may be removed using a vibratory shaker machine and second component 416b of the LGS may be removed using centrifuge 404. Efficient removal of LGS allows slurry to be recycled. As such, removal of LGS represents a cost savings relative to replacement costs of slurry that would otherwise need to be replaced.

As described above, slurry generally includes a certain amount of HGS that is intentionally added to the slurry to adjust the density of the slurry. For example, HGS in the form of barite or hematite may be intentionally added to the slurry. Therefore, it is important to adjust operating parameters of vibratory shaker machines 402a, 402b, and 402c, and to adjust operating parameters of centrifuge 404 to avoid removal of HGS. HGS 418a that is removed by shaker machines 402a, 402b, and 402c, or HGS 418b that is removed by centrifuge 404, therefore, may represent a net incurred cost associated with replacement of removed HGS 418a and 418b. Removal of other components of slurry, such a water and brine, 420a and 420b, may further represent a net incurred cost if the resulting shaker effluent and/or centrifuge effluent becomes too dry. In such situations, it may be necessary to add further liquids to adjust the fluidic properties of the resulting effluent.

A controller for system 400 may adjust operating parameters to efficiently remove certain components (e.g., LGS 416a and 416b) while leaving other components (e.g., HGS 418a and 418b, water, and brine 420a and 420b). Various cost metrics that govern operation of system 400 may be defined. Cost metrics may depend on various measured parameters and control parameters that govern the system, as described in greater detail below. Disclosed embodiments provide a control system that optimizes performance of system 400 based on the various cost metrics and dependence of the cost metrics on measured parameters and control parameters.

TABLE 1
angle of shaker screen frame
shape of shaker motion
amplitude of shaker motion
frequency of shaker motion
size of screen apertures
screen wire thickness
screen panel non-blanked surface area
flow rate of material over screen

Table 1, above, provides a list of shaker control parameters, according to an example embodiment. As described above with reference to FIGS. 1 and 2, a vibratory shaker may be used to separate particulate materials from a slurry. The size of screen apertures is an important shaker parameter that acts to modify a particle size distribution. In this regard, liquids and particles that are smaller than a screen aperture pass through the screen apertures and remain with the shaker effluent. Particles that are larger than screen apertures are removed from the slurry and are collected from a screening surface. As slurry flows across a screening surface, a frequency, an amplitude and shape of shaker motion governs screening efficiency. Further, a flow rate of material passing over the screen may have an effect on screening efficiency. For example, if the flow rate is too fast, more of the particulate matter may not have sufficient time to be properly screened. As such, reducing the flow rate may improve screening efficiency. In certain applications, such as with drilling an oil or gas well, it may not be possible to control the rate of flow to the shaker. In such operations, several shakers may be employed. For slow to moderate flow, one or more shakers may be employed with increasing numbers of shakers used as flow increases.

As mentioned above, a screen angle of a vibratory screening machine may be adjustable. In certain embodiments, as the vibratory screening machine vibrates, removed solids may vibrate in such a way that they gradually move up an incline of the screening surface. As removed solids move up the screening surface they generally lose liquid and thereby become drier. As such, the degree of dryness may be affected by the screen angle, as described in greater detail below with reference to Table 5. As also described below, a rate at which solids are removed from a slurry may be determined, in part, by a shaker screen angle.

TABLE 2
solids content
slurry rheology
particle size distribution
dryness of removed solids
maximum flow rate
rate of screen degradation
power consumption

Table 2, above, provides a list of shaker measured parameters, according to an example embodiment. Various measurements may be performed to determine properties of the initial slurry, the shaker effluent, and the centrifuge effluent. Parameters may include solids content and particle size distributions of dispersed solids. One parameter of interest is a distribution of solids in terms of mass fractions of LGS, HGS, water, brine, oil, and other components. As mentioned above, it may be desirable to remove LGS while leaving HGS in the effluent. HGS may include barite, hematite, or other heavy solid particulate material that is added to a slurry to adjust the density of the slurry. Often, in an operation to recycle a slurry, LGS, which may represent drill cuttings and other sediment, may be removed from the slurry while HGS, such as barite, hematite, etc., may remain in the slurry. In other operations, it may also be useful to recover HGS material, if needed, for example, to reduce the density of the recycled slurry.

Recovered solids generally are not completely dry and, therefore, have a certain amount of an associated fluid component. The fluid may include water, brine, oil, etc. When such recovered solids are discarded, the liquid component is also discarded. As such, the discarded liquid component may represent an incurred cost if the liquid is otherwise a useful component of the slurry. As such, the dryness of removed solids is a parameter that may factor into operation costs, as described in greater detail below.

As mentioned above, with reference to Table 1, the angle of a screening surface may affect screening efficiency relative to a flow rate of material across a screen. As such, a maximum rate at which solids may be removed from the slurry may be affected by the angle of the screen. A rate of screen degradation may also be affected by other parameters. For example, screens with smaller apertures tend to degrade more quickly than screens with larger apertures. Further, when operating a vibratory screening machine with a variable angle, the screen may degrade at a rate that is dependent on the screening angle, as described in greater detail below. Power consumption is another parameter to consider when operating a vibratory screening machine. For example, under certain operating conditions, it may be more efficient to run a vibratory screening machine continuously at a slower speed rather than operating it at a higher speed but only for certain time intervals.

TABLE 3
bowl speed
conveyor speed
pump speed
conveyor/bowl differential speed
radius of weir plates

Table 3, above, provides a list of centrifuge control parameters, according to an example embodiment. The parameters include a bowl speed, a conveyor speed, a pump speed, and a differential speed of relative conveyor/bowl motion. A further parameter may include a radius of weir plates. A pond level of fluid in the centrifuge may be adjusted by changing the radius of weir plates. Various performance metrics of the centrifuge may be adjusted by controlling parameters, such as those listed in Table 3.

TABLE 4
torque load
density
viscosity
turbidity
solids content
particle size distribution
flow rate
pond depth
power consumption

Table 4, above, provides a list of centrifuge measured parameters, according to an example embodiment. Measured parameters that characterize material separation processes of the centrifuge include density, viscosity, turbidity, solids content, and particle size distribution. Flow rate of material fed to the centrifuge, along with bowl speed and conveyor speed governs a degree to which materials are separated from the effluent. Pond depth generally affects dryness of the separated solids, and overall power consumption of the centrifuge is related to bowl speed, conveyor speed, pump speed, and torque load. As described in greater detail below, torque load may be controlled by controlling a speed of relative conveyor/bowl motion.

An imposed change in a control parameter generally induces a change in a measured parameter. In turn, a change in a first measured parameter may further induce a change as second, a third, etc., measured parameter. Table 5, below, summarizes relationships between measured and control parameters for a shaker machine while Table 6, below, summarizes relationships between measured and control parameters for a centrifuge.

TABLE 5

| | Change in first parameter | Induced change in second |
|---|---|---|
| 1 | angle of shaker ↑ | dryness of removed solids ↑ |
| 2 | angle of shaker ↑ | maximum flow rate ↑ |
| 3 | angle of shaker ↑ | rate of screen degradation ↑ |
| 4 | flow rate ↑ | effluent solids content (no change) |
| 5 | size of screen apertures ↑ | minimum particle size removed ↑ |
| 6 | size of screen apertures ↑ | rate of screen degradation ↓ |

Table 5 summarizes various relationships between measured and control parameters of the shaker, according to an example embodiment. The relationships shown in Table 5 are observed in some embodiments while in other embodiments, other relationships may govern. For any given embodiment, relationships such as those indicated in Table 5 are generally determined experimentally for a given embodiment. Control schemes and control systems may then be developed to control the system based on the determined relationships.

As mentioned above, the angle of a vibratory shaker machine affects the screening process. For example, as the angle of a screen basket of the shaker is increased, the dryness of the screened solids tends to increase. Further, in some embodiments, as the angle of the shaker is increased, a maximum flow rate may increase. For example, in certain embodiments, separated solids flow up the screen, and as such, gravity limits how fast the separated solids flow up the screen. Higher angle means the separated solids flow up the screen more slowly so the overall flow rate of material that can be processed is slower with higher angle. Alternatively, increased screen angle leads to a larger pool of material at the feed end which tends to increase throughput. Unfortunately, as mentioned above, increasing the shaker screen angle also tends to increase the rate of degradation of the screen.

A further angle of interest with regard to the shaker is an angle of vibratory motion. As the angle of motion is increased from 0 to 90° (with 90° being perpendicular to the screen surface), screened particles are conveyed along the screen at a slower rate. In this scenario the capacity would decrease with increasing angle, as there would be more solids blocking the screen surface thereby reducing fluid flow through the screen. Increasing the screen angle generally does not significantly change the angle of motion. Thus, for embodiments in which the motion of screened solids is dominated by the angle of motion, screened solids continue to convey up the screen at a rate that is not strongly dependent on the screen angle.

A further relationship governs flow rate and effluent solids content. In certain embodiments, material is fed from a top end of a screen to a bottom end of the screen, as described above with reference to FIGS. 1 and 2. In such embodiments, an increasing shaker angle leads to an increased rate of effluent flowing down the screen. In this case, effluent spends less time on the screen, and therefore, fewer solids are removed. Thus, the resulting effluent may have a higher solids content. In other embodiments, such as shakers that are fed from a bottom end, an opposite trend may occur. In other embodiments, there may be no relation between flow rate and effluent solids content.

In general, effluent solids content depends on screen aperture sizes and the percentages of various size particles in the feed to the shaker. Increasing the flowrate (or shaker angle) may not have a significant effect on the percentage of solids that are able to pass through the screen. In terms of mass or volume, a higher feed flow rate may lead to more solids in the effluent stream but the amount of solids would still be related to the proportion of a given particle size in the feed. For example, if the feed includes 10% by volume of particles that are small enough to pass through the screen openings, the effluent would be expected to contain approximately 10 gallons/minute (GPM) of solids in the effluent if the feed to the shaker was 100 GPM. If the flowrate to the shaker was increased to 1000 GPM the effluent may be expected to contain 100 GPM of solids.

As further indicted in Table 5, as screen aperture sizes increase, so does the minimum size of particles that are removed by the screening process. Also, as mentioned above, an inverse relationship between screen aperture size and a rate of screen degradation exists.

TABLE 6

| | Change in fist parameter | Induced change in second parameter |
|---|---|---|
| 1 | pump speed ↑ | flow rate ↑ |
| 2 | pump speed ↑ | power consumption ↑ |
| 3 | pump speed ↑ | dryness of removed solids ↓ |
| 4 | bowl speed ↑ | minimum size of particles removed ↓ |
| 5 | bowl speed ↑ | effluent viscosity ↓ |
| 6 | bowl speed ↑ | effluent turbidity ↓ |
| 7 | bowl speed ↑ | effluent solids content ↓ |
| 8 | bowl speed ↑ | effluent density ↓ |
| 9 | bowl speed ↑ | power consumption ↑ |
| 10 | bowl speed ↑ | dryness of removed solids ↓or ↑ |
| 11 | conveyor speed ↑ | motion of removed solids ↑ |
| 12 | conveyor/bowl | torque load ↓ |
| | differential speed ↑ | |
| 13 | conveyor/bowl | dryness of removed solids ↓ |
| | differential speed ↑ | |
| 14 | flow rate ↑ | torque load ↑ |
| 15 | flow rate ↑ | effluent density ↑ |
| 16 | flow rate ↑ | throughput ↑ |
| 17 | radius of weir plates ↑ | pond depth ↓ |
| 18 | pond depth ↑ | dryness of removed solids ↓ |
| 19 | pond depth ↑ | effluent viscosity ↓ |
| 20 | pond depth ↑ | effluent turbidity ↓ |
| 21 | pond depth ↑ | effluent solids content ↓ |
| 22 | pond depth ↑ | effluent density ↓ |

Table 6 summarizes various relationships between measured and control parameters of a centrifuge, according to an example embodiment. For example, increasing pump speed increases a flow rate of material into the centrifuge at a cost of increased power consumption. The increased flow rate due to the increased pump speed means that material spends less time in the centrifuge. As such, a dryness of particles removed by the centrifuge tends to decrease. Increasing the centrifuge bowl speed leads to a greater degree of solids removal. As such, a minimum size of removed solids tends to decrease. Greater removal of material with increased bowl speed tends to lower effluent viscosity, effluent turbidity, effluent solids content, and effluent density at a cost of increased power consumption.

Increasing bowl speed may increase or decrease dryness of removed solids. Increasing bowl speed increases removal of liquid. As such, for certain sizes of removed particles, dryness increases with bowl speed. In other situations, as bowl speed increases, smaller size particles are more readily removed. Smaller particles may have a larger total surface area per volume which may tend to retain more moisture. Thus, depending on how drastic the change in particle size is with respect to bowl speed, it may be possible that the solid discard actually includes more liquid at high bowl speed. In general, dryness may increase with bowl speed for a first range of bowl speeds and may decrease with bowl speed for a second range of bowl speeds. In certain embodiments, the second range of bowl speeds may be greater than the first range of bowl speeds. For other ranges of bowl speed, there may be approximately no change in dryness of removed solids verses bowl speed.

The conveyor acts to move material through the centrifuge. As such, increased conveyor speed tends to increase the motion of removed solids. Bowl speed is influenced by a bowl drive motor (e.g., bowl drive motor 319 in FIG. 3), and conveyor speed is influenced by a conveyor drive motor 321 (e.g., conveyor drive motor 321 in FIG. 3). A speed of the bowl drive motor is not necessarily the speed of the bowl, as the bowl motor is coupled to the bowl via a belt with a fixed ratio for that drive mechanism. Likewise, the conveyor speed is not necessarily the speed of the conveyor. The conveyor is coupled to the output of a gearbox that is mounted to the bowl. The conveyor motor spins an input pinion on the gearbox and therefore the conveyor speed is determined based on the bowl speed, conveyor motor speed, and the gear box ratio. As a result, there is a conveyor motor speed (gearbox input), conveyor speed (gearbox output), bowl speed, and bowl motor speed.

A control system may calculate the various speeds as follows. A user may input a desired bowl speed and the control system may determine a necessary motor speed to obtain the desired bowl speed. A user may also specify a desired differential speed. In this case, the control system may determine an actual bowl speed (based on the actual motor speed and the belt drive ratio). The control system may further determine a conveyor speed that is needed to obtain a desired differential speed. Based on the determined conveyor speed, the control system may then determine a necessary conveyor motor speed needed to obtain the desired differential speed. Lastly, based on a current conveyor motor speed and a current bowl speed, the control system may determine the actual conveyor differential speed. Various parameters may be controlled or changed if the differential speed differs from a desired differential speed.

For simplicity, Table 6 refers only to bowl speed and bowl/conveyor differential speed to characterize relationships between measured and controlled centrifuge parameters. As the above discussion shows, however, there are more complicated relationships involving the bowl motor speed and the conveyor motor speed. For example, no direct relationships can be established regarding conveyor speed alone because a given conveyor speed may result in many different differential speeds depending on the bowl speed of the centrifuge.

A torque load on one or more motors may be affected by the flow rate and/or by the conveyor/bowl differential speed. An increase in flow rate may lead to a decrease in torque load. Changing a differential speed, however, may be a faster or more efficient way to decrease a torque load. For example, in certain situations, turning off the feed to the centrifuge (i.e., reducing the flow rate to zero) may lead to torque load decreasing on a time scale of thirty to sixty seconds. Alternatively, in certain embodiments, increasing a differential speed by one or two revolutions per minute (RPM) can significantly reduce the torque in a matter of a few seconds.

Table 6 indicates further relationships involving flow rate. For example, increased flow rate may increase effluent density as well as throughput. In many situations, however, it may not be convenient or even possible to control the flow rate. For example, when drilling an oil well, slurry or drilling fluid/mud is pumped down the well and when it returns from the well it is directed to one or more shakers at a rate that is determined by the rate at which slurry is pumped into the well. As described above with reference to FIG. 4, a solids control system may have one or more shakers. A single shaker may be sufficient for low flow rates of slurry. As flow rates increase, based on the needs of a drilling operation, one or more additional shakers may be used.

As mentioned above, a pond depth of liquid in the centrifuge may be controlled by adjusting a radius of weir plates. In turn, adjusting the pond depth may influence various other parameters including: dryness of removed solids, effluent viscosity, effluent turbidity, effluent solids content, and effluent density.

Various systems and methods for controlling a centrifuge using relationships such as those provided in Table 6, above, are described in U.S. Pat. No. 9,283,572, the disclosure of which is incorporated by reference herein in its entirety. For example, a system may receive one or more input parameters identifying desired speeds for the bowl and conveyor motors, a desired torque load for the conveyor motor, and a maximum flow rate for a pump. The system may then regulate a pump speed, and thus a slurry flow rate, to maintain an actual torque load for the conveyor motor at the desired torque load. In situations for which it is not possible to maintain an actual torque load for the conveyor motor at the desired torque load, a pump may be regulated to adjust a pump speed and slurry flow rate to maintain maximum flow rate.

In other embodiments, a system may be configured to determine that an actual torque load is greater than a desired torque load. In turn, the system may regulate a pump speed to control flow rate of the slurry to reduce the actual torque load to be equal to or less than desired torque load. In other embodiments, a differential speed between the bowl and the conveyor may be adjusted to control a torque load, as mentioned above.

In further embodiments, various control systems and methods may rely on various measured parameters. For example, a system may be configured to measure at least one parameter of an effluent including feed density, viscosity, turbidity, solids content, particle distribution, and flow rate. Results of such measurements may then be used by the control system to adjust one or more of a bowl speed, a conveyor speed, a pump speed, a differential speed, and a pump flow rate to obtain desired results based on relationships such as those described above with reference to Table 6.

As described in greater detail below, similar control systems are provided to control a system that includes a centrifuge and one or more vibratory shaker machines, such as system 400, described above with reference to FIG. 4. Such a control system may control the various parameters (e.g., see Tables 1 to 4) of a solids control system (e.g., system 400 of FIG. 4) to control costs according to various cost metrics, based on known relationships between parameters (e.g., see Tables 5 and 6). Cost metrics may include dilution cost savings, disposal cost savings, energy cost savings, screen-replacement costs, maintenance costs, and non-productive time (NPT) cost reduction. The various cost metrics are described in greater detail below.

A cost metric associated with dilution is described as follows. As drilling fluid is used it acquires LGS and its density increases. For solids that are not removed, such a drilling fluid must be diluted with new drilling fluid in order for it to continue to be useful. In an example, 10 barrels (bbl) of fresh drilling fluid may be needed to dilute 1 bbl of solids that are not removed from used drilling fluid. For the purpose of illustration, a cost of $60/bbl of new drilling fluid is assumed. Increasing solids removal by a factor of “R” bbl, leads to a dilution cost savings of 10*60*R. As described above, removed solids typically also are not completely dry. As such, disposal of removed solids also leads to unwanted disposal of liquid. Decreasing the retained liquid by a factor of “O” bbl thus leads to a cost savings of 60*O due to the reduction, by O bbl, of replacement fluid. Thus, for an improved solids control system that increases solids removal by R bbl of solids, and increases dryness of the removed solids by O bbl, a combined dilution cost savings of 600*R+60*O is achieved.

The following example provides estimated dilution cost saving based on testing data from an oil well. In drilling the well, 1465 bbl of drilling fluid was used for dilution, at a cost of $60/bbl drilling fluid for a cost of $87,166. A total of 1110 bbl of cuttings were drilled and of these cuttings, 1005 bbl were removed and discarded leaving 105 bbl of missed cuttings that required dilution. Further, along with the discarded cutting, a total of 1649 bbl of liquid and LGS was discarded including 644.5 bbl of liquid and 1004.7 of LGS. A substantial cost savings may be achieved with an improved solids control system. For example, an improved solids control system may lead to a 13:1 actual dilution ratio, a 50% increase of removal of missed cuttings (i.e., approximately 50 bbl additional cuttings removed), and decreased removal of liquid on cuttings by 125 bbl (i.e., 20% slurry loss). With these estimates, a cost savings of 13*60*50+125*60−$46,500 may be achieved.

Disposal costs may be estimated as follows. In an example, a cost of $20/bbl may be assumed to haul away waste. With an improved solids control system that increases solids removal by R bbl, and decreases retained liquid on cutting by O bbl, a cost savings of 20*O−20*R may be obtained. Data from above-described oil well may also be used to estimate disposal costs. For example, with the above-described example oil well, disposal cost was $17/bbl to haul off waste. A total of 1110 bbl cuttings were drilled and 1649 bbl of waste was discarded. Of the waste discarded, 644.5 bbl was liquid, and 1004.7 bbl was LGS. Using an improved solids control system to increase removed solids by 50 bbl (i.e., 50% of missed cuttings) and to decrease liquid retained on the cutting by 125 bbl (i.e., 20% of slurry lost), leads to a cost savings of 17*125−17*50=$1,275.

As mentioned above, one parameter that may be optimized in an improved solids control system is power consumption. For example, under certain operating conditions, it may be more efficient to run the system continuously at a slower speed rather than operating the system at a higher speed but only for certain time intervals. Assuming an energy cost of $0.16/kWh, an improved system that reduced power consumption by P kWh leads to an energy cost savings 0.16*P dollars.

Screens used in vibratory screening machines gradually degrade and wear out over time. As such, there is an operation cost associated with screen degradation. As mentioned above with reference to Table 5, various operating parameters, such as size of screen apertures and screen angle, affect a rate at which screen panels degrade. In this regard, operating parameters may be adjusted or optimized to prolong screen life and to thereby reduce costs associated with replacement of screens. Assuming a replacement cost of X dollars per screen panel, for example, an improved solids control system that reduced screen panel consumption S screen panels leads to a cost savings of X*S dollars.

Maintenance costs represent another parameter that may be reduced or optimized using an improved solids control system. For example, a conventional system may have maintenance costs that average approximately $1,000/month. An improved system that reduces maintenance costs by M % leads to a monthly cost reduction of 10*M dollars.

Additional costs are typically associated with non-productive time (NPT). Many factors may lead to down time or NPT, such as mechanical failure and delays associated with processing of used drilling fluid to remove cuttings and other unwanted debris. An improved solids control system may make processing of drilling fluid more efficient leading to a reduction in NPT by N %. In an example drilling situation daily costs to operate a drilling rig may be on the order of $15,000/per day. As a conservative estimate, NPT may account for 20% of working hours per month. Assuming an average of 4,320 working hours per month, and an NPT reduction of N %, a monthly NPT savings of (15,000/24)*4320*(N/10)=27,000*N dollars may be obtained.

The above-described individual cost estimates may be combined into an overall cost metric that may be optimized by controlling the various system parameters listed above in Tables 1 to 4, based on the relationships shown in Tables 5 and 6. As described above, an improved solids control system may lead to: increased solids removal by R bbl, decreased retained liquid on cutting by O bbl, reduced power consumption by P kWh, reduced screen consumption by S screens, reduced maintenance costs by M %/month, and reduced NPT by N %/month. Thus, given these factors, for a job that takes one month, an overall cost savings (in dollars) may be given by the metric=600*R+60*O+20*O−20*R+0.16*P+X*S+10*M+900*N=580*R+80*O+0.16*P+X*S+10*M+27,000*N dollars. In other embodiments, various other metrics may be defined with different weighting factors assigned to the various costs.

In an example embodiment, various shaker parameters, such as the parameters listed in Table 1, may be adjusted to optimize the above-described cost metric. For example, proper selection of screen panel properties (e.g., screen aperture sizes), deck angle adjustment, and rate at which screen panels are replaced may influence various factors in the cost metric. For example, solids removal may be increased by R bbl, retained liquid on cutting may be decreased by O bbl, screen panel consumption by be reduced by S screens, maintenance costs may be reduced by M %/month, and NPT may be reduced by N %/month.

An improved solids control system may control the above parameters by measuring various parameters, such as parameters listed in Table 2, and controlling parameters, such as parameters listed in Table 1, based on relationships such as those listed in Table 5. For example, an improved solids control system may be configured to automatically measure a discard rate of drilling fluid. Such discarded fluid may be measured as a weight per time rate (e.g., in tons/hour). Properties of the discarded fluid may be measured, such as a percentage of solids in the discarded fluid. One or more sensing devices, such as a manual retort, may be used to determine a percentage of solids in the discarded fluid. Using a manual retort, for example, involves weighing a fluid containing solids, using the retort to boil off the liquid, and then weighing the remaining solids to determine a percentage of solids. Various other sensors may be used to perform a particle size analysis to determine a particle size distribution of solids in the discarded fluid.

Parameters for one or more centrifuges, such as parameters listed in Table 3, may also be adjusted to optimize an overall cost metric. Various parameters, such as bowl speed, differential conveyor/bowl speed, flow rate, weir settings, etc., may be adjusted to control various parameters (e.g., see measured parameters of Table 4). For example, solids removal may be increased by R bbl, retained liquid on cutting may be decreased by O bbl, maintenance costs may be reduced by M %/month, and NPT may be reduced by N %/month. In the centrifuge context, as with the above shaker example, an improved solids control system may be configured to automatically measure a discard rate of drilling fluid. Such discarded fluid may be measured as a weight per time rate (e.g., in tons/hour). Properties of the discarded fluid may be measured, such as a percentage of solids in the discarded fluid.

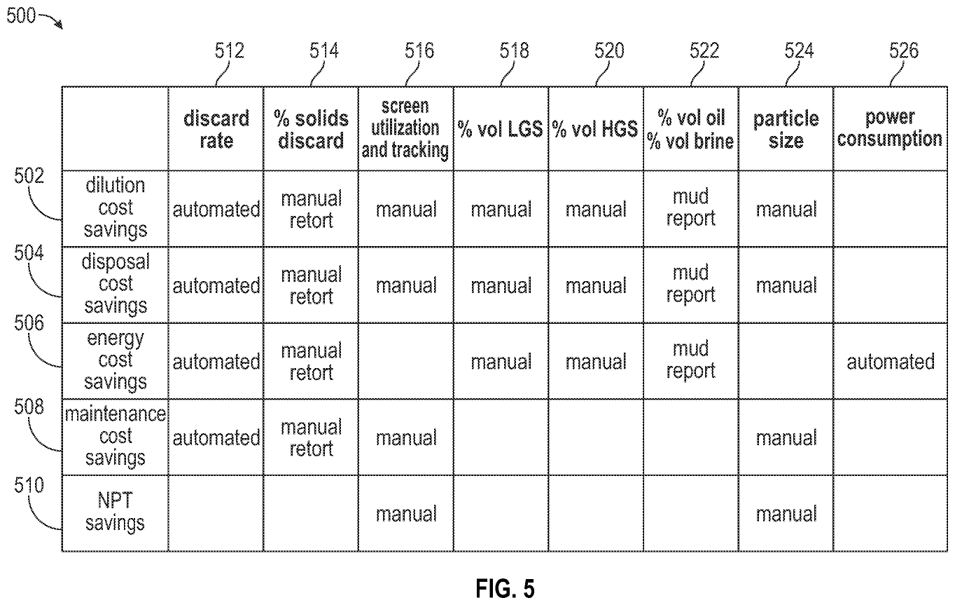

FIG. 5 is a matrix 500 of measured properties in relation to various cost metrics, according to an example embodiment. Rows of the matrix shown in FIG. 5 correspond to various cost metrics including dilution cost savings 502, disposal cost savings 504, energy cost savings 506, maintenance cost savings 508, and NPT cost savings 510. The columns of matrix 500 correspond to various measured properties including a discard rate 512, a percentage of discarded solids 514, a screen utilization 516, a volume percentage of LGS 518, a volume percentage of HGS 520, a volume percentage of brine 522, a particle size distribution 524, and a power consumption 526.

In certain embodiments, various parameters may be automatically measured or may be measured manually. For example, in development of a new system, it may be advantageous to use a combination of automated and manual measurements for benchmarking and testing. As mentioned above, using a manual retort to determine volume density of various components of a fluid, for example, involves weighing a fluid containing solids, using the retort to boil off the liquid, and then weighing the remaining solids to determine a percentage of solids. Alternatively, density and flow measurements may be performed automatically using various density and flow meters that are commercially available.

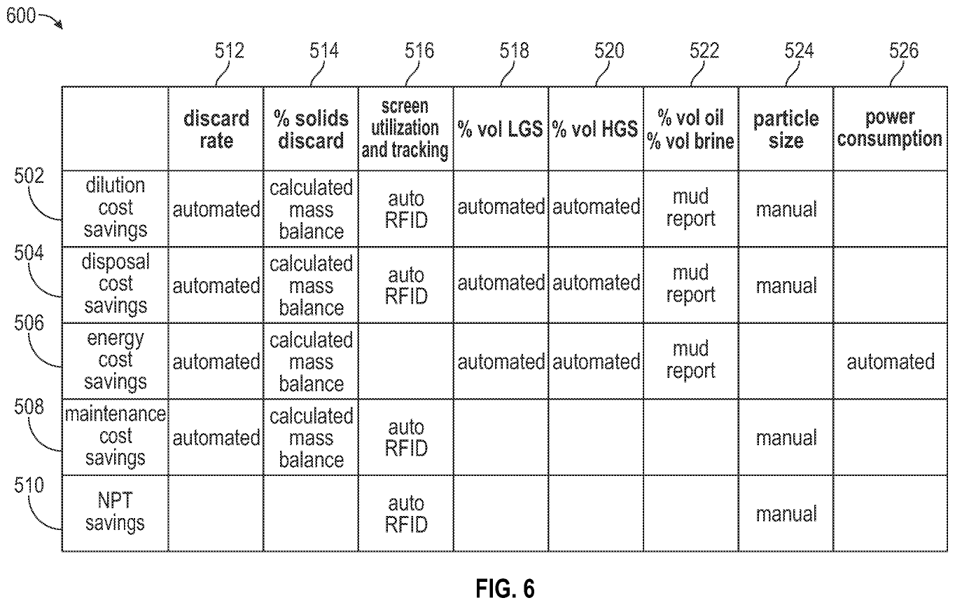

FIG. 6 is a matrix 600 of measured properties in relation to various cost metrics, according to an example embodiment. Matrix 600 is similar to matrix 500 with the same cost metrics labelling the rows and same measured properties labelling the columns. Matrix 600, however, refers to an alternative embodiment in which more of the measurements are automated, such as the measurement of percentage of discarded solids 514, screen utilization 516, and volume percentages of LGS 518 and HGS 520. The embodiment of FIG. 6 may represent a prototype system that is intermediate between a system that is mostly operated manually, such as the embodiment of FIG. 5, and a fully automated system.

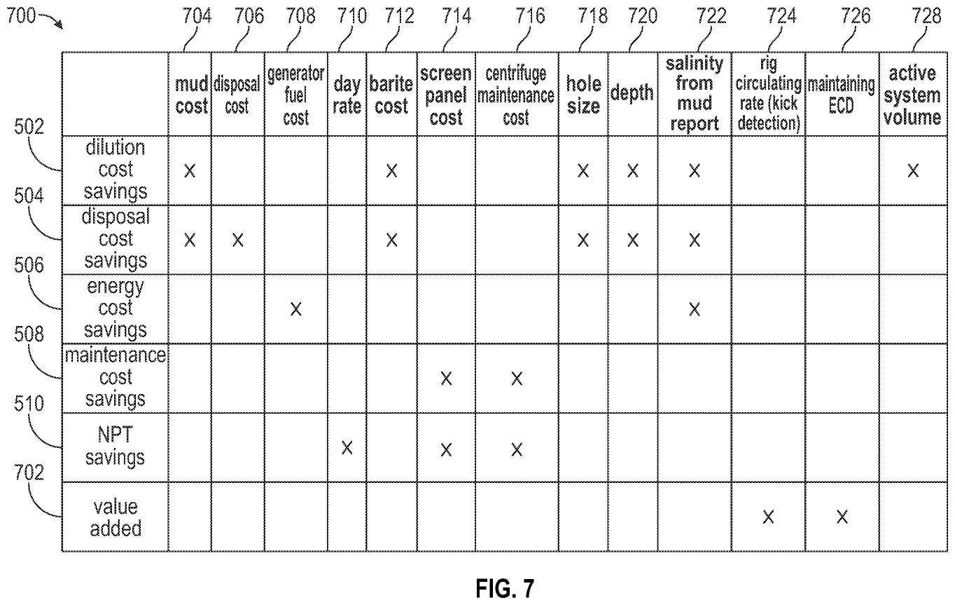

FIG. 7 is a matrix 700 of external input data in relation to various cost metrics, according to an example embodiment. The rows correspond to cost metrics including dilution cost savings 502, disposal cost savings 504, energy cost savings 506, maintenance cost savings 508, and NPT cost savings 510. Matrix 700 includes a further row corresponding to projected value added. The columns of matrix 700 correspond to various pieces of external input data related to determining cost metrics. This data includes mud cost 704, disposal cost 706, generator fuel cost 708, a daily rate 710, barite cost 712, screen panel cost 714, centrifuge maintenance cost 716, oil well hole size 718, well depth 720, starting salinity of drilling mud 722, rig circulating rate 724, maintaining ECD 726, and active system volume 728.

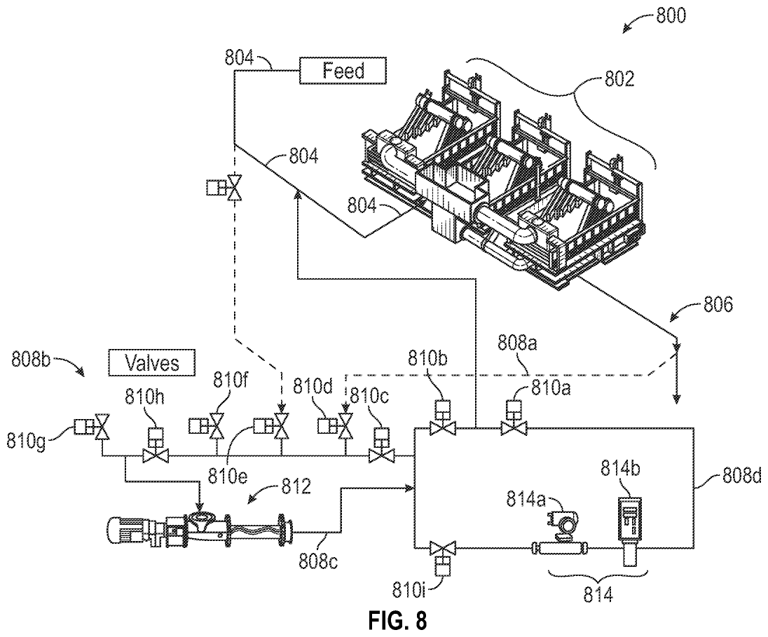

FIG. 8 illustrates a sub-system 800 for measuring fluid effluent of a vibratory shaker component of a solids control system, according to an example embodiment. In this example, one or more vibratory shaker machines 802 may receive drilling fluid along a feed path 804. Vibratory shaker machines 802 may separate the drilling fluid into solids and an effluent. The effluent may be removed from vibratory shaker machines 802 along an effluent path 806 and may be processed through various fluidic paths 808a, 808b, 808c, and 808d. Fluidic paths 808a, 808b, 808c, and 808d may have various valves 810a to 810i, one or more pumps 812, and one or more analytic instruments 814. Analytic instruments 814 may include one or more flow/density/viscosity meters 814a and one or more drilling fluid analyzers 814b. Analytic instruments may be used to manually or automatically perform measurements of shaker effluent properties. Effluent properties may include mass and/or volume flow rates, and mass and/or volume percentages of LGS, HGS, water, brine, oil, etc. In an example embodiment, flow/density/viscosity meter 814a may be a Coriolis meter that measures flow rate, density, and viscosity. Further, drilling fluid analyzer 814b may be a Salunda MudChecker™ that measures percentages of oil, water, and solids (e.g., % HGS, % LGS, etc.). Analytical instruments may further include a particle size analysis sensor (e.g., a sensor based on Focus Beam Reflectance Measurements (FBMR)) and/or an optical based turbidity sensor.

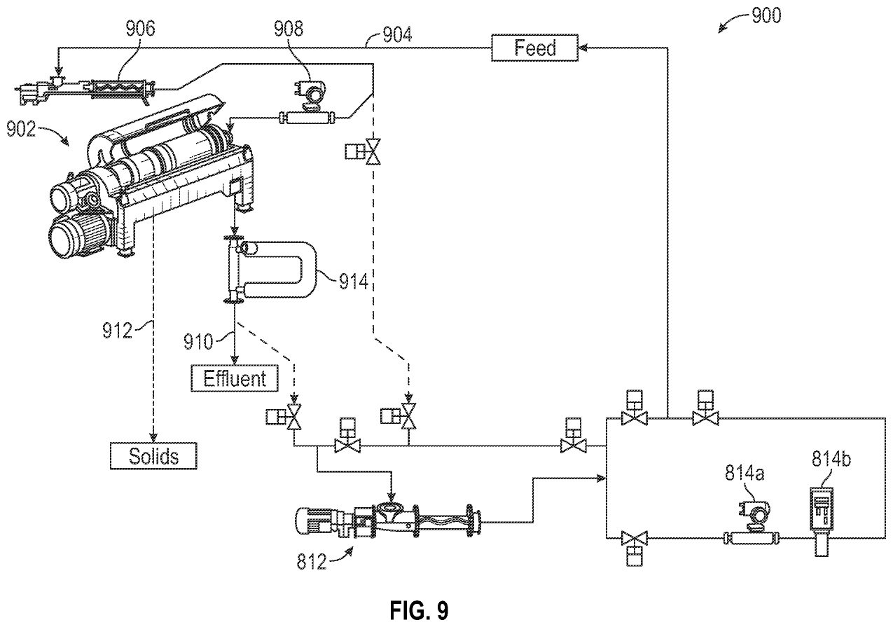

FIG. 9 illustrates a sub-system 900 for measuring fluid effluent of a centrifuge component of a solids control system, according to an example embodiment. Fluid effluent generated by the above-described shaker sub-system 800 may be provided to a centrifuge 902 along one or more fluidic pathways 904. Fluidic pathways 904 may include one or more pumps 906. One or more flow meters 908 may measure the flow rate of material pumped into centrifuge 902. Centrifuge 902 may further separate the effluent provided from shaker sub-system 800 into a centrifuge effluent 910 and separated solids 912. A flow rate of the centrifuge effluent 910 may be measured by one or more flow meters 914. The centrifuge effluent may be routed through various fluidic pathways that may be combined with fluidic pathways associated with shaker sub-system 800. In this way, centrifuge effluent may be recycled in various ways including mixing the centrifuge effluent with the shaker effluent, etc.

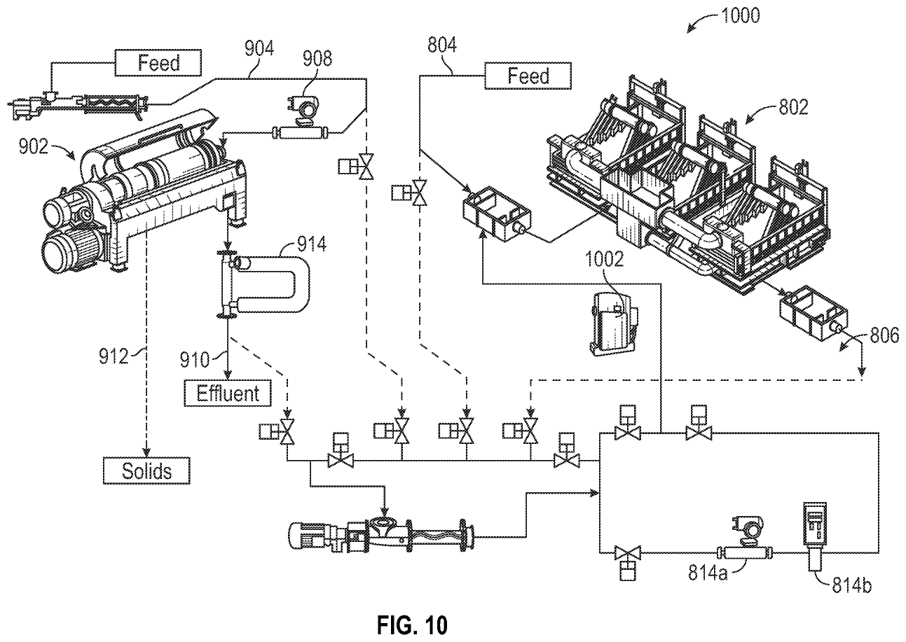

FIG. 10 illustrates a combined sub-system 1000 including subsystems shown in FIGS. 8 and 9, according to an example embodiment. System 1000 represents an integrated sub-system for processing effluent through the shaker sub-system 800 and the centrifuge sub-system 900 including analytical instruments 814a, 814b, 908, and 914.

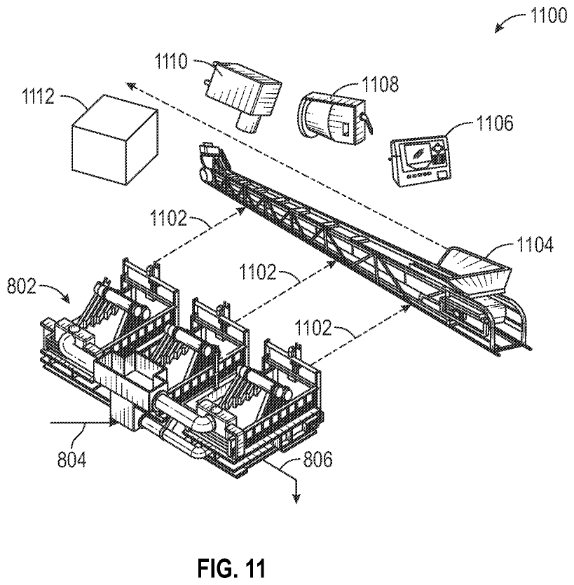

FIG. 11 illustrates a sub-system 1100 for measuring solids removed from a shaker component of a solids control system, according to an example embodiment. In this example, one or more vibratory shaker machines 802 receive drilling fluid along pathway 804 and effluent is removed along fluid pathway 806, as described in greater detail above. Solids that are removed by shaker 802 are removed along a solids removal pathway 1102. Removed solids may then be fed to a conveyor 1104 for further processing.

Removed solids may be analyzed by performing various measurements, for example, by weighing the removed solids with a scale 1106, by performing spectroscopy measurements and volumetric calculations on removed solids using laser 1108 and/or near-infrared (NIR) 1110 sources, etc., to determine a discard rate. Removed solids may then be dried using one or more ovens 1112. Dried removed solids may then be weighed to determine a weight of the dried removed solids. Comparison with weight of the removed solids before drying allows a determination of the amount of retained fluid on the removed solids.

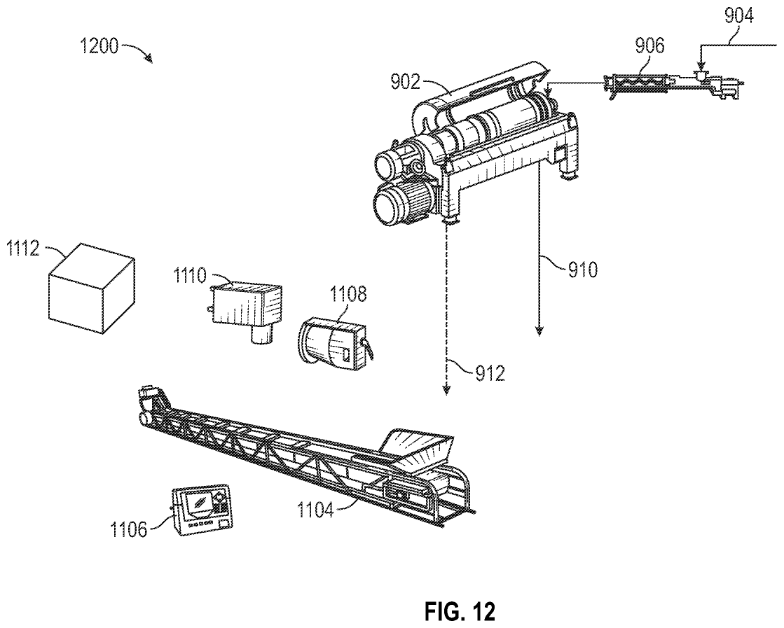

FIG. 12 illustrates a sub-system 1200 for measuring solids removed from a centrifuge component of a solids control system, according to an example embodiment. As described above, effluent received by the shaker sub-system 800 may be fed to the centrifuge 902 along a fluidic pathway 904 using one or more pumps 906. Centrifuge effluent may be removed along fluidic pathway 910 and processed as described above with reference to FIG. 9. Solids removed by centrifuge 902 may be removed along pathway 912 and may be processed like solids removed by the shaker sub-system 1100. In this way, removed solids may then be fed to a conveyor 1104 for further processing. Removed solids may be analyzed by performing various measurements, for example, by weighing the removed solids with a scale 1106, by performing spectroscopy measurements on removed solids using laser 1108 and/or near-infrared (NIR) 1110 sources, etc., as described above.

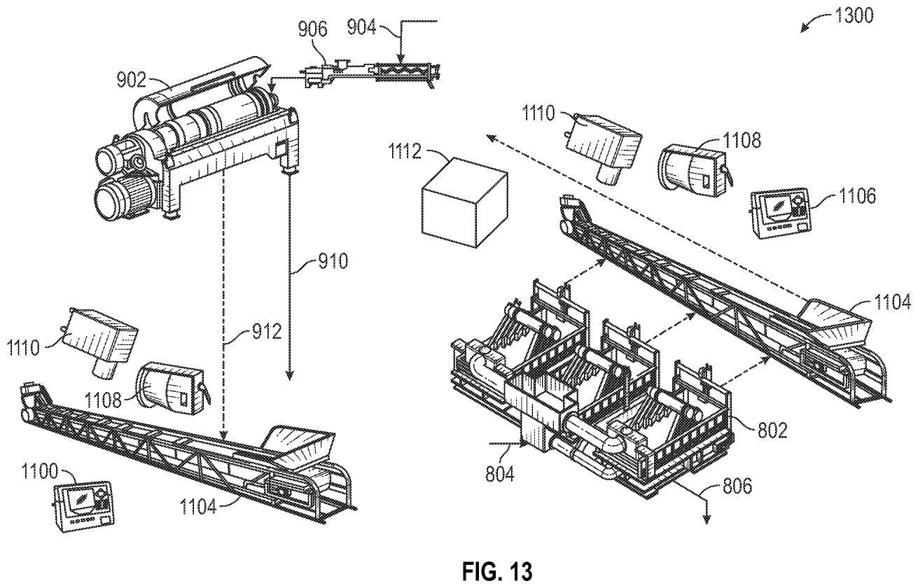

FIG. 13 illustrates a combined sub-system 1300 including the subsystems shown in FIGS. 11 and 12, according to an example embodiment. System 1300 represents an integrated sub-system for processing solids through the shaker sub-system 800 and the centrifuge sub-system 900 including conveyors 1104, scales 1106, laser sources 1108, NIR sources 1110, ovens 1112, etc.

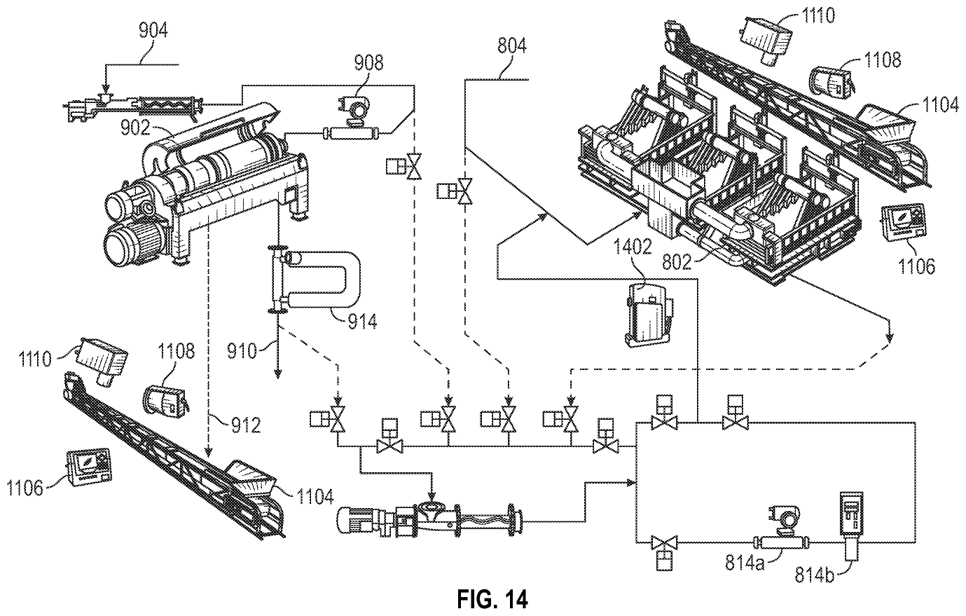

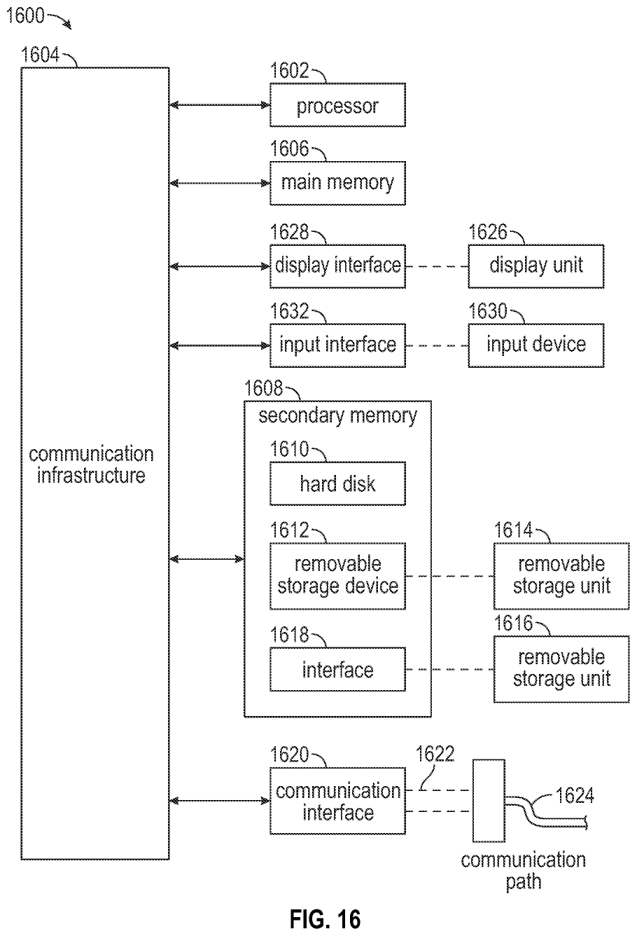

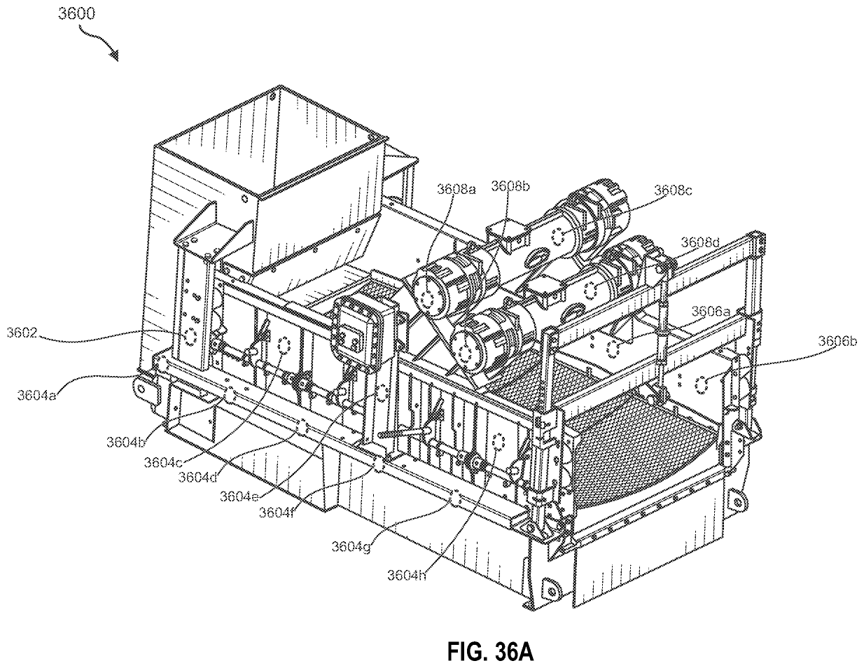

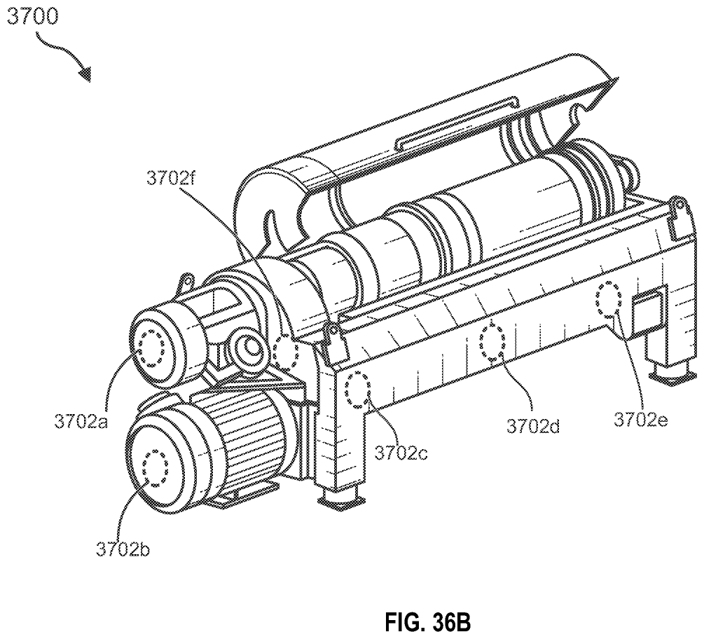

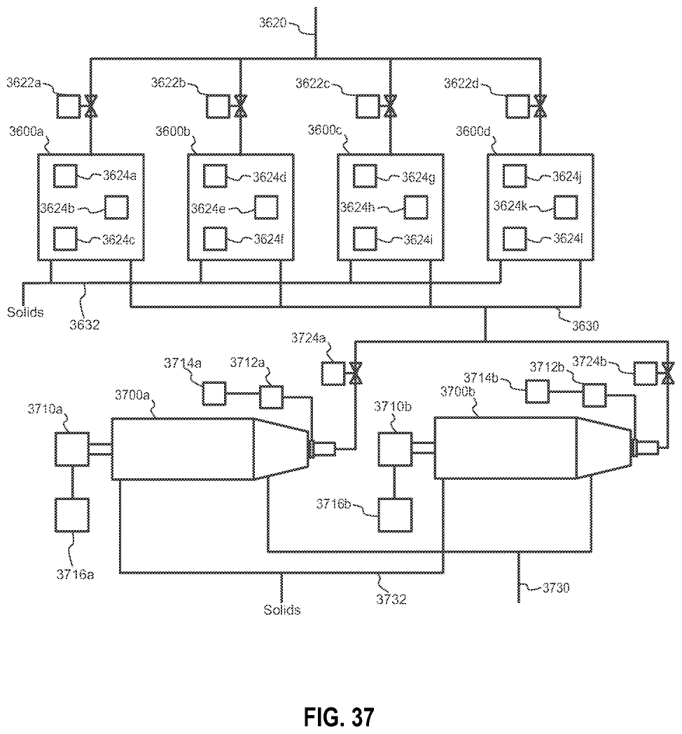

FIG. 14 illustrates a complete solids control system 1400, according to an example embodiment. System 1400 is an integrated solids control system that includes one or more vibratory shaker systems 802, one or more centrifuges 902, effluent processing sub-systems, 1000 and 1100, as well as removed solids processing sub-systems 1200 and 1300. System 1400 includes various analytical instruments 814a, 814b, 908, and 904 that may be configured to perform flow and density measurements on various fluid components, as well as other solids processing measurement apparatus, as described in greater detail with reference to FIGS. 11 and 12, above. System 1400 may further include one or more controllers 1402 and/or computing systems or processing circuits. Such controllers and/or computers and/or processing circuits may receive information from sensors and may generate control signals to control various parameters described above with reference to Tables I to 4, based on the relationships described above with reference to Tables 5 and 6, and/or to control various parameters based on the relationships described below with reference to FIGS. 36-37. A control system 1402 may be implemented using hardware, firmware, or software using system components such as described below with reference to FIG. 16.

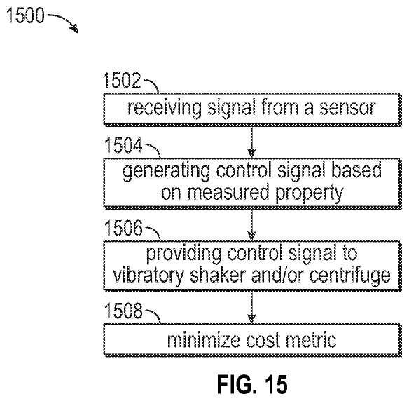

FIG. 15 is a flowchart 1500 illustrating a processor implemented method, according to an example embodiment. In this method, the processor controls a solid-liquid separation system that includes a vibratory shaker, a centrifuge, and a sensor. The shaker is configured to separate a solid-liquid mixture into a first solids-containing component and a shaker effluent, and the centrifuge is configured to separate the shaker effluent into a second solids-containing component and a centrifuge effluent. In a first stage 1502, the method includes receiving a signal from a sensor that is configured to measure a property of one or more of the first solids-containing component, the shaker effluent, the second solids-containing component, and the centrifuge effluent. In stage 1504, the method includes generating a control signal based on the measured property, and in stage 1506, the method includes providing the control signal to the vibratory shaker and/or to the centrifuge to thereby cause a change in an operational parameter of the vibratory shaker and/or the centrifuge. In a further stage 1508, the processor may be configured to control the system to minimize a cost metric. The cost metric may depend on one or more of a dilution cost, a disposal cost, an energy cost, a screen-replacement cost, a maintenance cost, and a NPT cost. Various other cost metrics may be defined in other embodiments.

FIG. 16 is a block diagram of an example computer system 1600 in which disclosed embodiments of, or portions thereof, may be implemented as computer-readable code (i.e., machine-readable computer program instructions), which is executed by one or more processors causing the one or more processors to perform operations of the disclosed embodiments, according to an embodiment.

Disclosed systems may include components implemented on computer system 1600 using hardware, software, firmware, tangible computer-readable (i.e., machine-readable) media having computer program instructions stored thereon, or a combination thereof, and may be implemented in one or more computer systems or other processing system.

If programmable logic is used, such logic may be executed on a commercially available processing platform or a on a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various disclosed embodiments are described in terms of this example computer system 1600. After reading this description, persons of ordinary skill in the relevant art will know how to implement disclosed embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Computer or processor circuit 330, described above with reference to FIG. 3, is an example of computer system 1600, described in greater detail below. Computer or processor circuit 330 may be configured to gather measurement data and to provide control signals to the various components of the system. For example, computer processor circuit 330 may include a personal computer (PC) and/or a programmable logic controller (PLC). The computer processor circuit 330 may receive measurement data from the one or more flow/density/viscosity meters 814a, 908, one or more drilling fluid analyzers 814b (e.g., see FIGS. 8 and 9), turbidity sensors, temperature sensors, viscosity sensors, particle count sensors, etc. Computer or processor circuit 330 may control laser 1108 and/or NIR 1110 sources (e.g., see FIG. 11) and may further receive measurement data from corresponding laser and/or NIR sensors (not shown). Computer or processor circuit 330 may further receive data from, and provide control signals, to VFD systems 331, 332, and 334 (e.g., sec FIG. 3) that, in turn, control bowl drive motor 319, screw conveyor drive motor 321, pump drive motor 335, etc. Computer or processor circuit 330 may also control various valves 810a to 810i (e.g., see FIG. 8), scale 1106, and oven 1112 (e.g., see FIG. 11).

As persons of ordinary skill in the relevant art will understand, a computing device (e.g., computer or processor circuit 330) for implementing disclosed embodiments has at least one processor, such as processor 1602, wherein the processor may be a single processor, a plurality of processors, a processor in a multi-core/multiprocessor system, such system operating alone, or in a cluster of computing devices operating in a cluster or server farm. Processor 1602 may be connected to a communication infrastructure 1604, for example, a bus, message queue, network, or multi-core message-passing scheme.

Computer system 1600 may also include a main memory 1606, for example, random access memory (RAM), and may also include a secondary memory 1608. Secondary memory 1608 may include, for example, a hard disk drive 1610, removable storage drive 1612. Removable storage drive 1612 may include a floppy disk drive, a magnetic tape drive, an optical disk drive, a flash memory, or the like. The removable storage drive 1612 may be configured to read and/or write data to a removable storage unit 1614 in a well-known manner. Removable storage unit 1614 may include a floppy disk, magnetic tape, optical disk, etc., which is read by and written to, by removable storage drive 1612. As will be appreciated by persons of ordinary skill in the relevant art, removable storage unit 1614 may include a computer readable storage medium having computer software (i.e., computer program instructions) and/or data stored thereon.

In alternative implementations, secondary memory 1608 may include other similar devices for allowing computer programs or other instructions to be loaded into computer system 1600. Such devices may include, for example, a removable storage unit 1616 and an interface 1618. Examples of such devices may include a program cartridge and cartridge interface (such as that found in video game devices), a removable memory chip (such as EPROM or PROM) and associated socket, and other removable storage units 1616 and interfaces 1618 which allow software and data to be transferred from the removable storage unit 1616 to computer system 1600.

Computer system 1600 may also include a communications interface 1620. Communications interface 1620 allows software and data to be transferred between computer system 1600 and external devices. Communications interfaces 1620 may include a modem, a network interface (such as an Ethernet card), a communications port, a PCMCIA slot and card, or the like. Software and data transferred via communications interface 1620 may be in the form of signals 1622, which may be electronic, electromagnetic, optical, or other signals capable of being received by communications interface 1620. These signals may be provided to communications interface 1620 via a communications path 1624.

In this document, the terms “computer program storage medium” and “computer usable storage medium” are used to generally refer to storage media such as removable storage unit 1614, removable storage unit 1616, and a hard disk installed in hard disk drive 1610. Computer program storage medium and computer usable storage medium may also refer to memories, such as main memory 1606 and secondary memory 1608, which may be semiconductor memories (e.g., DRAMS, etc.). Computer system 1600 may further include a display unit 1626 that interacts with communication infrastructure 1604 via a display interface 1628. Computer system 1600 may further include a user input device 1630 that interacts with communication infrastructure 1604 via an input interface 1632. A user input device 1630 may include a mouse, trackball, touch screen, or the like.

Computer programs (also called computer control logic or computer program instructions) are stored in main memory 1606 and/or secondary memory 1608. Computer programs may also be received via communications interface 1620. Such computer programs, when executed, enable computer system 1600 to implement embodiments as discussed herein. In particular, the computer programs, when executed, enable processor 1602 to implement the processes of disclosed embodiments, such various stages in disclosed methods, as described in greater detail above. Accordingly, such computer programs represent controllers of the computer system 1600. When an embodiment is implemented using software, the software may be stored in a computer program product and loaded into computer system 1600 using removable storage drive 1612, interface 1618, and hard disk drive 1610, or communications interface 1620. A computer program product may include any suitable non-transitory machine-readable (i.e., computer-readable) storage device having computer program instructions stored thereon.

Embodiments may be implemented using software, hardware, and/or operating system implementations other than those described herein. Any software, hardware, and operating system implementations suitable for performing the functions described herein may be utilized. Embodiments are applicable to both a client and to a server or a combination of both.

FIG. 17 is a transparent perspective view of an eccentric vibrator apparatus 1700, according to an example embodiment. Eccentric vibrator apparatus 1700 includes a housing assembly 1750 that may have an elongated shape defining an axis 1702 (e.g., labeled with a “z” in FIG. 17). Eccentric vibrator apparatus 1700 may also include a first motor assembly 1710a and a second motor assembly 1710b, each disposed within housing assembly 1750. In some embodiments, first motor assembly 1710a may include a first shaft 1705a oriented substantially along axis 1702, a first mass member 1720a mounted eccentrically on first shaft 1705a, and a first counterbalance mass member 1730a mounted eccentrically on first shaft 1705a.

As shown in FIG. 17, first mass member 1720a may be attached proximate to a first end of the first shaft 1705a. First counterbalance mass member 1730a may be attached proximate to a second end of first shaft 1705a. The first mass member 1720a and the first counterbalance mass member 1730a may each include a plurality of members. In an embodiment, a first member of the first mass member 1720a and a first member of the first counterbalance mass member 1730a may be configured to be substantially in parallel and may be assembled at a defined angle around a circumference of the first shaft 1705a relative to one another. In one example, the defined angle may be approximately 180 degrees (e.g., as shown in FIG. 18 and described in greater detail below).

Second motor assembly 1710b may include a corresponding second shaft 1705b oriented substantially along axis 1702, a second mass member 1720b mounted eccentrically on second shaft 1705b, and a second counterbalance mass member 1730b mounted eccentrically on second shaft 1705b. Second mass member 1720b may be attached proximate to a first end of second shaft 1705b, where the first end of the second shaft 1705b is adjacent to the first end of first shaft 1705a. Second counterbalance mass member 1730b may be attached proximate to a second end of the second shaft 1705b, opposite the first end of second shaft 1705b. The second mass member 1720b and the second counterbalance mass member 1730b may each include a plurality of members. A first member of the second mass member 1720b and a first member of the second counterbalance mass member 1730b may be configured to be substantially in parallel and may be assembled at a defined angle around a circumference of the second shaft 1705b relative to one another. In an example, the defined angle may be approximately 180 degrees (e.g., as shown in FIG. 18 and described in greater detail below).

The first mass member 1720a and the second mass member 1720b may each have a first net mass. Likewise, the first counterbalance mass member 1730a and the second counterbalance mass member 1730b may each have a second net mass. Various combinations of the first net mass and the second net mass may be chosen, with the magnitude of the second net mass depending on the magnitude of the first net mass, as explained in more detail below. For example, the first net mass may be about 24.0 kg, while the second net mass may be about 3.0 kg. In some embodiments, each member of the first mass member 1720a may have a substantially circular sector shape having a radius of about 14.0 cm. Similarly, each member of the second mass member 1720b may have a substantially circular sector shape having a radius of about 14.0 cm. Further, each member of the first counterbalance mass member 1730a may have a substantially circular sector shape having a radius of about 9.4 cm. Similarly, each member of the second counterbalance mass member 1730b may also have a substantially circular sector shape having a radius of about 9.4 cm. Other embodiments may include mass members having other shapes, dimensions, and masses.

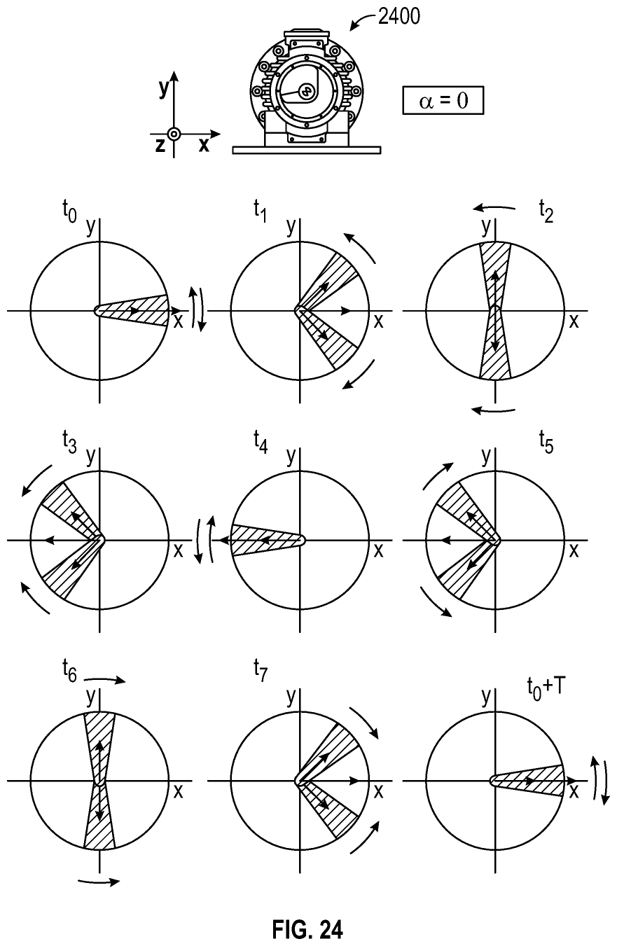

Eccentric vibrator apparatus 1700 may generate a substantially sinusoidal force with an adjustable magnitude and orientation along a direction substantially perpendicular to axis 1702 (e.g., in the x-y plane). In this regard, first shaft 1705a is configured to rotate about axis 1702 in a first direction at an angular frequency ω (a real number in units of rad/s), and second shaft 1705b is configured to rotate about axis 1702 at the angular frequency ω, in a second direction. In certain embodiments the second direction may be opposite the first direction, while in other embodiments, the first and second directions may be the same. The angular frequency ω may have a magnitude of up to about 377 rad/s. Rotation in the first direction causes first mass member 1720a to produce a first radial force Fₐ that is substantially perpendicular to a trajectory of circular motion (i.e., perpendicular to the velocity) of first mass member 1720a (as described in greater detail below with reference to FIGS. 24 to 27). Similarly, rotation in the second direction causes second mass member 1720b to produce a second radial force F_{b} that is substantially perpendicular to a trajectory (i.e., perpendicular to the velocity) of circular motion of second mass member 1720b. Rotation of first shaft 1705a and second shaft 1705b about axis 1702 may yield a resultant force that is substantially contained within a plane perpendicular to the axis 1702 (e.g., in the x-y plane). A linearly oscillating force may be generated when first 1705a and second 1705b shafts are counter-rotating. Alternatively, a force corresponding to circular or elliptical motion may be generated when first 1705a and second 1705b shafts are co-rotating, as described in greater detail below.

A magnitude of the first force Fₐ may be determined, in part, by the angular frequency ω and the moment of inertia of first mass member 1720a. Further, the magnitude of the second force F_{b} may be determined, in part, by the angular frequency o and the moment of inertia of second mass member 1720b. Each member of the first mass member 1720a may have a different mass or may share a common first mass, and each member of the second mass member 1720b may have a different mass or may share a common second mass. In an embodiment, the first and second masses may be approximately equal. In this case, force Fₐ would have a similar magnitude to force F_{b}, irrespective of respective angular positions of first and second mass members. Counter rotation of the first shaft 1705a and second shaft 1705b at angular frequency ω may yield a resultant force F=Fₐ+F_{b} that is maximal at an angular position in which a tangential velocity of first mass member 1720a and a tangential velocity of second mass member 1720b are substantially collinear and oriented in the same direction. Further, the resultant force F may vanish at an angular position in which the tangential velocity of first mass member 1720a and the tangential velocity of second mass member 1720b are substantially collinear and oriented in substantially opposite directions. In an embodiment, the amplitude of the time-dependent resultant force F may have a value of about 89000 N for an angular frequency ω of about 183 rad/s.

In some embodiments, mass members in first mass member 1720a may be embodied as respective first slabs disposed substantially perpendicularly to axis 1702. Each of these first slabs may be elongated and assembled to be substantially parallel to one another. Further, each of these first slabs may be mounted eccentrically on the first shaft 1705a. Similarly, mass members in second mass member 1720b may also be embodied as respective second slabs, also disposed substantially perpendicularly to axis 1702. Each of the second slabs may also be elongated and assembled to be substantially parallel to one another. In addition, the second slabs may be mounted eccentrically on second shaft 1705b.

The first slabs may each have a defined first mass and a defined first size, and the second slabs may also collectively share the defined first mass and the defined first size. Accordingly, the magnitude of the force Fₐ and the magnitude of the force F_{b} may be essentially equal irrespective of the respective angular positions of the first slabs and the second slabs. As mentioned, the counter rotation of first shaft 1705a and second shaft 1705b at angular frequency ω may yield a resultant force F=Fₐ+F_{b} that is maximal at an angular position in which the tangential velocity of the first slabs and the tangential velocity of the second slabs are substantially collinear and oriented in the same directions. Likewise, the resultant force F may be substantially zero (or otherwise negligible) at an angular position in which the tangential velocity of the first slabs and the tangential velocity of the second slabs are substantially collinear and oriented in substantially opposite directions.

In some embodiments, as shown in FIG. 17, first mass member 1720a is assembled in proximity to and spatially separated along axis 1702 from second mass member 1720b. At an angular position in which the tangential velocity of first mass member 1720a and the tangential velocity of second mass member 1720b are substantially collinear and oriented in substantially opposite directions, forces Fₐ and F_{b} described herein may not cancel one another completely due to imperfect alignment between first mass member 1720a and second mass member 1720b, as described in more detail below.

Incomplete cancellation of the forces may result in residual net forces that are oriented along a direction that is transverse to the longitudinal axis 1702. For example, the residual net forces may be oriented along the x direction of the Cartesian coordinate system shown in FIG. 17. The spatial offset between mass members 1720a and 1720b and the residual net forces form a couple, which may distort the linear vibration generated by the eccentric vibrator apparatus 1700. In order to remove or reduce such a couple, first counterbalance mass member 1730a and second counterbalance mass member 1730b are added to eccentric vibrator apparatus 1700, as described above. As illustrated in FIGS. 17 and 18, for example, first counterbalance mass member 1730a and second counterbalance mass member 1730b also are offset relative to one another, along the longitudinal axis 1702. Therefore, due to this spatial offset, counterbalance mass members 1730a and 1730b also generate an additional couple as a result of incomplete cancellation of forces generated by these mass members. By aligning counterbalance mass members 1730a and 1730b in a transverse direction opposite the transverse direction along which mass members 1720a and 1720b are oriented, as shown in FIG. 18, for example, the couple resulting from the counter rotation of the counterbalance mass members 1730a and 1730b may cancel the couple generated by the mass members 1720a and 1720b.

In some embodiments, mass members in first counterbalance mass member 1730a may share a common first mass, and mass members in second counterbalance mass member 1730b may share a common second mass. A magnitude of masses 1730a and 1730b may therefore be essentially equal. The magnitude of the first and second masses of counterbalancing mass members 1730a and 1730b may be configured to be less than the net mass of mass members 1720a and 1720b, due to differences in spatial offsets, as needed to cancel unwanted residual couple from interaction of mass members 1720a and 1720b.

As illustrated in FIG. 17, first mass member 1720a and first counterbalance mass member 1730a may be assembled to have an offset relative angular alignment. In addition, second mass member 1720b and second counterbalance mass member 1730b may also be assembled to have the same relative alignment offset. The relative alignment offset may be indicated by an angle θ (a real number in suitable units, such as radians or degrees) between a line representative of the orientation of first mass member 1720a and another line representative of the orientation of first counterbalance mass member 1730a.

In an embodiment in which θ is essentially equal to π (or 180 degrees), As illustrated in FIG. 18, for example, the resultant force F, due to masses 1720a and 1720b, may be oriented substantially opposite to the resultant force F′ due to masses 1730a and 1730b. As such, a net residual couple force is essentially zero when masses 1720a and 1720b are not aligned. Thus, first counterbalance mass member 1730a and/or second counterbalance mass member 1730b may be utilized to maintain linearity of the vibrational motion produced by the eccentric vibrator apparatus 1700 when shafts 1705a and 1705b are counter rotating, as described in greater detail below with reference to FIGS. 24 to 27.

With further reference to FIG. 17, eccentric vibrator apparatus 1700 includes a first rotor mechanism 1740a that generates rotation of the first shaft 1705a. Vibrator apparatus 1700 also includes a second rotor mechanism 1740b that generates rotation of second shaft 1705b. In some embodiments, first rotor mechanism 1740a may include a first rotor assembly (not shown) mechanically coupled to first shaft 1705a, and a first stator assembly (not shown) electromagnetically coupled to the first rotor assembly. First rotor mechanism 1740a may also include a first bearing assembly (not shown) mechanically coupled to first shaft 1705a near first mass member 1720a, and may further include a second bearing assembly (not shown) mechanically coupled to first shaft 1705a near first counterbalance mass member 1730a. Further, second rotor mechanism 1740b may include a second rotor assembly (not shown) mechanically coupled to second shaft 1705b, and a second stator assembly (not shown) electromagnetically coupled to the second rotor assembly. Second rotor mechanism 1740b may also include a first bearing assembly (not shown) mechanically coupled to second shaft 1705b near second mass member 1720b, and may further include a second bearing assembly (not shown) mechanically coupled to second shaft 1705b near second counterbalance mass members 1730b.

In some embodiments, first rotor mechanism 1740a may include a first feedback device such as an encoder device (not shown) attached to first shaft 1705a. The first feedback device may provide one or more of first information indicative of a respective position of at least one mass member of first mass member 1720a; second information indicative of the angular velocity ω of the first shaft 1705a; or third information indicative of a rotation direction (such as clockwise direction or counterclockwise direction) of the first shaft 1705a. A position of first mass member 1720a is represented by an angle between 0 and 2π per revolution of the first shaft 1705a, relative to a defined origin corresponding to a particular placement of the first shaft 1705a. Rotor mechanism 1740b may further include a second feedback device such as an encoder device (not shown) attached to second shaft 1705b.

The second feedback device may provide one or more of first information indicative of a respective position of second mass member 1720b; second information indicative of angular velocity ω of second shaft 1705b; or third information indicative of a rotation direction of second shaft 1705b. A position of second mass member 1720b is represented by an angle between 0 and 2x per revolution of second shaft 1705b, relative to a defined origin corresponding to a particular placement of the first shaft 1705b.

First feedback device and second feedback device may be embodied as respective encoder devices. Each of the respective encoder devices may be embodied in or may include, for example, a rotary encoder device. A rotary encoder device may include, for example, a 1024 pulse-per-rotation rotary encoder device. An encoder device may include an essentially circular plate that rotates with the shaft (either the first shaft 1705a or second shaft 1705b).

The essentially circular plate may include openings alternating with solid sections. The openings and solid section partition the plate in multiple arcs of essentially equal length, subtending a defined angle Δγy. The greater the number of openings in the encoder device, the smaller the value of Δγ, and thus, the greater the angular position resolution of the encoder device. Each opening may represent a value of an angular position of the shaft. The encoder device may also include, for example, a light source device, a first sensor, and a second sensor. The light source device may illuminate the essentially circular plate, causing the first light sensor to provide an electric signal in response to being illuminated and further causing the second light sensor to provide another electric signal in response to being obscured by a solid section. As the shaft rotates, the first sensor and the second sensor provide respective trains of pulses that may be utilized to determine the angular velocity of the shaft, an angular position of the shaft, and/or a direction of rotation of the shaft. The disclosure is not limited to rotary encoder devices and other types of encoder devices may be utilized in various embodiments.

By controlling respective initial angles of rotation of first shaft 1705a and rotation of second shaft 1705b—and, thus, controlling a relative angle offset between such shafts—a direction of a resultant force generated by first mass member 1720a and of second mass member 1720b may be controlled. As such, a resultant force directed in a required or intended direction perpendicular to the axis 1702 may be achieved by configuring and maintaining initial angles of, and associated relative angle offset between, the respective substantially circular motions of the first shaft 1705a and second shaft 1705b. Configurations of such initial angles may be performed during operation (with the mass member in movement) or at start up (with the mass members at rest) of the eccentric vibrator apparatus.

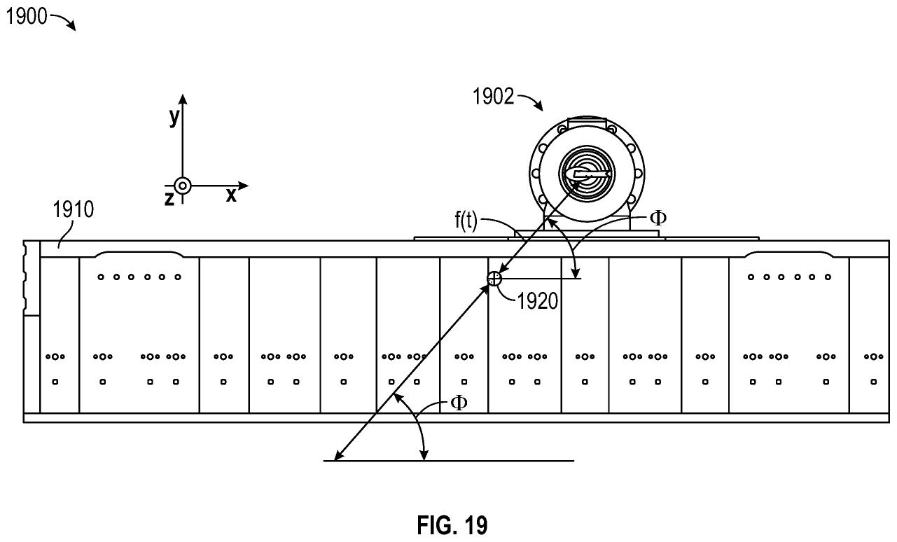

FIG. 19 is a side view of vibratory system 1900 that utilizes eccentric vibrator apparatus 1902, according to an example embodiment. Vibratory system 1900 includes a deck assembly 1910 that is mechanically coupled to eccentric vibrator apparatus 1902 by, for example, coordinated flange members and fastening members (not shown). During operation, eccentric vibrator apparatus 1902 may generate a time-dependent force f(t). Thus, in operation, eccentric vibrator apparatus 1902 may exert a time-dependent oscillatory force f(t) on the deck assembly 1910, causing a time-dependent oscillatory mechanical motion of the deck assembly 1910. The intensity and period of oscillation of the mechanical motion may be determined by the angular frequency ω of rotation of shafts in the eccentric vibrator apparatus 1902 and by other mechanical parameters including moments of inertia.

An amplitude of time-dependent force f(t) may be determined, in part, by the angular velocity ω of the shafts in eccentric vibrator apparatus 1902, by the respective resultant moments of inertia of a first mass member and a second mass member in the eccentric vibrator apparatus 1902, and by the respective moments of inertia of a first counterbalance mass member and a second counterbalance mass member in eccentric vibrator apparatus 1902. The time-dependent force f(t) may be oriented in a direction substantially perpendicular to the longitudinal axis of eccentric vibrator apparatus 1902 (e.g., axis 1702 in FIG. 17). As such, the time-dependent force f(t) may be represented as a three-dimensional vector (fₓ(t), f_{y}(t), f_{z}(t)), where the vector component f_{z}(t) may be substantially null and the time dependent force f(t) may be substantially equal to (fₓ(t), f_{y}(t), 0). In an example scenario in which the deck assembly 1910 starts at rest and eccentric vibrator apparatus 1902 is energized from an power-off state, f(t) may self-align, after a transient period (for example, about 500 ms), into a direction that passes through the position of a center of gravity (CG) 1920 of the deck assembly, in the x-y plane.

Such a self-alignment may occur based on angular momentum conservation in vibratory system 1900 after eccentric vibrator apparatus 1902 is energized. Such alignment may be configured by choice of motor assembly, such as an assembly that includes an asynchronous motor (such as an induction motor) that allows slip between an input frequency and shaft speed. Such a motor may thereby produce torque without reliance on physical electrical connections to a rotor. Accordingly, an angle ϕ indicative of the orientation of the time-dependent force f(t) relative to a base side of the deck assembly 1910 may be determined by the position of the eccentric vibrator apparatus 1902 on the deck assembly 1910, along the x direction in the coordinate system illustrated in FIG. 19.

While the f(t) is illustrated as being strictly collinear with a line having an orientation ϕ, the actual f(t) generated by eccentric vibrator apparatus 1902 traverses, over time, an ellipse having a semi-major axis parallel to the line having orientation ϕ and a semi-minor axis that is much smaller (such as one, two, or three orders of magnitude smaller) than the semi-major axis. Such an ellipse may be referred to as a “tight ellipse.” Specifically, angle ϕ decreases as the coordinate of the eccentric vibrator apparatus 1902 along the x axis increases (or, more colloquially, as the eccentric vibrator is moved forward on the deck assembly) and increases as the coordinate of the eccentric vibrator apparatus 1902 along the x axis decreases (or as the eccentric vibrator is moved rearward). Angle ϕ and the magnitude |f(t)| may determine the respective magnitudes of vector components fₓ(t) and f_{y}(t). For example, small ϕ (that is, a few degrees) may yield a large fₓ(t) and a small f_{y}(t), whereas large ϕ (for example, several tens of degrees) may yield a small fₓ(t) and a large f_{y}(t). Thus, the angle ϕ may adjusted to control a conveyance rate or residence time of particulate matter or other types of solids on an x-z plane of deck assembly 1910.

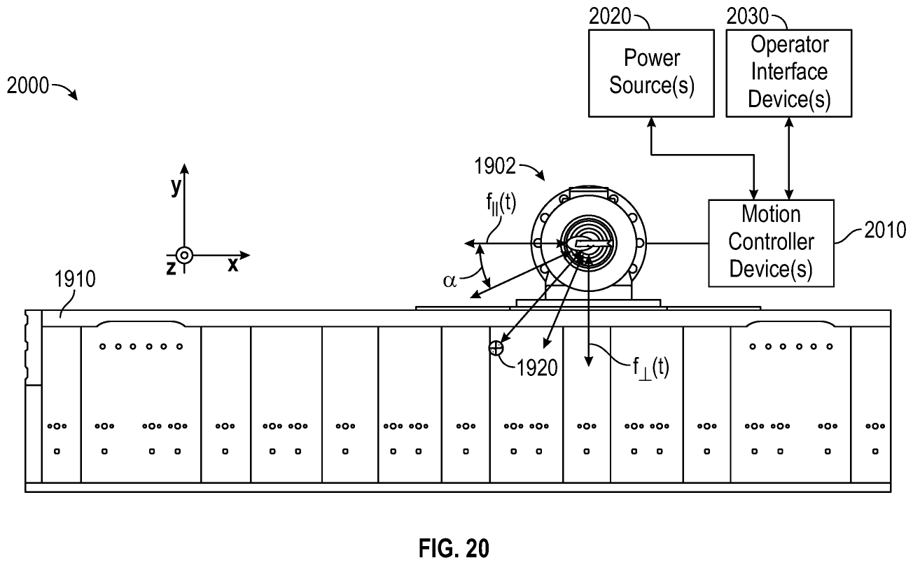

FIG. 20 is a diagram of a vibratory system 2000 that includes a control system functionally coupled to eccentric vibrator apparatus 1902, according to an example embodiment. The control system includes one or more operator interface devices 2030 and one or more motion controller devices 2010. Vibratory system 2000 also includes one or more power sources 2020 that may energize the motor assemblies included in eccentric vibrator apparatus 1902 and/or at least one device of the control system. Power source(s) 2020 may include one or more power supplies and/or a utility power source. Operator interface device(s) 2030 may include input/output (I/O) interface device(s), such as a human machine interface (HMI), which may allow selection of a desired mode of vibration (for example, substantially linear excitation or substantially elliptical or circular excitation).

Operator interface device(s) 2030 may further allow real-time monitoring or intermittent monitoring at particular instants. A mode of vibration may include a defined orientation and a defined magnitude of a time-dependent force f(t) exerted by eccentric vibrator apparatus 1902. The defined orientation is represented by an angle α in FIG. 20. As illustrated, α=0 would correspond to a time-dependent force f_{∥}(t) essentially aligned along an x direction. Stated differently, f_{∥}(t) is essentially parallel to a base side of the of deck assembly 1910. As further illustrated, α=π/2 would correspond to a time-dependent force f_{⊥}(t) that is essentially vertical, along a y direction, where f_{⊥}(t) is essentially perpendicular to the base side of the of deck assembly 1910.

Configuration of a mode of operation may include the configuration of a defined angular frequency of rotation of a shaft of eccentric vibrator apparatus 1902 and/or the configuration of a defined angular offset between a first eccentric mass member of a first motor assembly and a second eccentric mass member of a second motor assembly. An operator interface device 2030 may receive input information indicative of a desired angle α, angular frequency ω, and/or angular offset. The input information may be used to configure a motion controller device 2010 to control vibratory motion of eccentric vibrator apparatus 1902. While the resultant f(t) generated by eccentric vibrator apparatus 1902 is illustrated as being linear with an orientation α, the actual f(t) generated by eccentric vibrator apparatus 1902 traverses, over time, an ellipse having a semi-major axis parallel to the line having the slope α and a semi-minor axis that is much smaller (for example, one, two, or three orders of magnitude smaller) than the semi-major axis.

Depending on desired screen performance, angle α (which may also be referred to as tight-ellipse angle) may be configured to induce slow conveyance of material to be screened, to thereby maximize discharge dryness. Alternatively, angle α may be configured to induce fast conveyance to material to be screened, to thereby increase machine handling capacity, or may be configured to momentarily reverse conveyance of material to thereby dislodge stuck particles (i.e., for de-blinding).

Further, angle α may be adjusted during operation, as described herein, to an angle α′ of about 90° for a defined period of time to attain temporary deblinding of a screen in a screening apparatus. After the defined period, α′ of about 90° may be readjusted to α. Further temporary changes to a mode of operation may be implemented in various embodiments. In one example, a transition from an angle α₀ of about 45° to angle α′ of about 60° may be made to slow conveyance and to cause a drier discharge from a slurry fed into a deck assembly having eccentric linear vibrator 1902. Subsequently, a transition from α′ of about 60° to α₀ of about 45° may be implemented to resume faster conveyance. In another example, an angle α of approximately 45° may be adjusted during operation, as described herein, to an angle α′ of about 30° for a defined period of time to remove accumulated matter on a screen. After the defined period of time, α′ of about 30° may be readjusted to α.

Such an adjustment may be desirable in operation of a screening machine to screen a slurry. During screening, slurry material transforms from a liquid-solid mixture to a dewatered solid. Angle α may be adjusted to increase dryness. For example, if the angle α is increased from about 45° to approximately 60°, as described above, a flow rate of the material on the screening decreases. This decrease in flow rate permits more time for liquid to be driven out of the slurry as the material moves more slowly towards a discharge end of the screening machine.

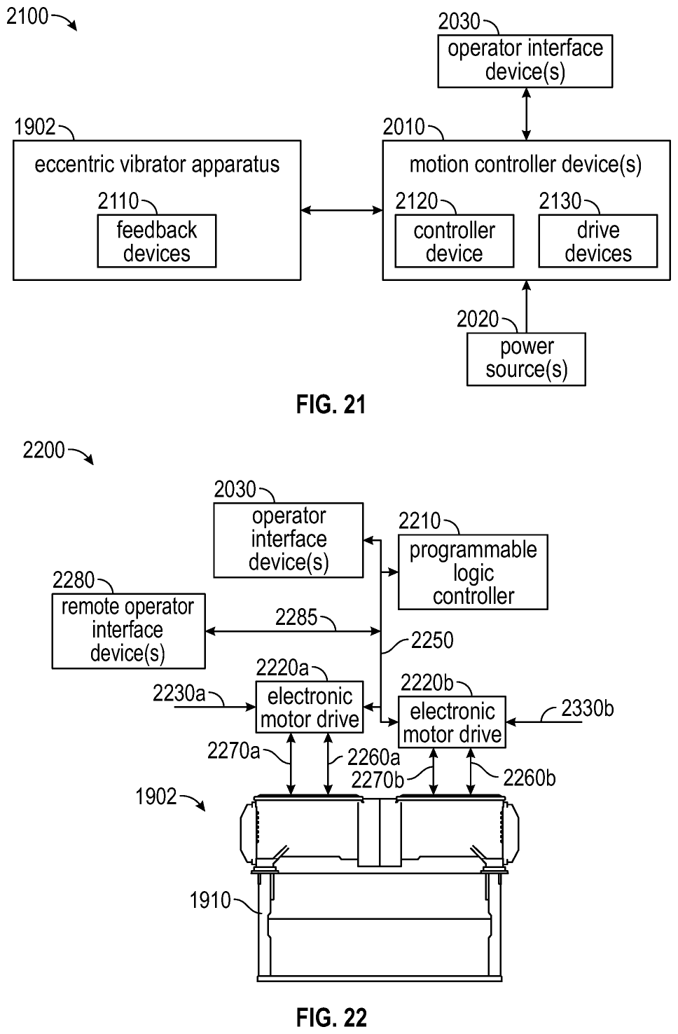

FIG. 21 is a schematic illustration of a system 2100 that may include motion controller device(s) 2010, a controller device 2120, and drive devices 2130. Controller device 2120 may be embodied in or may include a programmable logic controller (PLC), a microcontroller, etc., and drive devices 2130 may be embodied in or may include electronic motor drives, variable frequency drives (VFDs), etc. Controller device 2120 may receive information indicative of position, velocity of eccentric mass members, and/or of direction of rotation of eccentric vibrator apparatus 1902. Controller device 2120 may control drive devices 2130 to generate a specific mode of operation. In this regard, feedback devices 2110 may be coupled to respective shafts of eccentric vibrator apparatus 1902 and may provide first information indicative of respective positions of mass members.

Feedback devices 2110 may also provide second information indicative of respective angular velocities of the shafts. Feedback devices 2110 may provide third information indicative of a direction of rotation of a shaft of eccentric vibrator apparatus 1902. In one embodiment, the first information, the second information, and the third information may be provided directly to controller device 2120. In another embodiment, the first information, the second information, and the third information may be provided indirectly to controller device 2120, where such information is provided to respective drive devices 2130, and relayed by drive devices 2130 to controller device 2120. Controller device 2120 may control drive devices 2130 to generate rotational movement of at least one of the collinear shafts of eccentric vibrator apparatus 1902.

Feedback devices 2110 may include a first feedback device (such as a first encoder device) attached to a first shaft of eccentric vibrator apparatus 1902. The first feedback device may send one or more of (a) first information indicative of a respective position of at least one of first mass members of eccentric vibrator apparatus 1902, (b) second information indicative of angular velocity of the first shaft, or (c) third information indicative of a direction of rotation of the first shaft. Feedback devices 2110 may also include a second feedback device (such as a second encoder device) attached to a second shaft of vibrator apparatus 1902. The second feedback device may send one or more of (a) fourth information indicative of a respective position of at least one of second mass members of eccentric vibrator apparatus 1902, (b) fifth information indicative of angular velocity of the second shaft, or (c) sixth information indicative of direction of rotation of the second shaft.

Controller device 2120 may further receive the first information, the second information, the third information, the fourth information, the fifth information, the sixth information, and operator interface device 2030 information and may direct drive devices 2130 to configure rotational movement of the first shaft and second shaft based at least on the received information. In an embodiment, controller device 2120 may receive such information directly from the first feedback device and the second feedback device. In another embodiment, controller device 2120 may receive the first information, the second information, the third information, the fourth information, the fifth information, and/or the sixth information indirectly, where such information is provided to drive devices 2130, and relayed by drive devices 2130 to controller device 2120.

Drive devices 2130 may include a first drive device coupled to a first motor assembly including the first shaft of eccentric vibrator apparatus 1902. Controller device 2120 may direct the first drive device to generate the rotational movement of the first shaft based on one or more of a portion of the first information; a portion of the second information; a portion of the third information and operator interface device 2030 information. Drive devices 2130 may also include a second drive device coupled to a second motor assembly including the second shaft of eccentric vibrator apparatus 1902. Controller device 2120 may direct the second drive device to configure the rotational movement of the second shaft based on one or more of a portion of the fourth information; a portion of the fifth information; a portion of the sixth information and operator interface device 2030 information.

FIG. 22 is a schematic illustration of an eccentric vibrator apparatus 2200 coupled to a control system, according to an example embodiment, as illustrated in FIG. 22, system 2200 may include a controller device 2210 that may be embodied in or may include a programmable logic controller. In addition, drive devices 2130 (e.g., see FIG. 21) may be embodied in or may include a first electronic motor drive 2220A and a second electronic motor drive 2220B. The disclosure is not limited to electronic motor drives that share a common architecture. First electronic motor drive 2220A and second electronic motor drive 2220B may power respective motor assemblies in eccentric vibrator apparatus 1902. In this regard, first electronic motor drive 2220A may include an electronic inverter or another type of power supply coupled (for example, electromechanically coupled) to a first motor assembly by, for example, a power line assembly 2260A. Second electronic motor drive 2220B may include an electronic inverter or another type of power supply coupled to a second motor assembly by a second power line assembly 2260B.

First and second power line assemblies 2260A and 2260B may include, for example, an electrical conductor, power connectors, insulating coatings, etc. First electronic motor drive 2220A and second electronic motor drive 2220B may be coupled to respective power lines 2230A and 2230B that are connected to a utility power source (such as a 50 Hz AC power source or a 60 Hz AC power source). Further, first electronic motor drive 2220A may be coupled (electrically or electromechanically) to the first feedback device of eccentric vibrator apparatus 1902 by a first bus 2270A. Second electronic motor drive 2220B may also be coupled (electrically or electromechanically) to a second bus 2270B. First and second bus structures 2270A and 2270B allow transmission of information (analog and/or digital) that may represent angular position, angular velocity, and/or direction of rotation of a shaft of eccentric vibrator apparatus 1902. The disclosure is not limited to buses that share a common architecture.

As is further illustrated in FIG. 22, system 2200 may further include operator interface device(s) 2030 and remote operator interface device(s) 2280. Operator interface device(s) 2030, programmable logic controller 2210, first electronic motor drive 2220A, and second electronic motor drive 2220B may be coupled by network devices 2250 (such as a high-speed network device or bus). Network devices 2250 may allow exchange of information (for example, data and/or signaling) between operator interface device(s) 2030, programmable logic controller 2210, first electronic motor drive 2220A, and second electronic motor drive 2220B. One or more of remote operator interface device(s) 2280 may be coupled to a network device 2250 via wireless links and/or wired links 2285. Device(s) 2280 may allow configuration and/or monitoring of operation of eccentric vibrator apparatus 1902.

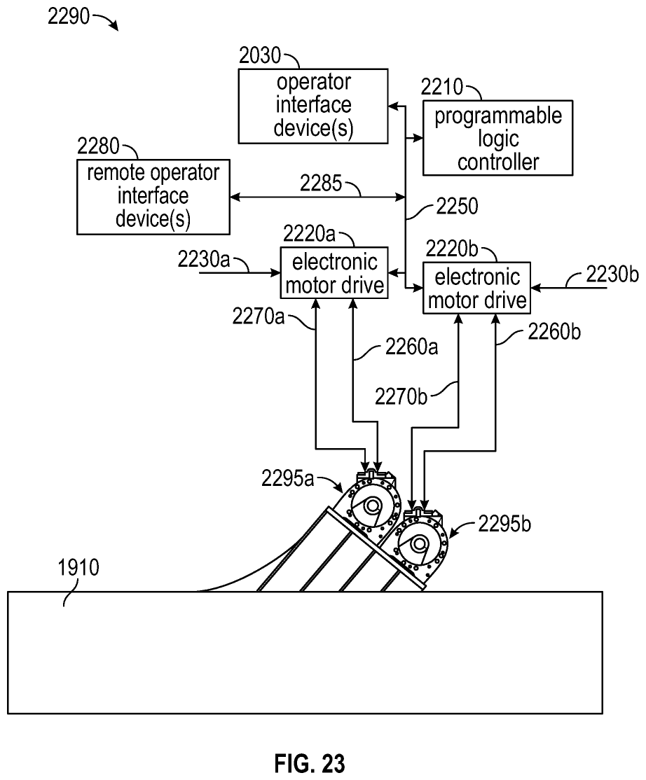

FIG. 23 is a schematic illustration of a vibratory system 2290 having a control system that is functionally coupled to other types of eccentric motors to thereby control a type of motion generated by the eccentric motor. For example, a control system may be functionally coupled to conventional eccentric motors 2295a and 2295b, such as eccentric motors that do not include collinear shafts. A mode of rotation (for example, magnitude of angular velocity and direction of rotation) of each one of the conventional motors 2295a and 2295b may be controlled independently, according to an embodiment. For example, to generate an essentially linear mechanical excitation, a PLC 2210 may direct a first electronic motor drive 2220A to cause eccentric motor 2295a to rotate in a first direction at an angular velocity ω. PLC 2210 may further direct a second electronic motor drive 2220B to cause eccentric motor 2295b to rotate in a second direction opposite the first direction, at the angular velocity ω. In another example, to generate an essentially circular mechanical excitation, PLC 2210 may direct first electronic motor drive 2220A to cause eccentric motor 2295a to rotate in a first direction at an angular velocity ω. PLC 2210 may further direct second electronic motor drive 2220B to cause eccentric motor 2295b to rotate in the first direction as well, at the angular velocity ω.

As described above, control system that includes motion controller device(s) 2010 (e.g., see FIG. 20) may generate a predetermined mode of operation of a disclosed eccentric vibrator apparatus. The control system may configure and/or monitor the respective movements—such as respective angular velocities and angular positions—of collinear shafts included in the eccentric vibrator apparatus independently and continuously, nearly continuously, or at specific times (for example, periodically, nearly periodically, or according to a schedule). For example, a mode of operation may be monitored and/or configured as desired in nearly real time (or essentially periodically, at time intervals significantly shorter than, such as a hundredth part, a thousandth part, a millionth part, and so forth, of a period of revolution 1/ω of a shaft of the apparatus) without powering off the eccentric vibrator apparatus. In this regard, motion controller device(s) 2010 may employ various techniques, including electronic gearing to configure the angular velocity and/or angular position of a shaft during operation of the eccentric vibrator apparatus, without needing to power down the eccentric vibrator apparatus to perform a reconfiguration operation.

As described above, the control system may be configured to set and maintain a relative angle offset between respective rotational movements of collinear shafts of an eccentric vibrator apparatus. In this regard, the control system may impose respective initial angles of respective rotational movements of the collinear shafts. The respective initial angles may be defined relative to a reference coordinate system and may determine an orientation of oscillation of a resultant force f(t) (an essentially sinusoidal force) produced by the eccentric vibrator apparatus. The orientation may be represented by an angle relative to a defined direction in a reference coordinate system. For example, the reference coordinate system may be a Cartesian system having an axis (for example, a z-axis as shown in FIG. 20) essentially parallel to the longitudinal axis of the eccentric vibrator apparatus. A direction representing an orientation of the oscillation of the resultant force f(t) may lie in a plane (e.g., in the x-y of FIG. 20) that is normal to the z axis.

FIGS. 24-27 illustrate schematic force diagrams for four respective configurations of initial angles and associated relative angle offsets, at nine different instants during operation of an eccentric vibrator apparatus 2400 in accordance with embodiments described herein.

FIG. 24 illustrates force configurations at instants t₀, t₁, t₂, t₃, t₄, t₅, t₆, t₇, and t₀+T for initial angles equal to 0 for both collinear shafts in eccentric vibrator apparatus 2400, resulting in a relative angle offset essentially equal to 0. At any given instant, forces are indicated by arrows within the circle, and shaded regions indicate positions of respective masses. Arrows external to the circle indicate velocities. Forces corresponding to respective pluralities of mass member are represented with thin arrows, and resultant forces F are represented with thick arrows. In this example, angles are defined relative to the Cartesian coordinate system shown in FIG. 24, and T represents a period of the rotation of the collinear shafts. For the initial angular configuration and associated relative angle offset of this example, a first mass member of eccentric vibrator apparatus 2400 may be essentially aligned with a second mass member at angles 0 and π, As illustrated by the diagrams corresponding to t₀ and t₄.

At each instant, the force exerted by a given mass (e.g., shown by a thin arrow in the circle) is essentially perpendicular to the velocity (e.g., shown by an arrow outside of the circle) of the mass members. The masses generate forces that share a common magnitude. For example, a first mass member and a second mass member may exert, respectively, a force Fₐ and a force F_{b}, where |Fₐ|=|F_{b}|. As shown in FIG. 24, for initial angles essentially equal to 0, the resultant force f(t) may be oriented along the x direction, or parallel to a base of the eccentric vibrator apparatus 2400. Further, forces cancel at instants t₂ and t₆ and point in the negative x direction at instant t₄. The configuration of FIG. 24 therefore causes horizontal, side-to-side vibration of equipment (such as a deck assembly or screen basket) onto which the force is exerted. For instance, a screen frame or deck assembly may vibrate with oscillations in a plane that is essentially horizontal.

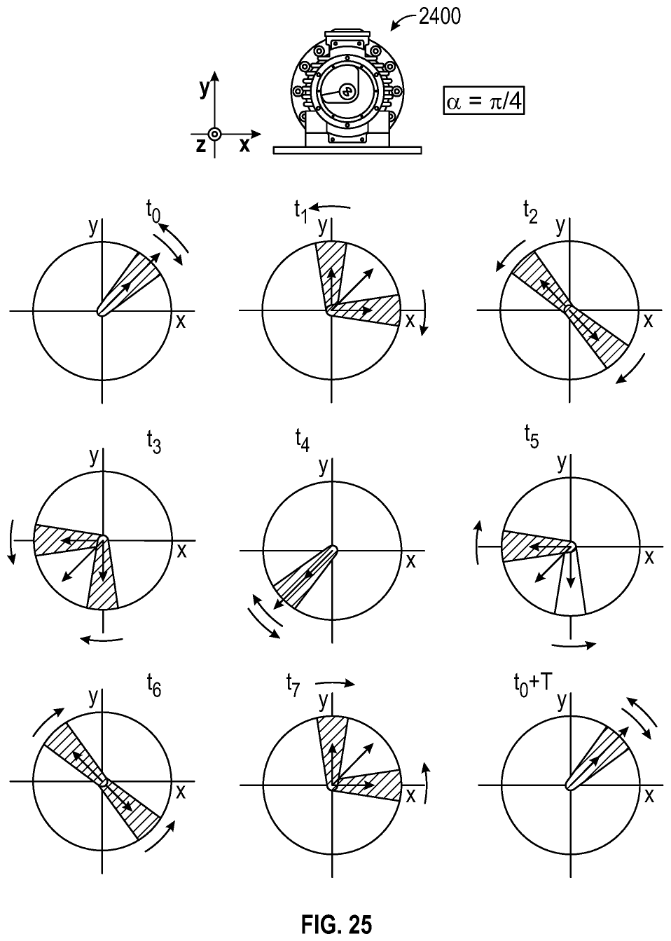

FIG. 25 illustrates a second mode of vibration in which a linear oscillation is oriented at an angle with respect to the horizontal, in accordance with an embodiment of the disclosure. In this example, the control system may momentarily delay the first shaft and momentarily increase speed of the second shaft of the eccentric vibrator apparatus, thus configuring respective initial angles of the first shaft and the second shaft that yield a relative angle offset approximately equal to π/4 (set t2 equal to t₀ in FIG. 25). In FIG. 25, one of the mass members may be advanced, for example, by π/4 and the other one of the mass members may be delayed, for example, by π/4. Therefore, the first mass member may be essentially aligned with the second mass member at angles π/4 and 5π/4, as illustrated by the diagrams corresponding to t₀ and t₄. For such initial angles and associated relative angle offset, the resultant force f(t) may be oriented at about π/4 relative to the base of the eccentric vibrator apparatus 2400.

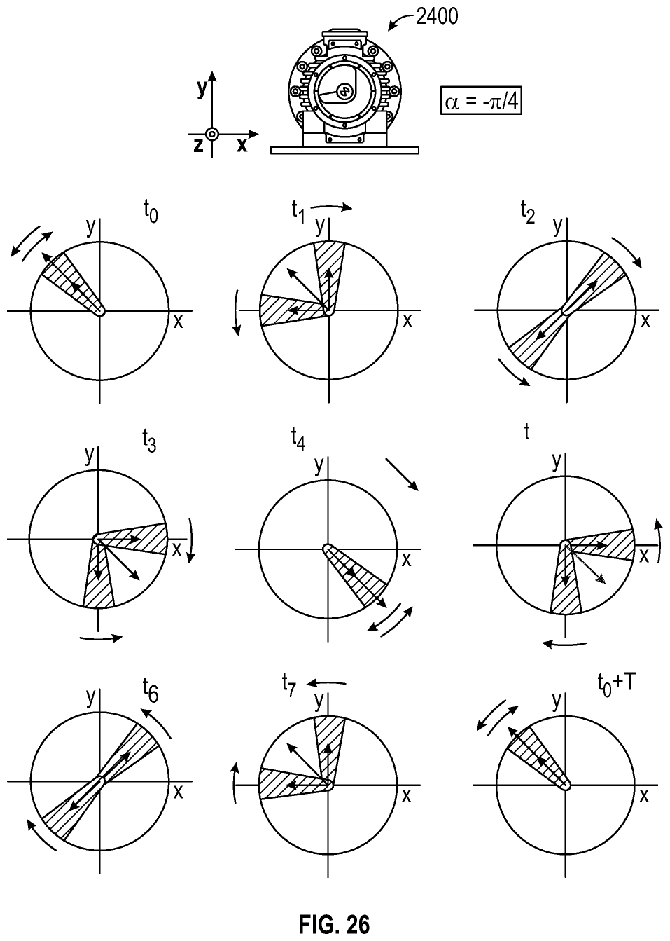

FIG. 26 illustrates a third mode of vibration in which a linear oscillation is oriented at an angle with respect to the horizontal, in accordance with an embodiment of the disclosure. By setting the initial angles of rotation of the first shaft and the second shaft to be approximately 3π/4, a relative angle offset of about 3π/4 may be attained, as is shown in FIG. 26 (set t₂ equal to t₀ in FIG. 26). In this example, the first mass member may be essentially aligned with the second mass member at angles 3π/4 and 7π/4, As illustrated by the diagrams corresponding to instants t₀ and t₄ in FIG. 26. Thus, rotating the orientation of oscillation of the resultant force f(t) by an angle π/2 relative to the orientation for a relative angle offset of π/4 (see FIG. 25), causing such a force to be essentially aligned with the other diagonal of the x-y plane of the Cartesian coordinate system relative to the motion of FIG. 25.

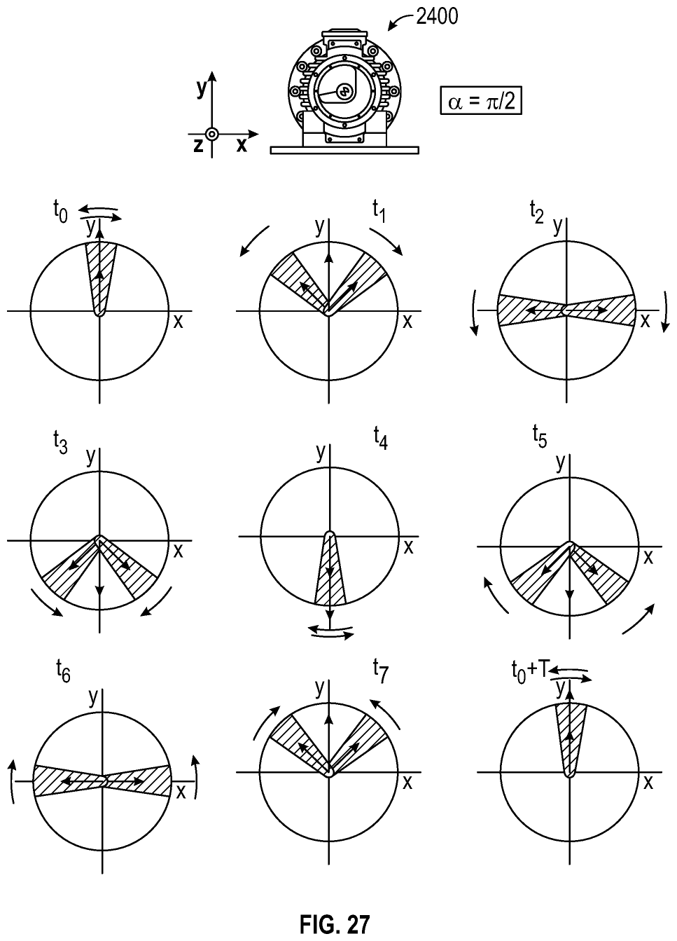

FIG. 27 illustrates a fourth mode of vibration in which a linear oscillation is oriented at an angle with respect to the horizontal, in accordance with an embodiment of the disclosure. The control system may set the initial angles of respective rotations of the first shaft and the second shaft to π/2, causing a relative angle offset of approximately π/2, as is shown in FIG. 27. In this example, a first mass member may be advanced, for example, by π/2 while a second mass member may be advanced by π2. As such, the first mass member may be essentially aligned with the second mass member at angles π/2 and 3π/2, As illustrated by the diagrams corresponding to t₀ and t₄ in FIG. 27 (set t₁ equal to t₀ in FIG. 27). The oscillation of the resultant force f(t) may therefore be oriented essentially perpendicular to the horizontal (i.e., aligned along the y direction). As such, the motion is essentially a vertical, up-down vibration. In this mode of vibration, a screen frame or deck assembly may be caused to vibrate with a linear oscillatory motion that is essentially perpendicular to the ground.

The control systems described herein may cause changes to angles of respective rotations of collinear shafts during the operation of an eccentric vibrator apparatus. In this regard, a plane of oscillatory motion may be changed while the eccentric vibrator apparatus is running. In a different mode of operation, the vibratory motion may be changed from a linear oscillation to a circular or elliptical oscillation. For example, a control system may cause collinear shafts of an eccentric vibrator apparatus to rotate in a common direction and at a common angular velocity to generate an essentially circular mechanical excitation. For example, while the system is generating linear motion with counter rotating masses, the control system may change the direction of rotation of a first shaft (or, in some instances, a second shaft) of the substantially collinear shafts to be reversed. Upon such a reversal, the control system may also cause the first shaft and the second shaft to be angularly aligned—neither the first shaft nor the second shaft is angularly advanced or angularly retarded relative to the other shaft. Thus, the substantially collinear shafts are configured to rotate in a common direction at a common angular frequency ω, without an angular shift between the shafts, resulting in a substantially circular motion of the eccentric vibrator apparatus. In further embodiments, elliptical as well as circular vibrations may be implemented with masses rotating in the same direction but with relative offsets.

In further embodiments, an eccentric vibrator apparatus may generate a substantially circular mechanical excitation, without reliance on a control system to configure circular motion and to provide power. In such embodiments, a direction of rotation of a shaft of the eccentric vibrator apparatus may be reversed by changing a polarity of two of three incoming power leads of a three-phase asynchronous induction motor that generates rotation of the shaft. For example, a three-phase system may include (i) a first line power L1, a second line power L2, and a third power line L3, and (ii) a first motor terminal T1, a second motor terminal T2, and a third motor terminal T3. Clockwise rotation of a shaft may be accomplished by connecting L1 to T1, L2 to T2, and L3 to T3. Alternatively, counterclockwise rotation of the shaft may be achieved by switching L1 to be connected to T3, maintaining L2 connected to T2, and switching L3 to be connected to T1.

A control system may allow real-time or nearly real-time control of motor assembly speed and/or vibrating force direction. A rate at which particulate matter is conveyed from a feed end to a discharge end of a separator system may, in turn, be controlled by controlling characteristics of an eccentric vibrator apparatus that is coupled to the separator system. In addition to shaker systems, an eccentric vibrator apparatus may be coupled to feeders, such as vibratory feeders, where feed rate of material may be accurately controlled. As an example, in high-volume processing applications, conveyance rate may be increased to move particulate matter or other types of solids away from a screening surface and/or to expose a screening surface area to an incoming flow of matter. As another example, a conveyance rate may be decreased to increase dryness of screened material by increasing a residence time of the material on a screening surface.

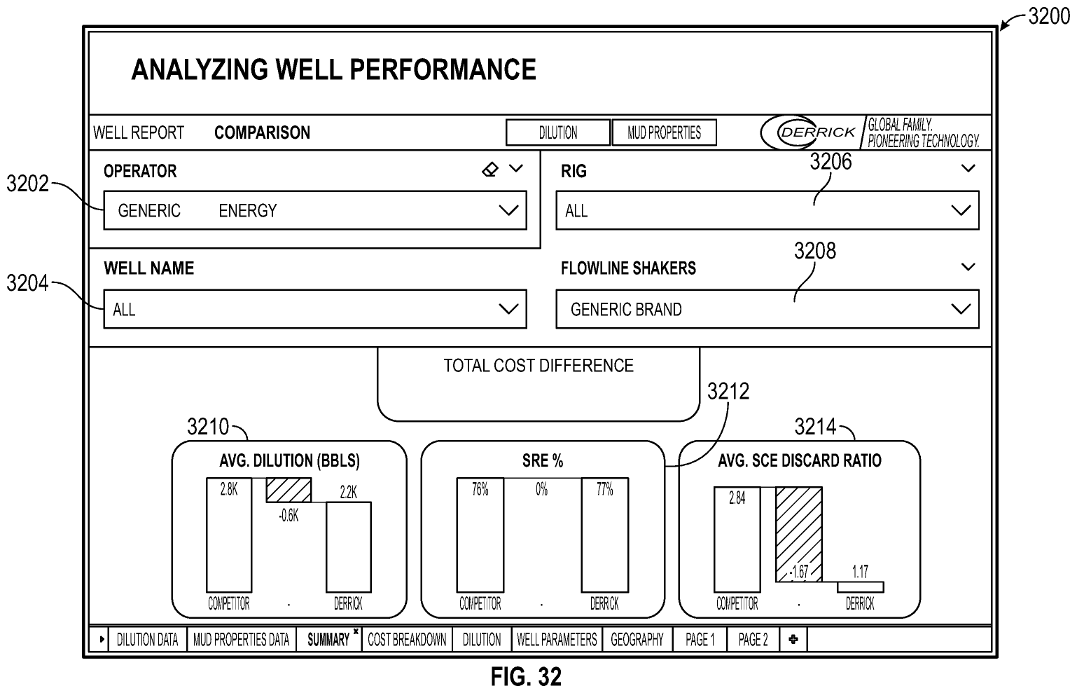

As will be described in greater detail below in reference to FIGS. 32-35, the dilution savings are displayed to the user within a user interface 3200 as a comparison in the Dilution Ratio 3510 and the SCE losses 3512 between the proprietary rigs and the third-party rigs. In some instances, the user interface 3200 may provide recommendations on how to improve the operators rigs, such as by adjusting solids controls to increase efficiency of the solids system, thereby reducing waste, improving dilution, and reducing cost. Additional drilling mud parameters may be compared and displayed in the user interface 3200. For example, a comparison of water (bbls) 3514, barite 3516, chemical 3518, and base oil 3520 may show how the wells compare in their performance. The user may then make informed decisions on changes to the well operating parameters to improve the well performance.

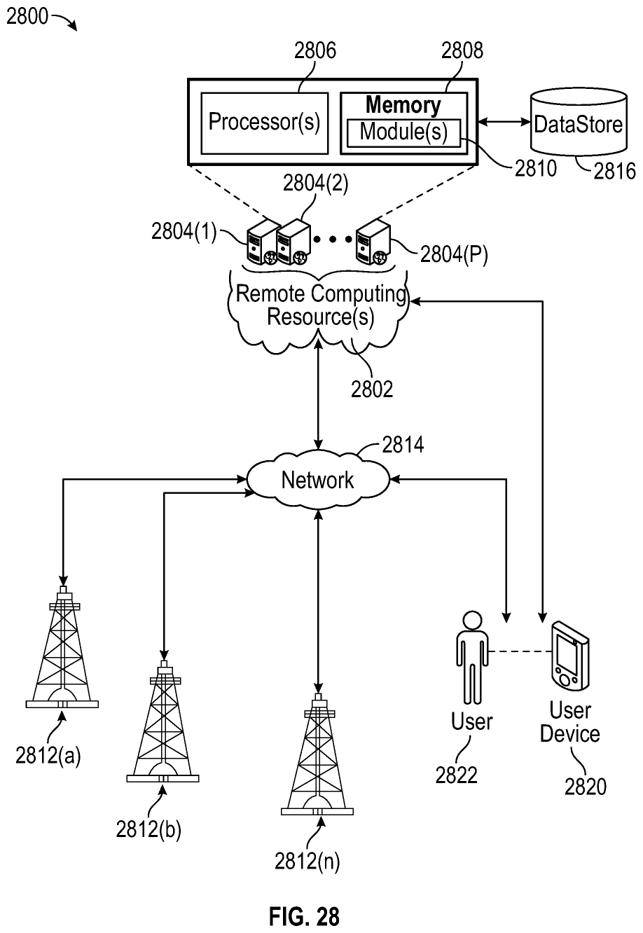

FIG. 28 illustrates a schematic representation of a system configured to generate data and visual representations associated with drilling mud quality and efficiency. The system may provide important feedback, statistics, and efficiency, which may be used to inform business decisions regarding operation of solids control equipment. According to some embodiments, a system 2800 includes computing resources 2802, which may be remote from a drilling site. Computing resources 2802 may be any suitable type of computing system as described herein, and may include one or more servers, a distributed computing platform (e.g., cloud computing services), or some other type of infrastructure or networked computing resources. In some embodiments, the computing resources 2802 include one or more server computers 2804(1), 2804(2), . . . 2804(P) which may be located in any suitable location and may share tasks required of the system. The computing resources 2802 have one or more processors 2806 and memory 2808. Memory 2808 stores one or more sets of computer readable instructions 2810, which include instructions that, when executed, cause computing resources 2802 to perform various operations (e.g., by executing procedures, routines, and tasks).

According to some embodiments, computing resources 2802 receive reports from one or more well sites 2812(a), 2812(b), 2812(n). As an example, computing resources 2802 will receive a report, such as a drilling mud report or fluid volume tracker, from one or more of the well sites 2812(a). The mud report may include data regarding drilling fluids (e.g., drilling mud), which may aid in maintaining hydrostatic pressure, transporting drill cuttings to the surface, cooling a drill bit and drill string, and sealing the wellbore, among other things. Mud reports may include data associated with a mud, such as, but not limited to, density, rheology, fluid loss, chemical properties, and solids control and analysis. Mud reports are typically prepared by a mud engineer and may take any suitable form, such as a physical document, an electronic document, and may be prepared by one or more software applications that receive data from the mud engineer, from one or more sensors, or a combination of sources.

In some examples, at least some portions of the mud report are generated automatically from sensors that capture data associated with a time-dependent state of the drilling mud and/or the drilling equipment. The mud report may be sent to computing resources 2802 through any suitable method, such as a wired connection or a wireless connection utilizing any suitable technology and protocol. In some situations, the mud report is sent to computing resources 2802 in an email. Drilling rigs 2812(a), may be in communication with the computing resources 2802 by a network 2814, such as the internet.

The mud report may typically contain a substantial amount of information about the drilling mud, and an analysis of the report, or a series of reports, may be used to determine changes to the drilling operation to increase efficiency, increase throughput, increase well production rate, reduce cost, and reduce waste, among other things. In some instances, the mud report may include data associated with the current density of the mud, which is the ability of the mud to suspend cuttings or clear obstructions from within the wellbore to the surface. The density of the mud may be determined before entering the wellbore and again after exiting the wellbore to determine the change in density as a result of withdrawing solids from the wellbore.

The mud report may include data associated with rheology of the mud which is indicative of the flow properties of the mud. The rheology data may include data such as a yield point which indicates a shear stress required for the mud to flow; a funnel viscosity which is a measure of the viscosity profile as the mud flows through a funnel; a plastic viscosity which is a measure of viscosity from a rheometer or viscometer; Gels, which measures a gel strength after a predetermined undisturbed time.

The mud report may additionally include data associated with a fluid loss of mud which indicates loss of fluid to maintenance of hydrostatic pressure and other losses. The fluid loss data may include a filtrate volume, cake thickness, static filtration behavior at an elevated temperature and pressure, water loss, etc.

The mud report may additionally include data associated with the chemical properties of the mud, which may be used to ensure that the physical properties of the mud are not changing over time and are not eroding the wellbore. The chemical properties data may include, among other things, a pH which indicates the mud system's hydrogen ion concentration, and its acidity or alkalinity; a total chlorides content in the mud; the levels of K and Ca, a phenolphthalein alkalinity of mud filtrate, a methyl orange alkalinity of mud filtrate, and a clay content in the mud.

The mud report may also include a solids control analysis, which indicates a measure of LGS, a measure of HGS, a percent water in the mud system, a percent oil in the mud system, and a total solids in the mud system, among other parameters.

These properties, along with others, are important performance indicators for well equipment (e.g., efficiency of well production). A mud report may be sent to the computing resources 2802 on a periodic basis, such as once a day, twice a day, four times a day, or another increment. Mud reports may be stored in a datastore 2816 for aggregation and analysis.

Instructions 2810 may include a variety of instructions that perform analyses on the aggregated mud reports, which may provide data that may lead to more efficient operation of the well site, as will be described in further detail, below.

Results of the data analysis may be used to determine recommendations, trends, costs, performance, or other useful information, and may be delivered to a user device 2820 associated with a user 2822. The user may be a stakeholder of the one or more well sites, such as a mud engineer, an investor, an owner, an operator, or some other interested party. In some instances, the analysis performed on the data agglomerated from the mud reports will show trends that may be helpful in operating the solids control apparatus more efficiently, economically, or both.

In some embodiments, a solid-liquid separation system includes one or more sensors that collect data associated with the drilling mud. A shaker is configured to separate a solid-liquid mixture into a first solids-containing component and a shaker effluent, and a centrifuge is configured to separate the shaker effluent into a second solids-containing component and a centrifuge effluent. A signal from a sensor that is configured to measure a property of one or more of the first solids-containing component, the shaker effluent, the second solids-containing component, and the centrifuge effluent, is generated and sent to the computing resources 2802. In some embodiments, a control signal based on the measured property is returned from the computing resources 2802 and may be used to adjust one or more parameters of the mud. In some instances, the control signal sends a recommendation, a control, or a parameter that is used to reduce or minimize a cost metric. The cost metric may depend on one or more of a dilution cost, a disposal cost, an energy cost, mud-replacement, and a maintenance cost, and a NPT cost. Various other cost metrics are contemplated herein, such as any one or more of the cost metrics shown and described in conjunction with FIGS. 5-7, and may be used with any of the embodiments described herein.

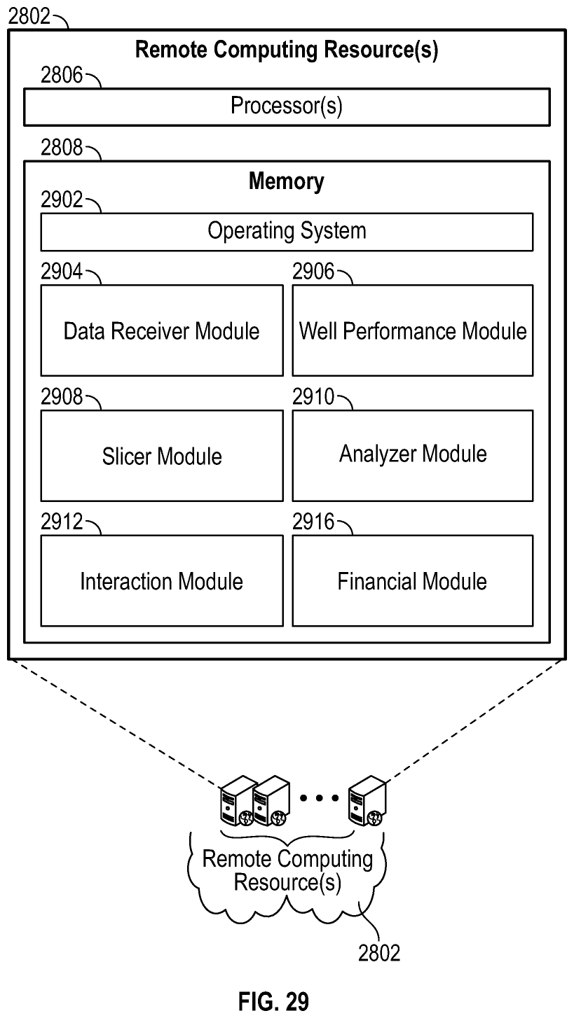

FIG. 29 schematically illustrates computing resources 2802. Computing resources 2802 includes one or more processors 2806, and memory 2808 that stores instructions. The memory stores any suitable operating system 2902 and one or more sets of computer readable instructions. Some exemplary instructions include a data receiver module 2904, a well-performance module 2906, a slicer module 2908, an analyzer module 2910, an interaction module 2912, a trends data module 2914, a financial module 2916, and a user input module 2918, among others.

Computing resources 2802 may be in communication with the datastore 2816 to store and retrieve historical well-performance data. The data receiver module 2904 includes instructions that allow the computing resources 2802 to receive data in any of a variety of formats. In some instances, the computing resource 2802 receives periodic mud reports that are delivered in a machine-readable file format. In some instances, the mud reports are delivered as a fillable form, a spreadsheet, or another type of file format, and may be pushed or pulled from one or more drilling sites, as needed. In some examples, the mud report is sent in an email associated with a mail server accessible by computing resources 2802. Data receiver module 2904 is able to receive the mud report and extract data contained in the mud report. In some embodiments, the data receiver module 2904 is configured to parse an email to determine that an attached file contains a mud report. The data receiver module 2904 may use natural language processing, keyword recognition, or some other type of artificial intelligence to determine the contents of the received data.

Data receiver module 2904 may parse the contents of the mud report and format and/or standardize the data for storage in the datastore 2816. In some embodiments, data receiver module 2904 is configured to standardize various mud reports through a taxonomy that tags the incoming data and stores the incoming data in datastore 2816 according to a predetermined taxonomy for later analysis.

Well-performance module 2906 may access datastore 2816 to determine a historical performance of a well site. This may be performed through data analysis using an algorithm that generates a well performance metric. In some instances, the well performance module 2906 utilizes data such as average dilution, average discard ratio, average production rate, total mud built, and other data types to indicate historical well performance. In some embodiments, incoming data may be analyzed in near real time and a current well performance may be generated.

Slicer module 2908 allows a user to analyze, view, and create reports on a subset of all drilling sites that provide data to the computing resources 2802. For instance, slicer module 2908 may segregate well sites by geography, by owner, by operator, by type, by date, by technology, by manufacturer, or some other filter or combination of filters that allows mud reports to be analyzed and viewed as a subset of all the mud reports that have previously been aggregated. This may help determine whether a drilling rig is operating at similar efficiency levels to other drilling rigs, such as other wells in geographic proximity to a given well.

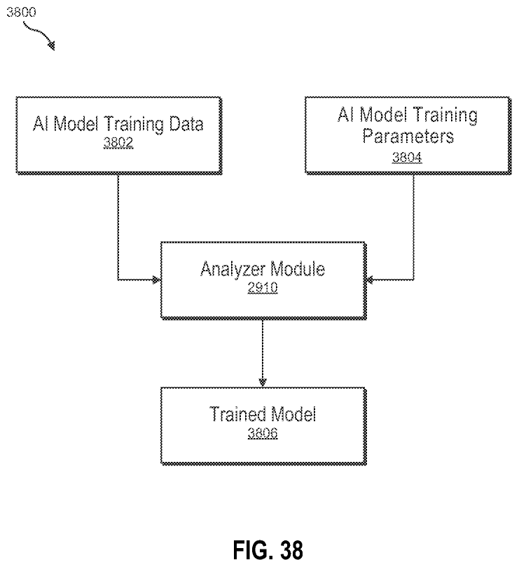

Analyzer module 2910 parses the mud report data stored in the datastore 2816 and determines trends, anomalies, and patterns that may be used to improve operating efficiency of one or more drilling rigs. The analyzer module 2910 may use one or more machine learning algorithms to determine trends and associations. Such a machine learning algorithm may include, without limitation, neural networks, linear regression, nearest neighbor, Bayesian, clustering, K-means clustering, error checking (e.g., value out of range, missing data, etc.), natural language, and others. Additional examples, illustrations, and embodiments of machine learning systems, algorithms, methods, and/or models that may be implemented via one or more of the modules described herein are described below in reference to FIGS. 38-40.

Interaction module 2912 provides an interface that facilitates user interaction. For example, a user interface may be generated to allow one or more users to query data associated with one or more operators, drilling rigs, or wells. Interaction module 2912 may generate a web-based interface that allows a user to interact with computing resources 2802. In some instances, the interaction module 2912 requests log-in credentials with associated individual users and may allow individual users to gain access to only certain portions of data stored in the datastore 2816. For example, a particular well operator may be limited to retrieving, viewing, and analyzing data associated with wells operated by that particular well operator. In some cases, a particular well operator may have access to agglomerated data for other well operators (such as by geographic basin), but may not be able to determine individual data for specific well sites owned by other entities.

The trends data module 2914 may analyze long term trends in various well metrics, as reflected in the data in the data store 2816. The identified trends can relate to trends for a single well, similar trends that appear for multiple wells, trends for wells in the same geographic region, and possibly trends that appear for commonly owned or commonly managed wells. The trends data module 2914 may also generate reports that identify, highlight or explain such trends.

Financial module 2916 may be configured with instructions to output financial models associated with one or more drilling rigs or wells. For example, the financial module 2916 may provide information associated with the economic impact of modifying the solids control configuration of a drilling rig based on empirical data from historical wells. For instance, the financial module 2916 may determine a cost savings associated with reducing the density of the drilling mud and provide a recommendation for maximizing the cost savings.

The user input module 2918 allows users to input data and commands. The user input module 2918 could be used to input or upload data relating to one or more wells that would not otherwise be obtained via the data receiver module 2904.

According to some embodiments, the described systems allow a user to view chronological attributes, for example, dilution, performance, and waste management for particular drilling rigs and wells and to correlate trends in solids control performance with changes in drilling programs. In some embodiments, the systems allow for fair comparisons between drilling sites by slicing the comparable drilling sites through intelligent decision making, such as by slicing by geographic basis. One or more data quality algorithms may be utilized to identify problems with data that the mud engineer provides to the system. In some embodiments, drill basin averages and conditional formatting may be used to provide baselines and performance trends to benchmark solids controls across a broad sample size.

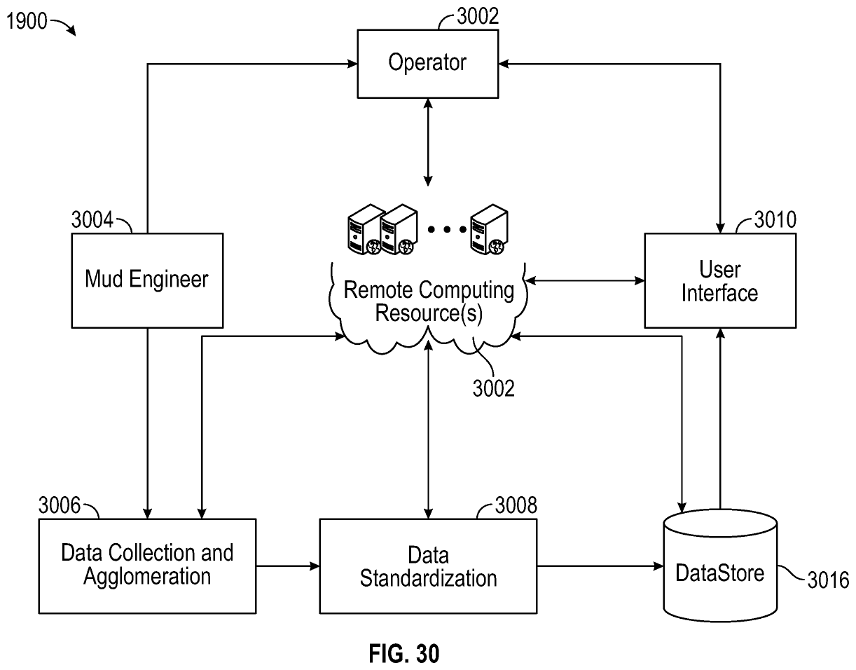

FIG. 30 illustrates a sample data flow schematic 3000 according to some embodiments. A mud engineer 3004 creates a mud report, such as by entering data into a software program, filling in a fillable form, and in some cases, the data is generated by one or more sensors that determine one or more parameters of the drilling mud. The mud report may be sent to multiple locations, such as to an operator 3002 and also to computing resources 2802. In some instances, the mud report may be sent to an email alias, which may be configured to route the mud report to one or more intended recipients, including the computing resources 2802. The mud report may be collected through a data collection and agglomeration 3006 process executed on the computing resources 2802 and may include natural language processing to tag and store the data. The computing resources 2802 may additionally execute a data standardization process 3008 that allows data from different sources and in different formats to be tagged and stored meaningfully for subsequent analysis, filtering, and retrieval. In some cases, the mud reports may use different terminology, have different fields, or use a different format, and the data standardization process 3008 may standardize the terminology and formatting of the mud reports to a uniform data mapping.

The standardized data is then stored in the datastore 2816 for subsequent analysis, filtering, and retrieval. Computing resources 2802 may execute instructions to provide a user interface 3010 that allows a user, such as the operator 3002, to run searches, queries, and receive alerts, notifications, recommendations, and updated machine operating parameters to improve one or more characteristics of the well. In some cases, the operator 3002 may access the datastore 2816 through the user interface 3010 to search for, and retrieve, raw data associated with one or more drilling rigs or wells. In some cases, operator 3002 may retrieve trends or historical data associated with a plurality of drilling rigs or wells, which may be grouped by a predetermined grouping, such as geographic basin, well type, operator-owned, or some other grouping. In some cases, historical statistics may be provided for drilling rigs or wells not owned or controlled by the operator 3002, and the operator may view a comparison of drilling rigs or wells that are controlled by the operator 3002 versus drilling rigs or wells not controlled by the operator 3002.

According to some embodiments, the systems and methods described herein provide a web-based application that enables users to access the data in a meaningful way, such as by having predefined reports available to track the history, trends, and performance of drilling rigs. In some cases, the data is retrievable by a user, but some of the data is not readily identifiable with a particular drilling rig, well, or operator. The level of available detail may be based, among other things, on user credentials to the system. In some embodiments, a user is able to slice the data according to meaningful subset, such as by geographic basin, that allows comparison options between an operator's fleet and those owned by third parties. A user may be able to view chronological information based on drilling rig, well dilution, well performance, and waste management and correlate trends in solids control performance to changes in drilling programs.

In some embodiments, the user interface 3010 provides historical averages, such as according to a geographic basin, and the user may compare a current operating performance with historical baseline performance across an entire geographic basin. In some cases, the data is normalized, such as to account for wells of varying lengths to expand the applicable data sets and provide performance measures.

In some cases, the user interface 3010 allows an operator to review parameters

associated with a well, or a grouping of wells, in order to make informed decisions and actions. For example, a user may view, and act upon, information associated with one or more of AVG well LGS%; Solids Removal Efficiency %; Total Dilution; Total Mud Built; Total Haul-Off (waste volume); Discard Ratio; Dilution Ratio; Total Dilution/Foot; Total Mud Built/Foot; Average Plastic Viscosity; Average Yield Point; Average Mud Weight; Days on Interval; Interval Length; Base Oil Addition Volume; Water Addition Volume; Weight Material Addition Volume; Chemical Addition Volume; Dilution Cost (based on a user-defined cost/bbl); Haul-Off Cost (based on a user-defined cost/bbl); Base Oil Cost (based on a user-defined cost/bbl); Weight Material Cost (based on a user-defined cost/bbl); Basin averages for the metrics above; and Data Quality Analysis and Error Detection, among other factors.

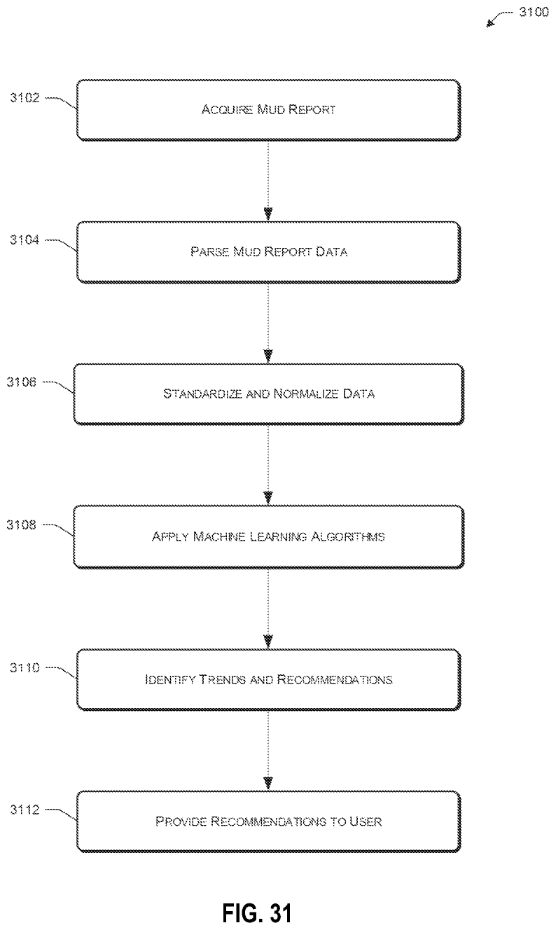

FIG. 31 illustrates an example process flow 3100 for the system according to some embodiments. At block 3102, the system receives one or more mud reports. The mud reports may be sent at regular intervals, such as once a day, multiple times a day, or some other regular or nonregular interval. The mud report may be sent by a mud engineer, or some other person or system associated with a drilling operation. The mud report may be automatically generated, such as by sensors coupled to the drilling equipment. The mud report may be manually generated, and in some cases, the mud report is a combination of automatically generated data and manually obtained data. The mud report may be acquired through any suitable process, such as by receiving an electronic file, pulling data from one or more sensors, through email, or some other method.

At block 3104, the system parses the mud report. This may include opening an attached file, calling an application programming interface (“API”) to extract data, performing natural language processing or semantic processing on the data, or some other process.

At block 3106, the data is standardized and normalized. In some cases, the data may come from different sources, be in different formats, include different tags or semantics, or be associated with different well types and sizes. In these cases, the data may be standardized, such as by applying a taxonomy to the data and assigning standardized tags to the data for categorization. In some cases, the data is normalized such as to account for different well lengths so the data may be compared against data from other wells in a meaningful way.

At block 3108, one or more machine learning algorithms are applied to the data. Any suitable machine learning algorithm may be applied, such as at block 3110 to look for trends, anomalies, or cause and effect, and may be used to generate and provide recommendations for improving well performance. In some instances, recommendations include changes to the solids control configuration to improve performance, increase efficiency, reduce waste, reduce cost, among others.

At block 3112, the recommendations are provided to a user. The recommendations may be delivered through the user interface, or may be pushed to a user, such as through instant communication, for example, text messaging, email, SMS messaging, or some other form of an alert or recommendation.

The system provides numerous improvements to current technology by synthesizing drilling fluid properties, characteristics, and well bore geometry from daily mud reports to measure solids control effectiveness and cost-savings metrics. The mud reports are distributed to stakeholders in the drilling process, and embodiments of the described system acquire the raw data and transform it into decision-quality information, complete with recommendations based upon machine learning algorithms that inform the operator or suggested steps to take to increase productivity, increase well performance, reduce cost, reduce waste, and increase efficiency. The data analysis and recommendation system provides decision-makers, engineers, and technicians with tools and recommendations to optimize solids control configurations and cut costs associated with the drilling process. Embodiments of the described system analyze data and provide metrics to the user that were not previously attainable or possible by simply reviewing the fluids reports (e.g., mud reports and volume tracking spreadsheets). The described system further compares rig and well data against other rigs and wells from the same operator, against aggregated basin averages, and slices this data by a myriad of factors to realize network effects. Further, described embodiments broaden the scope of solids control performance evaluation available to users and focus the tool to provide valuable insights into cost-savings that are application-specific.

Furthermore, embodiments described herein provide a feedback loop in the solids control system and compare fluid and waste-disposal cost savings, fluid properties, and differentiate solids control setups. These improvements to existing technology allow operators to optimize cycle, reduce environmental impact, and enhance the cost-savings of solids control equipment.

FIG. 32 illustrates an example user interface 3200 that may be used with the methods and systems described herein for improved solids control. The user interface 3200 provides a visualization of one or more attributes of a well and in the illustrated embodiment, provides a comparison between the currently selected operator and third-party wells. For example, a selection in the Operator selector 3202 allows a user to select a well operator, which is Generic Energy in the illustrated example. A well name selector 3204 allows the user to choose one or more wells to analyze. In addition, a rig selector 3206 allows one or more rigs at the well site to be selected. A flowline shaker selector 3208 allows a user to specify a type of shaker being used.

Based upon the selected criteria, the system analyzes the data collected in one or more mud reports and displays relevant data according to the selected criteria. For example, the user interface 3200 may display a cost difference by reviewing the Avg. Dilution (bbls) 3210, the SRE % 3212, and the Avg. SCE Discard Ratio 3214.

The system is able to determine these savings based upon historical mud reports acquired by the system. For example, the estimated dilution cost saving may be based on testing data from an oil well. In one example of drilling the well, 1465 bbl of drilling fluid was used for dilution, at a cost of $60/bbl drilling fluid for a cost of $87,166. A total of 1110 bbl of cuttings were drilled and of these cuttings, 1005 bbl were removed and discarded leaving 105 bbl of missed cutting that required dilution. Further, along with the discarded cutting, a total of 1649 bbl of liquid and LGS was discarded including 644.5 bbl of liquid and 1004.7 of LGS. A substantial cost savings may be achieved with an improved solids control system. For example, an improved solids control system may lead to a 13:1 actual dilution ratio, a 50% increase of removal of missed cuttings (i.e., approximately 50 bbl additional cuttings removed), and decreased removal of liquid on cuttings by 125 bbl (i.e., 20% slurry loss). With these estimates, a cost savings of 13*60*50+125*60=$46,500 may be achieved. The user interface 3200 may display these type of cost savings representing a change in operation of the well.

Similarly, disposal costs may be estimated as follows. In an example, a cost of $20/bbl may be assumed to haul away waste. With an improved solids control system that increases solids removal by R bbl, and decreases retained liquid on cutting by O bbl, a cost savings of 20*O−20*R may be obtained. Data from the above-described oil well may also be used to estimate disposal costs. For example, with an example oil well, disposal cost may be $17/bbl to haul waste. A total of 1110 bbl cuttings were drilled and 1649 bbl of waste was discarded. Of the waste discarded, 644.5 bbl was liquid, and 1004.7 bbl was LGS. Using an improved solids control system to increase removed solids by 50 bbl (i.e., 50% of missed cuttings) and to decrease liquid retained on the cutting by 125 bbl (i.e., 20% of slurry lost), leads to a cost savings of 17*125−17*50=$1,275. The user interface is able to display these numerical savings and provide recommendations on how to improve efficiency at the well site.

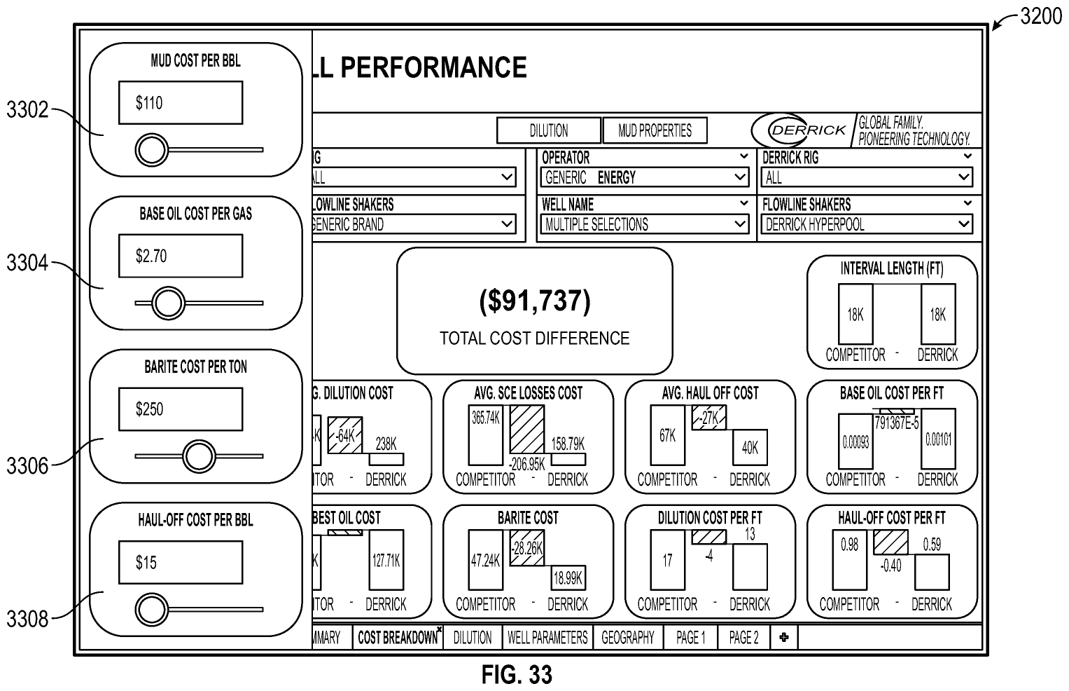

FIG. 33 illustrates an example user interface 3200 showing a cost difference between the selected wells based upon the solids control systems employed at the selected wells. As a comparison, wells are selected for comparison using Generic Brand flowline shakers and a proprietary flowline shaker manufactured and sold by Derrick Equipment Company. A series of variable inputs allow a user to input actual values, such as for mud cost per bbl 3302, base oil cost 3304, barite cost 3306, and haul-of cost per bbl 3308. Based upon these variable values in combination with the acquired mud report data, the system is able to display, through the user interface, a total cost difference between the selected wells. The total cost difference may be based at least upon differences in dilution cost, SCE losses, Haul off costs, Base oil cost, Interval length, Barite cost, and others. Thus, the system is able to display a financial change based upon changing well drilling equipment and operation parameters.

In some embodiments, the system receives inputs from one or more sensors associated with the solid-liquid separation system, such as any of the inputs listed in FIGS., 5-7, Tables 1-6, or described below in reference to FIGS. 36-37. Additionally or alternatively, the system receives inputs via manual input, which may include any of the aforementioned inputs. In some cases, one or more inputs are acquired from sensor data, and one or more inputs are acquired via manual input.

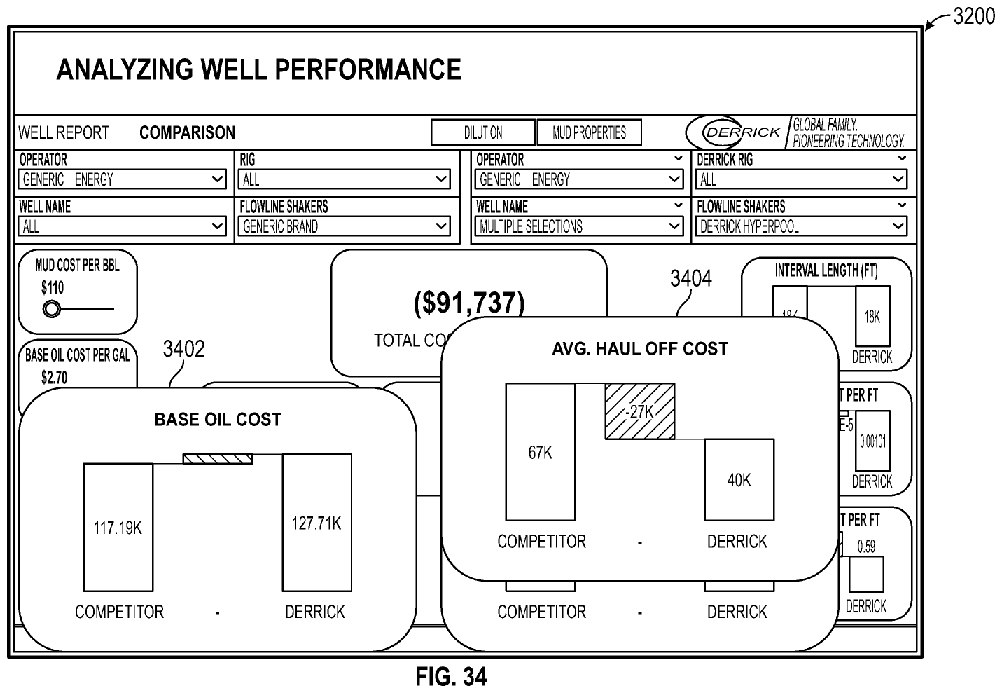

FIG. 34 illustrates another example user interface 3200 showing how a particular operators wells are performing in comparison with third party operated wells. The user interface 3200 may retrieve historical data from the datastore that may be populated with mud reports, daily drilling reports, and other information pertaining to well operation and performance. In some instances, the user interface 3200 will show a comparison of various costs, for example a base oil cost 3402 and an average haul off cost 3404. The wells may be compared, such as for equipment, equipment operating parameters, solids controls, and the user may receive recommendations on how to improve the performance on the selected wells.

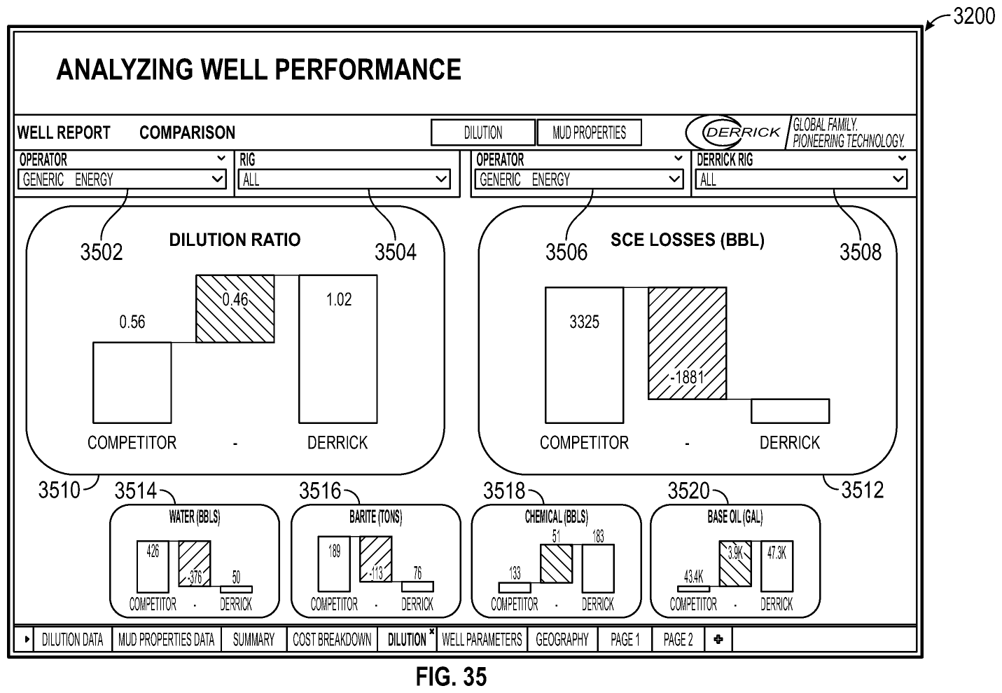

FIG. 35 illustrates an example user interface 3200 that compared dilution between selected wells. For example, a user may select all the rigs for a given operator and compare those with different rigs being run by the same, or a different, operator. In the illustrated example, a first operator selector 3502 allows the user to select an operator and a first rig selector 3504 may be used to select one or more rigs. A comparison panel allows an operator to make a selection in a second operator selector 3506 and a second rig selector 3508. As illustrated, the selectors have used to select a comparison between a proprietary rig and third-party rigs.

As may be appreciated by an examination of the foregoing, various additional and/or alternative sensors and/or sensor devices may be included and/or integrated into the systems, methods, processes, and/or apparatuses described above. For example, in at least one embodiment, a solid-liquid separation system (e.g., solids control system 400, combined sub-system 1000, etc.) that includes a vibratory shaker (e.g., vibratory screening machine 100, vibratory screening machine 200, shaker machine 402a, shaker machine 402b, shaker machine 402c etc.) and/or a centrifuge (e.g., centrifuge 310, centrifuge 404, centrifuge 902, etc.) may further include an acceleration sensor configured to measure an acceleration associated with the vibratory shaker and/or the centrifuge during operation of the solid-liquid separation system.

An acceleration sensor may include any sensor and/or sensor array configured to measure a change in velocity over time of at least a portion of a measured body. By way of illustration, an acceleration sensor may include an accelerometer configured to measure a change in velocity over time of a measured body. In some examples, and acceleration sensor may be configured to measure a change in velocity over time of a first portion of a measured body relative to a change in velocity over time of a second portion of the measured body.

In some examples, an acceleration sensor may be affixed to the measured body and/or a portion of the measured body. In such examples, the affixed acceleration sensor may measure an acceleration of a measured body via inertia and/or force transferred from the measured body to the acceleration sensor during a motion of the measured body. In additional or alternative examples, the acceleration sensor may measure a change in velocity over time of a measured body via contactless means, such as a sensor configured to measure electromagnetic radiation emitted by and/or reflected by the measured body. For example, an acceleration sensor may include a photosensor configured to receive light generated by hand/or reflected by a measured body. Such an acceleration sensor may use data gathered via the photosensor to determine a motion over time of the measured body.

By way of illustration, FIG. 36A shows a perspective view of an example vibratory screening machine 3600 that may be similar in at least some respects to one or more vibratory screening machines described herein (e.g., vibratory screening machine 100, vibratory screening machine 200, etc.). As shown, vibratory screening machine 3600 includes and/or illustrates various possible locations acceleration sensors may be disposed upon and/or affixed to a vibratory screening machine. As shown, an accelerometer 3602 may be affixed to an exterior surface of a wall member of vibratory screening machine 3600. Additional accelerometers 3604 (e.g., additional accelerometers 3604a through 3604h) may be disposed at various locations on an external surface of the wall member of vibratory screening machine 3600. Additionally or alternatively, additional accelerometers 3606 (e.g., 3606a through 3606b may be affixed to an interior surface of a wall member of vibratory screening machine 3600. Furthermore, additional accelerometers 3608 (e.g., 3608a through 3608d) may be disposed upon and/or affixed to various locations on one or more vibrational motors included in vibratory screening machine 3600.

As an additional illustration, FIG. 36B shows a perspective view of an example centrifuge 3700 that may be similar in at least some respects to one or more centrifuges described herein (e.g., centrifuge 310, centrifuge 404, centrifuge 902, etc.). As shown, example centrifuge 3700 includes and/or illustrates various possible locations acceleration sensors 3702a through 3702f may be disposed upon and/or affixed to a centrifuge 3700.

Each accelerometer illustrated in FIGS. 36A and 36B may independently measure an acceleration associated with a different portion of example vibratory screening machine 3600 and/or example centrifuge 3700. For example, accelerometer 3604a may measure an acceleration associated with a first portion of vibratory screening machine 3600, accelerometer 3604b may measure an acceleration associated with a second portion of vibratory screening machine 3600, and so forth. Additionally or alternatively, in some embodiments, a plurality of accelerometers, each configured to measure an acceleration of a different portion of vibratory screening machine 3600 or centrifuge 3700, may form an acceleration sensor. In such examples, a sensor signal from the acceleration sensor may include a plurality of accelerometer signals, each signal in the plurality of accelerometer signals associated with a different accelerometer in the plurality of accelerometers. In this way, an array of a plurality of accelerometers may provide an overall view of an acceleration of a solid-liquid separation system.

Note that the examples illustrated in FIGS. 36A and 36B are provided by way of example only, and do not limit the scope of this disclosure. Therefore, notwithstanding the examples illustrated in FIGS. 36 and 37, acceleration sensors and/or accelerometers may be configured to monitor acceleration of any portion of a solid-liquid separation system as disclosed herein.

FIG. 37 depicts a solids control system that includes four vibratory screening machines 3600A/3600B/3600C/3600D and two centrifuges 3700A/3700B. This diagram will be used to explain how flows of materials through a solids control system can be regulated to balance the loads placed upon the vibratory screening machines and the centrifuges based on signals from accelerometers mounted on the vibratory screening machines and the torque being applied to the centrifuges.

As illustrated in FIG. 37, there are accelerometers mounted at various locations on the vibratory screening machines. As explained above in connection with FIG. 36A, such accelerometers can be mounted at various different locations on a vibratory screening machine to detect the accelerations being experienced at various locations on the vibratory screening machine. The signals from those accelerometers can be used individual, or the information provided via the signals from multiple accelerometers can be combined to give an overall indication of the accelerations being experienced by the vibratory screening machines.

In the solids control system depicted in FIG. 37, three accelerometers 3624A/3624B/3624C are mounted on the first vibratory screening machine 3600A. Similarly, three accelerometers 3624D/3624E/3624F are mounted on the second vibratory screening machine 3600B, three accelerometers 3624G/3624H/3624I are mounted on the third vibratory screening machine 3600C and three accelerometers 3624J/3624K/3624L are mounted on the fourth vibratory screening machine 3600D.

As explained above, when the accelerometers mounted on a vibratory screening machine indicate that the machine is undergoing large accelerations, this can indicate that the machine is lightly loaded. Conversely, of the accelerometers mounted on a vibratory screening machine indicate that the machine is undergoing only small accelerations, this can indicate that the machine is heavily loaded. Of course, the degree to which the vibrators on a machine are operating to induce vibrations also play a role. However, if the vibrators on all four of the vibratory screening machines 3600A/3600B/3600C/3600D depicted in FIG. 37 are operating in a similar fashion, then differences in the reported accelerations being experienced by the machines can be due to differences in how much material is being handled by the vibratory screening machines. For example, if the accelerometers on the first vibratory screening machine 3600A and the fourth vibratory screening machine 3600D report high accelerations and the accelerometers on the second vibratory screening machine 3600B and third vibratory screening machine 3600C report low accelerations, this can indicate that the second and third vibratory screening machines 3600B/3600C are more heavily loaded than the first and fourth vibratory screening machines 3600A/3600D.

As also depicted in FIG. 37, the material feed line 3620 that delivers material into the vibratory screening machine branches into four segments, one for each vibratory screening machine. Also, there are electrically controlled valves 3622A/3622B/3622C/3622D installed on the respective four branches of the material feed line 3620. Control signals applied to the electrically controlled valves 3622A/3622B/3622C/3622D allow one to independently control the amount of material being delivered to each of the four vibratory screening machines 3600A/3600B/3600C/3600D.

If the accelerometers mounted on the vibratory screening machines 3600A/3600B/3600C/3600D report that one of the vibratory screening machines is experiencing less acceleration than the other vibratory screening machines, one can apply control signals to the electrical control valve on the branch of the material feed line leading to that vibratory screening machine to reduce the amount of material flowing to that vibratory screening machine. Thus, by monitoring the signals reported by the accelerometers mounted on the vibratory screening machines, and applying suitable control signals to the electrically controlled valves 3622A/3622B/3622C/3622D, one can balance the load being experienced by the vibratory screening machines.

As illustrated in FIG. 37, solids are carried away from the vibratory screening machines 3600A/3600B/3600C/3600D by a solids removal line 3632. The effluent that passes through the vibratory screening machines 3600A/3600B/3600C/3600D is collected in an effluent collection line 3630 that carries the effluent to the two centrifuges 3700A, 3700B. The effluent collection line 3630 separates into two branches that feed the two centrifuges 3700A, 3700B, and electrical control valves 3724A and 3724B control a flow of the effluent through the two branches.

FIG. 37 also depicts that bowl motors 3712A/3712B drive the bowls of the respective centrifuges 3700A/3700B. The bowl motors 3712A/3712B are controlled by respective variable frequency drives 3714A/3714B. Also, conveyer motors 3710A/3710B under the control of variable frequency drives 3716A/3716B drive the conveyers in the centrifuges. Information obtained from the variable frequency drives 3714A/3714B and 3716A/3716B can provide an indication of the amount of torque being applied to the elements of the centrifuge. That torque information can in turn be indicative of the loading of the centrifuges. As explained above, the greater the torque being applied to the centrifuge, the greater the load on the centrifuge.

One can use the torque information to determine the respective loads places on the centrifuges 3700A/3700B. One can then use that information to apply signals to the electrically operated valves 3724A/3724B on the branches of the effluent supply line 3630 to balance the load of effluent being delivered to each of the two centrifuges 3700A/3700B.

Solids are then carried away from the centrifuges via a solid extraction line 3732 and effluent is carried away from the centrifuges 3700A/3700B via an effluent extraction line 3730.

The foregoing example provided in conjunction with FIG. 37 is but one way to balance the loads being experienced by the vibratory screening machines and centrifuges of a solids control system. In alternate embodiments, the flow rates of materials being delivered into each of the elements of the solids control system could be sensed in alternate ways, and control could then be exerted over the electrically operated valves to help balance the loads across the elements of the system. As another alternate example, signals from accelerometers mounted on the centrifuges 3700A/3700B could also be used to sense the respective loading of the centrifuges 3700A/3700B. Such accelerometer signals could be used in lieu of the torque values, or the torque information and information from the accelerometer signals could be used together to determine the relative loading of the centrifuges 3700A/3700B.

In embodiments of the systems and methods described herein that include acceleration sensors, a processor circuit may be configured to receive, from the acceleration sensor, a sensor signal representing the measured acceleration. The processor circuit may be further configured to determine a change in a load percentage of a component of the solid-liquid separation system based on the measured acceleration, and identify, based on the change in the load percentage of the component of the solid-liquid separation system, an operational condition of the solid-liquid separation system.

Although some embodiments described herein may analyze (e.g., volumetrically analyze) drilling fluid in cuttings exiting a wellbore using mass flow sensors, such mass flow sensors may not distinguish between drilling fluid and drilling solids, and hence may only indicate a volume and/or volume percentage passing through a flow line at a particular measurement point. However, by using acceleration sensors to measure a change in acceleration of a portion of a solid-liquid separation system while separating a liquid-solid mixture, some embodiments described herein may gravimetrically measure the slurry exiting the wellbore.

Based on a measurement of acceleration of a portion of a solid-liquid separation system, (e.g., a vibratory shaker, a centrifuge, etc.), a processor circuit may determine a change in a load percentage of a component of a solid-liquid separation system. In some examples, a load percentage may be an expression of a percentage of a predetermined total load that may be processed by a portion of solid-liquid separation system. For example, a vibratory shaker may have a predetermined load limit, beyond which a change in acceleration of a measured portion of the vibratory shaker may not indicate an increase in a load being processed by the solid-liquid separation system. Continuing with this example, based on a measurement of acceleration of a portion of a vibratory shaker, a processing circuit may determine that the vibratory shaker is experiencing a load that is 70% of the predetermined load limit. Hence, the processing circuit may determine that the vibratory shaker is experiencing a load percentage of 70%.

There may be a calculable relationship between a measured acceleration of a component of a solid-liquid separation system and a load percentage of the component of the solid-liquid separation system. For example, there may be an inverse relationship between measured acceleration and load percentage, such that (1) when measured acceleration increases, load percentage decreases, and/or (2) when measured acceleration decreases, load percentage increases.

Furthermore, changes in a load percentage of a component of a solid-liquid separation system may indicate an operational condition of the solid-liquid separation system. When the load percentage increases, this increase may indicate an increase in mass of a liquid-solid mixture on a screen deck of a vibratory shaker. This increased mass may indicate a number of operational conditions of the vibratory shaker. For example, this increase may indicate that the solid liquid separation system is currently separating material, the liquid solid mixture is associated with a well experiencing a forced fluid flow, a component of the liquid solid mixture has a water content higher than a predetermined threshold, and so forth. Hence, a processor circuit may identify an operational condition of the component of the solid liquid separation system as at least one of (1) the solid liquid separation system is separating material, (2) the liquid-solid mixture is associated with a well experiencing a forced fluid flow, (3) a component of the liquid-solid mixture has a water content higher than a predetermined threshold, (4) a method of conveyance of cuttings away from the solid-liquid separation system has changed from a first method of conveyance to a second method of conveyance, (4) more than a threshold amount of solid material is adhering to the vibratory shaker, a sweep (i.e., a viscous pill circulated within a wellbore to help clear the wellbore of cuttings or debris) is moving from an initial position (i.e., within the well) to a secondary position (i.e., outside of the well).

Likewise, a decrease in a load percentage may indicate a decrease in mass of a component of a liquid solid mixture on a screen deck of a vibratory shaker. This decreased mass may indicate additional or alternative operational conditions of the vibratory shaker. For example, a decrease in a load percentage of a vibratory shaker may indicate that a component of the liquid solid mixture is associated with a well that has been inadequately cleaned, a circulation metric of at least one of the solid liquid separation system or the well is below a predetermined circulation threshold, or the solid liquid separation system is in an inoperative state while receiving the liquid solid mixture.

Hence, upon determining a decrease in load percentage, a processing circuit may identify and/or determine, based on the decreased load percentage, an operational condition of a component of the solid liquid separation system including at least one of (1) a component of the liquid-solid mixture is associated with a well that has been inadequately cleaned, (2) a circulation metric of at least one of the solid-liquid separation system or the well is below a predetermined circulation threshold, or (3) the solid-liquid separation system is in an inoperative state while receiving the liquid-solid mixture.

In some examples, as described above, the systems and methods described herein may generate control signals and/or provide control signals to one or more components of a solid liquid separation system to cause changes in operational parameters of the components of the solid liquid separation system. A measured acceleration and/or a determined change in a load percentage may similarly cause a processor circuit to generate a control signal based on the measured acceleration and/or the determined change in the load percentage, and provide the control signal to a component of the solid liquid separation system (e.g., the vibratory shaker, the centrifuge, etc.) to thereby cause a change in an operational parameter of the solid-liquid separation system.

A processor circuit may generate a control signal based on a measured acceleration in a variety of contexts. For example, the processor circuit may determine a relationship between the measured acceleration and the operational parameter such that a change in the operational parameter causes a change in the measured acceleration. The processor circuit may therefore generate a control signal such that the control signal causes a change in the operational parameter to thereby cause a change in the measured acceleration to reduce a difference between the measured acceleration and a predetermined target value of the measured acceleration. In some examples, as described above, an operational parameter of a vibratory shaker may include (1) a screen angle, (2) a shape of vibratory motion, (3) an amplitude of vibratory motion, (4) and/or a frequency of vibratory motion.

In additional or alternative examples, as described above, a processor circuit may, based on a measured acceleration, generate a control signal to cause changes in operational parameters of a component of the solid liquid separation system to minimize a cost metric that depends on a dilution cost, a disposal cost, an energy cost, a screen replacement cost, a maintenance cost, an NPT cost, and so forth.

As mentioned above, one or more of the systems described herein may use one or more machine learning algorithms to determine trends and associations. For example, analyzer module 2910 may parse mud data reports stored in data store 2816 and may determine trends, anomalies, and patterns that may be used to improve operating efficiency of one or more drilling rigs.

Machine learning models may provide increasingly important and accurate ways of making predictions based on given input data. Generally, machine learning algorithms build a model based on sample data, also called training data, in order to make predictions or decisions without being explicitly programmed to do so. Machine learning approaches may be divided into three broad categories including supervised learning, unsupervised learning, and reinforcement learning. Supervised learning algorithms may build a mathematical model of the set of data that contains both input and desired outputs. Unsupervised learning algorithms may take a set of data that contains only inputs, and find structure in the data, like grouping or clustering of data points. Reinforcement learning may generally be concerned with how intelligent agents ought to take actions in an environment in order to maximize a cumulative reward. Reinforcement learning may differ from supervised learning in not requiring labeled training data and in not requiring explicit correction when performing suboptimal actions.

The systems and methods described herein may employ a variety of machine learning algorithms to make predictions and/or decisions based on data received from various sensors associated with one or more drilling rigs. FIG. 38 is a block diagram of an example system 3800 that may train a machine learning model to make predictions and/or decisions based on data received from various sensors associated with one or more drilling rigs.

As shown in FIG. 38, system 3800 includes analyzer module 2910. As described above, analyzer module 2910 may parse mud report data stored in data store 2816 and determine trends, anomalies, and patterns that may be used to improve operating efficiency of one or more drilling rigs. Data store 2816 may also store AI model training data 3802 and AI model training parameters 3804.

In some examples, AI model training data (e.g., AI model training data 3802) may include any data set input into a training algorithm and used to train an AI model, such as training data sets, validation data sets, and/or test data sets. Likewise, in some embodiments, an AI model training parameter (e.g., AI model training parameters 3804) may include any value, setting, parameter, and so forth associated with an AI model that may be predetermined in advance of a training process.

In AI and/or machine learning contexts, a model may be defined and/or represented by model parameters. Training parameters may include parameters that may control the learning process. In some examples, training parameters may be referred to as “hyperparameters” in that they may influence and/or control the learning process and model parameters that may result therefrom. Training parameters may be determined (e.g., selected by a user, determined as a result of a selection process, etc.) in advance of training of the model. In some examples, training parameters and/or hyperparameters may be considered external to an AI model because, while used by a learning algorithm, they may not be included as part of a resulting trained model. Examples may include, without limitation, a train-test split ratio, a learning rate in optimization algorithm (e.g., gradient descent), a choice of optimization algorithm (e.g., gradient descent, stochastic gradient descent, Adam optimizer, etc.), a choice of activation function in a neural network layer (e.g., sigmoid, ReLU, tanh), a choice of cost or loss function, a number of hidden layers in a neural network, a number of activation units in each layer, a dropout probability, a number of iterations or epochs in training of a neural network, a number of clusters in a clustering task, a kernel or filter size in a convolutional layer, a pooling size, a batch size, and so forth.

One or more of the systems described herein (e.g., analyzer module 2910) may therefore receive AI model training data 3802 and AI model training parameters 3804. In this context, AI model training data 3802 may include any suitable information that, when analyzed by analyzer module 2910 in accordance with a machine learning model and AI model training parameters 3804, may result in a trained model 3806, a machine learning model trained to identify trends in well performance. For example, AI model training data 3802 may include one or more drilling fluid reports, mud data extracted from one or more drilling fluid reports, standardized mud data, and so forth. In some examples, AI model training parameters 3804 may be any values, statements, parameters, hyperparameters, directives, and/or analytical methodologies predefined to generate a trained machine learning model (e.g., trained model 3806) from AI model training data 3802.

Hence, in at least one embodiment, one or more of the systems described herein may acquire a plurality of drilling fluid reports. Each drilling fluid report may be associated with a different well in a plurality of wells (e.g., a field). One or more systems may parse the drilling fluid reports to extract mud data, may standardize the mud data, and may include a standardized mud data in a set of field mud data. One or more of the systems described herein (e.g., analyzer module 2910) may then use the set of field mud data as at least part of AI model training data 3802 and may use AI model training data 3802 model training parameters 3804 to generate (e.g., train) trained machine learning model 3806. In this example, trained machine learning model 3806 may thereby be trained to identify trends in well performance based on the set of field mud data acquired, extracted, generated, and/or parsed from the plurality of drilling fluid reports.

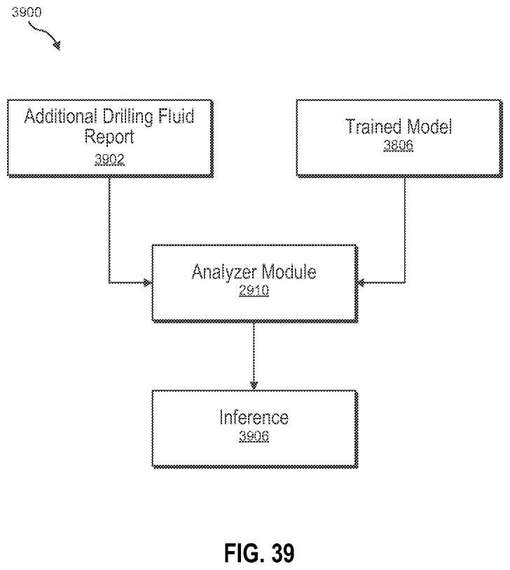

Once a suitable AI model has been trained to identify trends in well performance, the trained model may be employed to make predictions and/or recommendations regarding identified trends in well performance. FIG. 39 includes a system 3900 that may identify trends in well performance by making inferences from an additional drilling fluid report 3902 using trained model 3806. In this example, additional drilling fluid report 3902 may be used as input (also referred to as feature inputs) to trained model 3806. Additional drilling fluid report 3902 may not have been included as part of AI model training data 3802. In other words, additional drilling fluid report 3902 may represent data not used to train trained model 3806, and hence may represent data unseen by trained model 3806 prior to analysis by analyzer module 2910.

As described above, analyzer module 2910 may acquire additional drilling fluid report 3902, may parse the additional drilling fluid report to extract additional mud data, and may standardize the additional mud data in any of the ways described herein. Analyzer module 2910 may further identify at least one trend in well performance by analyzing the additional mud data in accordance with trained machine learning model 3806. Inference 3906 may represent an identified trend in well performance. Thus, analyzer module 2910 may identify the trend in well performance by making an inference 3906 from additional drilling fluid report 3902 using trained model 3806.

One or more of the systems described herein (e.g., interaction module 2912, financial module 2916, etc.) may then determine, based at least in part on the identified trend in well performance, at least one recommendation on improving the well performance by at least one change to at least one operating parameter of a solid liquid separation system, and may provide the recommendation via an output interface device.

As with other embodiments described herein, the recommendation on improving the well performance may include a recommendation that reduces a cost metric. The cost metric may depend on at least one cost including, without limitation, a dilution cost, a disposal cost, and energy cost, a screen-replacement cost, a maintenance cost, and a nonproductive time cost.

While training of a machine learning model as described herein may generally occur prior to an inference process using the trained machine learning model, the training process may be iterative, and may incorporate additional information acquired after an initial training process. Hence, one or more of the systems described herein (e.g., analyzer module 2910, interaction module 2912, etc.) may receive an input associated with a performance metric of a well associated with an additional drilling fluid report (e.g., additional drilling fluid report 3902), and may retrain a machine learning model (e.g., trained model 3806) based on the received input and the additional drilling fluid report. For example, a user may provide input indicating a particular operational parameter, condition, and/or other data associated with a well associated with additional drilling fluid report 3902, and analyzer module 2910 may retrain (e.g., modify one or more parameters associated with) trained model 3806 based on the input associated with the performance metric of the well associated with additional drilling fluid report 3902.

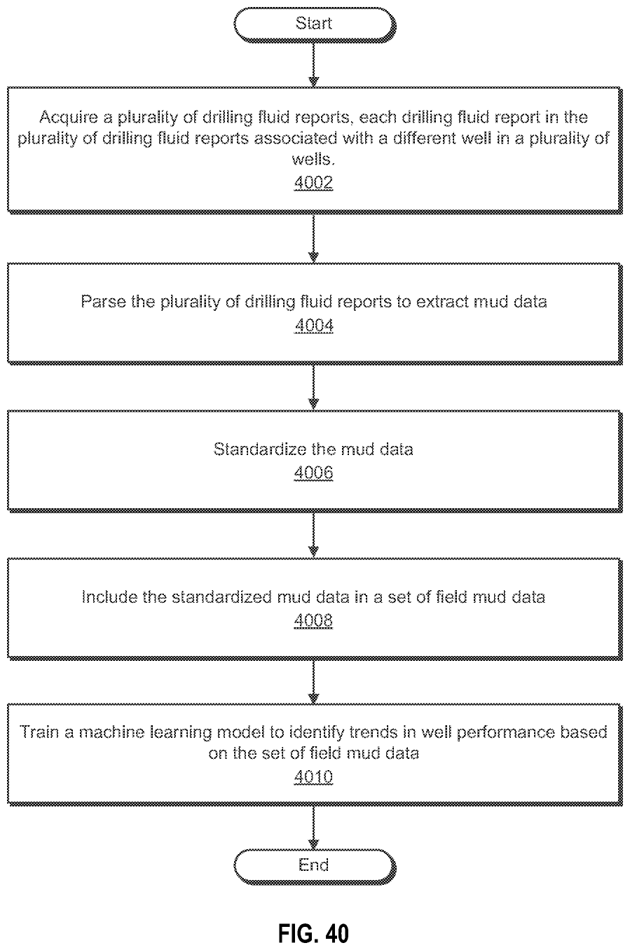

FIG. 40 illustrates an example process flow 4000 for the system according to some embodiments. At block 4002, the system acquires a plurality of drilling fluid reports. Each drilling fluid report may be associated with a different well in a plurality of wells (e.g., a field). The drilling fluid reports may be acquired at regular intervals, such as once a day, multiple times a day, or some other regular or non-regular interval. The drilling fluid reports may be sent by a mud engineer, or some other person associated with a drilling operation. The drilling fluid reports may be automatically generated, such as by sensors coupled to the drilling equipment. The drilling fluid reports may be manually generated, and in some cases, the drilling fluid reports may be a combination of automatically generated data and manually obtained data. The drilling fluid report may be acquired through any suitable process, such as by receiving an electronic file, pulling data from one or more sensors, through email, through accessing a data store over a network, or any other suitable method.

At block 4004, the system parses the plurality of drilling fluid reports to extract mud data. This may include opening an attached file, calling an API to extract data, performing natural language processing or semantic processing on the data, or any other suitable process.

At block 4006, the system standardizes and/or normalizes the data. In some cases the data may come from different sources, be in different formats, include different tags, identifiers, or semantics, or may be associated with different well types and/or sizes. In these cases, the data may be standardized, such as by applying a taxonomy to the data and/or assigning standardized tags to the data for categorization. In some cases, the data may be normalized such as to account for different well lengths so that the data may be compared against data from other wells in a meaningful way.

At block 4008, the standardized mud data may be agglomerated into a set of field mud data that may represent data acquired from a plurality of wells, such as may be included in a drilling field that may encompass a variety of terrain, geologic features, and/or operating conditions.

At block 4010, the system may train a machine learning model to identify trends in well performance based on the set of field mud data. As described in greater detail above, the system may use the set of field mud data as input, along with any suitable training parameters, to generate a trained machine learning model. This trained model may be used to make inferences and/or predictions regarding trends in well performance based on the set of field mud data. The system may train the machine learning model in any suitable way, such as in any of the ways described herein. Although not shown in FIG. 40, as described above, any of these operations may be repeated using new and/or additional drilling fluid reports and/or any performance metrics of a well associated with additional drilling fluid reports in order to update and/or retrain the machine learning model.

Embodiments described herein improve the technology of oil drilling, and in particular, some embodiments are designed to specifically improve solids control in drilling mud. The systems may acquire mud reports which may be parsed, tagged, stored, and analyzed by any of a number of machine learning algorithms. The machine learning algorithms may analyze the stored data for trends, cause and effect relationships, and determine ways to improve the solids control on one or more drilling rigs. This improvement in well efficiency by relying on artificial intelligence results in lower environmental impacts, less waste, less power required, increased production, more efficient well operation, and substantial cost savings. The described systems provide a feedback loop to detect and compare fluid and waste disposal metrics, mud properties, and differentiate solids control setups.

Embodiments described herein perform data collection and real-time analysis including expanded use of AI. In an embodiment, there is a focus for automated data driven decisions to optimize the drilling process. The goal of which is to increase safety, drilling speed, and quality of the drilled well while reducing construction and completion costs. Currently, data-based optimization systems typically focus on what is happening down hole and may utilize data that can be collected and observed at the surface, such as various drilling fluid properties. Typically, the collected data is tracked and compared to the drilling plan, and any deviations from the drilling plan are used adjust the well plan for the next well.

To date, there has been no focus on the collection or analysis of data relating to the processing of drill cuttings and drilling fluid that is coming out of the hole while drilling operations on ongoing. Cameras have been used to help the drillers see the solids in real-time. However, due to the hazardous environment, cameras have not been reliable, requiring constant cleaning and maintenance.

Vibratory screening machines, commonly referred to as shakers, are the first line of defense for effective solids control. There an industry focus on measuring and ensuring highly effective drilled solids removal from drilling fluid. Solids Removal Efficiency (SRE) is related to effective drilling fluid property management and thus efficient drilling, which is a function of hole cleaning, bit lubrication, drilling torque management, increased ROP, etc. API RP 13C is the industry recommended best practice for measuring and determining SRE. This method requires several physical tests and inputs on a given interval in order to yield a historical look back at solids removal for that interval. Decisions that are made based on this method tend to be reactive rather than proactive, as the data is analyzed only after an interval is already completed.

Carrying Capacity Index (CCI) is the product of angular velocity, density, and a viscosity constant (K derived from Power Law) divided by 400,000. In a near vertical well (deviation of less than 35 degrees) a CCI greater than 1 indicates effective hole cleaning. In highly deviated wells and horizontal wells, this equation doesn't apply.

Drillers typically rely on common industry knowledge and decision-making flowcharts to identify hole cleaning issues before they experience problems. It is up to the on-site individuals to identify, or suspect hole cleaning issues by piecing together various data, trends of down hole parameters and observed drilling behaviors. Often the identification of poor hole cleaning is realized only after problems occur, such as a stuck pipe or not getting well casing to the bottom.

Existing decision-making flowcharts may require observation of drill cuttings that are being delivered to the vibratory screening machine(s). This requires an individual to observe the drill cuttings and drill fluid flow to the vibratory screening machines over an extended period of time. The individual then estimates a percentage of increase or decrease of the flow over time, and the estimate is used as input to the decision-making flowchart. This qualitative measurement is completely reliant on the observer's judgment and experience. Moreover, it only captures a gross change in the flow rate over time, not short-term changes or fluctuations.

There is a need within the drilling industry to better measure and understand hole cleaning effectiveness during drilling in order to predict the future occurrence of potential drilling issues such as a stuck pipe, tight hole conditions, issues getting casing to bottom, etc. Due to the increased lengths of horizontal wells being drilled today and the speed at which they are being drilled, timely problem detection and prediction is essential. As noted above, a critical data point in the driller's problem avoidance decision matrix is the effectiveness of cuttings removal. To achieve a better understanding of the effectiveness of cuttings removal, there is a need for a more quantitative, continuous, consistent, and accurate measurement of cutting flow to the vibratory screening machine(s). Once more accurate and detailed data has been collected on cutting removal, it becomes possible to better determine when an actual problem with cutting removal has occurred and/or whether the data indicates the potential for a future drilling issue to arise. That, in turn, makes it possible to take proactive steps to avoid a potential drilling problem.

To address this need and provide better information for decision-making, the present disclosure is directed to the use of a data trends analyzer 4110 that collects data from the solids processing system and the drilling rig, and that uses that data to identify existing or potential future problems or issues with drilling operations. In particular, trends in the collected data can be used to help predict the onset of a problem or abnormal operating condition.

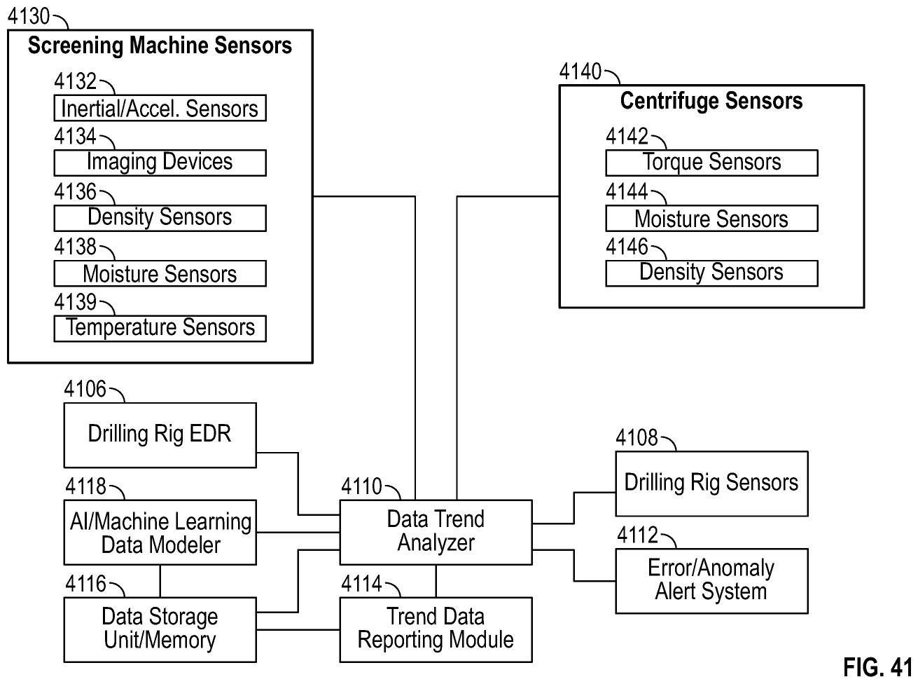

FIG. 41 illustrates elements of an overall system used to gather data and identify existing and/or potential problems in a well drilling operation. As illustrated therein, a variety of different sensors can be used in connection with vibratory screening machines and centrifuges of a solids processing system to determine the conditions being experienced by the solids processing system. For example, the vibratory screening machine sensors 4130 could include one or more inertial sensors 4130, such as accelerometers, that are mounted on one or more vibratory screening machines used to process drilling cuttings and fluid. Data reported by the inertial sensors 4130 could be used to determine the loading currently being experienced by the one or more vibratory screening machines.

The vibratory screening machine sensors 4130 could also include imaging devices 4134. The imaging devices 4134 could capture images based on visible light or based on infrared or ultraviolet radiation. The images produced by the imaging devices 4134 also could be used to determine loading on the vibratory screening machines. Such images also could provide information about various physical properties of the cuttings and fluid materials that are being deposited on the screening machines, such as temperature. Moreover, such images may include data indicative of the overall composition of the materials that are being screened, such as a solids-to-fluid ratio, as well as other properties of the materials.

The vibratory screening machine sensors 4130 could also include density sensors 4136, moisture sensors 4138 and temperature sensors 4139, all of which are capable of detecting various physical properties of the materials being delivered to the vibratory screening machines for processing. Information derived from these sensors can be used to help determine whether there is an existing or potential future drilling problem. Information derived from these sensors also could be used to help determine subsurface conditions in the drilled well, such as the composition of the material recently removed by the drill bit.

The solids processing system may also include one or more centrifuges that process the fluids and fine solids that pass through the screens of the vibratory screening machine to further separate the fluids from the fine solids. In that case, a variety of sensors could be installed on the centrifuges. The centrifuge sensors 4140 could include torque sensors 4142. Data from the torque sensors 4142 could be used to help determine the load currently being experienced by the centrifuges.

The centrifuge sensors 4140 could also include moisture sensors 4144 and density sensors 4146. Information derived from these sensors also could be used to help determine whether there is an existing or potential future drilling problem. Moreover, information derived from these sensors also could be used to help determine subsurface conditions in the drilled well, such as the composition of the material recently removed by the drill bit.

The foregoing examples of screening machine sensors 4130 and centrifuge sensors 4140 are examples. A variety of other types of sensors could also be used on the vibratory screening machines and centrifuges to help determine the conditions being experienced by the solids processing system and to help identify the characteristics and composition of the materials being processed by the solids processing system. Thus, the foregoing examples should in no way be considered limiting.

A data trend analyzer 4110 uses data generated by the screening machine sensors 4130 and information reported by a drilling rig electronic data recorder (EDR) 4106 to help determine if there is an existing or potential future problem with the drilling operation. In some embodiments, data from the centrifuge sensors 4140 could also be used alone or together with the data from the screening machine sensors 4130 to help determine if there is an existing or potential future problem with the drilling operation. In some instances, the data trend analyzer 4110 may also utilize information or data reported by one or more drilling rig sensors 4108 to help determine if there is an existing or potential future problem with the drilling operation.

The data trend analyzer 4110 may be embodied in a SCADA controller (e.g., a programmable logic controller). Communications between the data trends analyzer 4110 and the screening machine sensors 4130, the centrifuge sensors 4140, the drilling rig EDR 4016 and the drilling rig sensors 4108 could be implemented via cables, via wireless communications or via some combination of both.

The signals produced by the screening machine sensors 4130, the centrifuge sensors 4140 and the drilling rig sensors 4108 may be pre-processed by a separate monitoring and control system, such as the ones described above. In that case, the signals received by the data trend analyzer 4110 may directly indicate the conditions currently being experienced by the solids processing system, such as loading, as well as indicate various characteristics of the materials being processed by the solids processing system.

The data that the data trend analyzer 4110 receives data from the drilling rig's EDR system 4106 can include the drill string torque, the rate of penetration (ROP), a pumping rate, the RPM of the drill string and/or cutting bit(s), the differential pressure of the mud motor, standpipe pressure, the weight on the drill bit(s) and data from one or more flow sensors, as well as a variety of other data items. In some embodiments, one or more drilling rig sensors 4108 may report one or more of these data items directly to the data trend analyzer 4110.

The data trend analyzer 4110 uses the received information to determine whether drilling operations appear to be proceeding normally, or whether the data indicates an abnormal drilling condition has occurred or might be imminent. The data trend analyzer 4110 makes these determinations by comparing the current set of reported data and trends in the reported data to models that are indicative of abnormal drilling conditions or drilling conditions that tend to indicate that a problem is likely to soon occur.

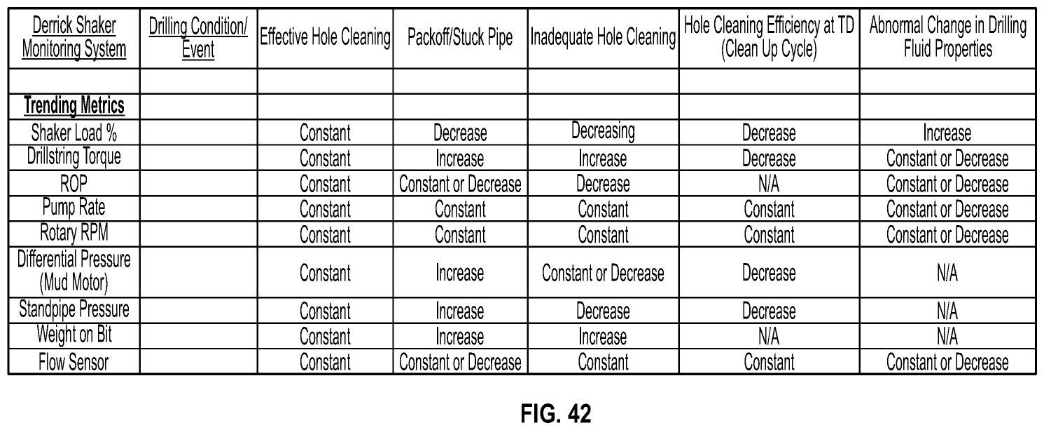

FIG. 42 provides a table of multiple different types of information or data that can be received by the data trend analyzer 4110, and the abnormal drilling conditions that are indicative of certain combinations of data trends. For example, if the data trend analyzer 4110 determines that when all of the received data is basically remaining relatively constant over time, that typically indicates that the drilling operations are proceeding normally.

However, if the load on the vibratory screening machines that are processing the drilling cuttings and drilling fluid is decreasing at the same time that the drill string torque is increasing and/or that one or more of the differential pressure, standpipe pressure and the weight on the drill bit(s) is increasing, this could indicate that there is a packoff or a stuck pipe. Similar sets of data trends are provided in the table illustrated in FIG. 42 to indicate abnormal drilling conditions relating to inadequate hole cleaning, hole cleaning efficiency at TD and abnormal changes in the drilling fluid properties. The data trends and abnormal drilling conditions provided in FIG. 42 are only examples. Data trends for a variety of other abnormal drilling conditions could also be used to determine when those other abnormal operating condition have arisen or are imminent. Thus, the depiction in FIG. 42 should in no way be considered limiting.

When the data trend analyzer 4110 determines that an abnormal drilling condition may be occurring or may be imminent, the data trend analyzer 4110 reports the abnormal condition to an error/anomaly alert system 4112. The error/anomaly alert system 4112 alerts drilling rig operators of the real or potential problems so that corrective actions can be taken to cure an existing problem, or to alter operations to avoid the occurrence of a problem that may be imminent. An alert given to the operators could include a recommended course of action to cure an existing problem or to head off a potential future problem.

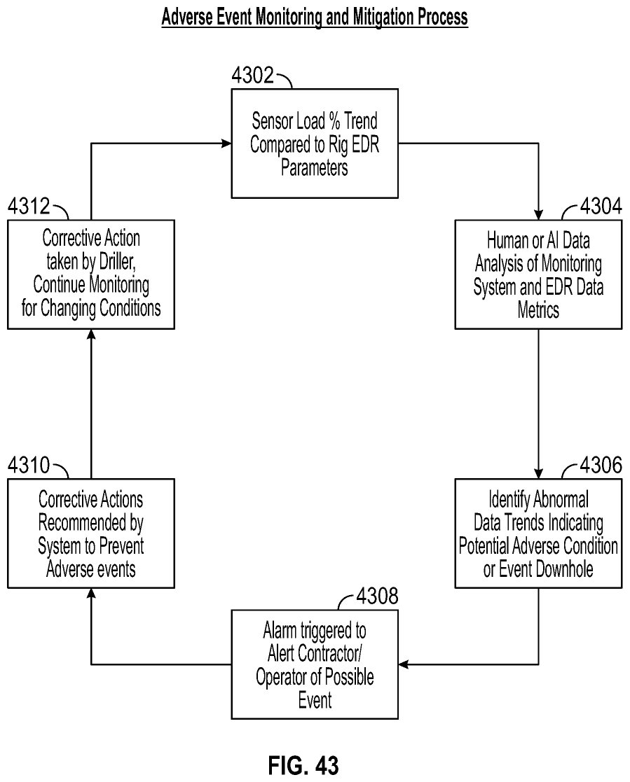

FIG. 43 illustrates how the overall cycle of analysis and corrective actions would occur. As illustrated in FIG. 43, in block 4302 the data trend analyzer 4110 receives data reported from a drilling rig's EDR and/or drilling rig sensors as well as data from a solids processing system, such as data generated by screening machine sensors 4130 and/or centrifuge sensors 4140. In block 4304 either a human or the data trend analyzer 4110 analyzes the reported data. In block 4306 a human or the data trend analyzer 4110 determines whether an abnormal condition has occurred and/or whether the data indicates that an abnormal condition is likely to soon occur. This can include identifying the specific type of abnormal condition. In block 4308 an alarm is triggered when an abnormal condition has occurred or is likely to soon occur, and the alarm is provided to one or more of the individuals responsible for operating the drilling rig. In block 4310 the data trend analyzer 4110 or other elements of a monitoring and reporting system may generate and provide to the drilling rig operators a list of specific steps that the drilling rig operators could take to help mitigate or cure an abnormal condition or to prevent one from occurring. In step 4312, the drilling rig operators take steps to mitigate or cure the abnormal condition. This could include the steps recommended in block 4310, and/or alternate or additional steps.

The cycle illustrated in FIG. 43 is continuously performed while drilling operations are ongoing so that any abnormal conditions that have occurred or that might be imminent can be dealt with as rapidly as possible. This helps to cure problems as soon as they arise and also to cure conditions that could lead to abnormal operations or problems before they actually occur.

As illustrated in FIG. 41, the data trend analyzer 4110 may also interact with a data trend reporting module 4114 that can issue various reports regarding data trends. Such reports may also be used by drilling rig operators to spot potential problems or abnormal conditions or to identify trends in the data that are indicative of problems that are about to occur. The trend data reporting module 4114 can process data and generate reports in a variety of different formats that make it easy for humans to read, understand and analyze the data.

The data trend analyzer 4110 also reports data that it has collected from the drilling rig EDR 4106, drilling rig sensors 4108 and data from the drilling fluid processing system such as data reported by the screening machine sensors 4130 and/or centrifuge sensors 4140 to a data storage unit or memory 4116. This data can later be accessed by the trend data reporting module 4114 to generate reports.

As illustrated in FIG. 41, an artificial intelligence (AI) or machine learning data modeler 4118 may also be provided to help analyze and model the data being gathered and analyzed by the data trend analyzer 4110. This can include developing one or more models or algorithms that use data from the drilling rig EDR 4106, drilling rig sensors 4108, the screening machine sensors 4130 and/or the centrifuge sensors 4140 to identify or predict anomalous drilling conditions and/or specific problems in a drilling rig. The AI/machine learning data modeler 4118 can access data from the data storage unit/memory 4116 to use as training data and also to use in identifying a currently occurring or imminent abnormal condition.

In some embodiments, the AI/machine learning data modeler 4118 could obtain and use data reported from multiple different drilling rigs and wells to develop and train data models used to identify and predict anomalous drilling conditions and problems. In some instances, an AI/machine learning data modeler 4118 may develop a first model for wells in a first geographical area and develop a second, different model for wells in a second geographical area. Multiple different systems monitoring the conditions at multiple different wells could all use the services of a single AI/machine leaning data modeler 4118. Thus, the depiction in FIG. 41 should in no way be considered limiting.

An AI/machine learning data modeler 4118 could be effective at spotting data trends indicative of anomalous drilling conditions or problems that would not be apparent to a human. Thus, the data trend analyzer 4110 may utilize the services of the AI/machine learning data modeler 4118 to help identify anomalous conditions or problems that are then reported to the error/anomaly alert system 4112.

One way that the data trend analyzer 4110 can identify actual or potential future problems is by comparing the drilling operations data recorded in the drilling rig EDR 4106 to the conditions being experienced by the solids processing system. Changes in the conditions being experienced by the solids processing system should correlate to drilling operations performed by the drilling rig. If there is a discrepancy between the drilling rig operations that are occurring and the conditions being experienced by the solids processing system, the discrepancy could be indicative of an actual or potential future problem in the drilling operations. If an algorithm being run by the data trends analyzer 4110 indicates that an actual or potential problem exists, the data trend analyzer 4110 can cause an alert to be issued by the error/anomaly alert system 4112.

There will be a time delay between when cuttings are generated at a drill bit and when those cutting arrive at the vibratory screening machines for processing. That time delay will lengthen over time as the well is drilled progressively deeper. By comparing the drilling data that corresponds to the cuttings currently being processed by the vibratory screening machines, one can determine if there is an actual or potential problem. This requires comparing the conditions currently being experienced by the solids processing system, such as the current loading on the vibratory screening machines, to drilling data for drilling events/operations that occurred in the past when the cuttings currently being processed by the solids processing system were being cut.

As a well is drilled, the time for solids to be returned to surface increases as a function of volume and circulation rate. This time lag between the point in time when cuttings are produced at the drill bit and the point in time at which the cutting arrive at the surface for processing by the solids removal system is called “time-to-surface” and can be upwards of 1.5 to 2 hrs. This time-to-surface interval must be accurately taken into account in order to correlate the drilling operations that occurred when cuttings were generated at the drill bit to the conditions experienced by the solids processing system when those cuttings are processed.

In an embodiment, the data trend analyzer 4110 can utilize a sweep detection algorithm to determine when a sweep occurred. The sweep detection algorithm may apply a logistical regression to identify sweeps. An increase in vibratory screening machine load that is more than a predetermined threshold above a rolling average load, when all else is constant, typically indicates a sweep occurred. Because of the time lag for cuttings to arrive at the vibratory screening machines, if a sudden increase on the vibratory screening machines is noted, indicative of a sweep, the sweep would have occurred at the present time minus the “Time-To-Surface” interval.

One can predict the time that a sweep occurred by noting the time when there is a sudden increase in the load on the vibratory screening machines, and then subtracting the time-to-surface interval from the current time. The data trends analyzer 4110 can then examine the data from the drilling log to determine whether a sweep was recorded at the predicted time. If the drilling log does not indicate a sweep occurred at the predicted time, the sudden increase in the load on the vibratory screening machines must be due to some other factor and may be indicative of an actual or potential problem.

Alternatively, the data trend analyzer 4110 could examine the drilling log to determine when a sweep was recorded. The data trend analyzer could then predict the time at which one would expect the load on the vibratory screening machines to increase. The predicted time would be the time at which the sweep was recorded, plus the time-to-surface interval. The data trend analyzer 4110 could then monitor the loading of the vibratory screening machines to ensure that the load on the screening machines increases at the predicted point in time. If there is no increase in the load on the vibratory screening machines at the predicted time (time of actual sweep plus the time-to-surface), this too may be indicative of an actual or potential problem. At a minimum, it probably indicates that the sweep was ineffective.

Another common drilling operation is called a connection. A connection occurs when a new section of pipe is added to the drill string. While a connection is occurring and a new section of pipe is being added to the drill string, no cutting is occurring. Thus, one would expect there to be a period of time corresponding to the connection at which no cuttings are arriving at the surface, or only minimal cuttings are arriving at the surface. Of course, the period when no or only minimal cuttings are arriving at the vibratory screening machines will occur at a point in time that is delayed from the actual connection by the current time-to-surface.

The data trend analyzer 4110 can detect when the load on the vibratory screening machines falls lower than a threshold amount relative to an average load. When that occurs, the data trend analyzer 4110 will assume that a connection occurred. The data trend analyzer 4110 then predicts the time at which the connection should have occurred (current time minus the time-to-surface). The data trend analyzer 4110 then checks the drilling log to ensure that a connection occurred at the predicted point in time. If the drilling data indicates that no connection occurred at the relevant point in time, then the data trend analyzer 4110 may provide an alert of an actual or potential problem.

Conversely, if the drilling data indicates a connection occurred at a particular point in time, and there is no corresponding decrease in the load on the vibratory screening machines at the time corresponding to the connection (time of connection plus the time-to-surface interval), this too could be indicative of an actual or potential problem.

The data trend analyzer 4110 can be configured to analyze the conditions being experienced by the solids processing system to determine when the data is indicative of a specific drilling operation. The data trend analyzer 4110 uses the current time-to-surface to estimate when the identified drilling operation would have occurred. The data trend analyzer 4110 then compares the identified drilling operation and the estimated time of occurrence to the actual drilling data to ensure everything matches up. If there are any inconsistencies, an alert regarding an actual or potential may be issued.

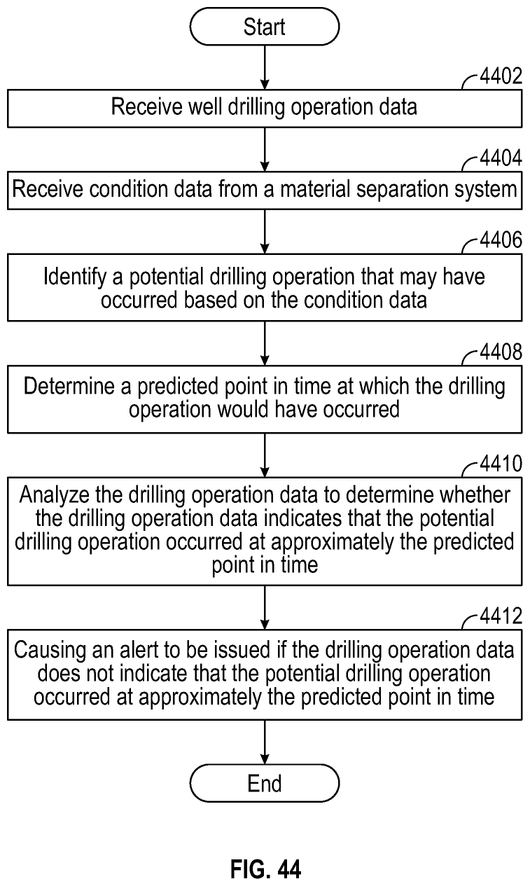

FIG. 44 illustrates steps of a first method for identifying when an actual problem has arisen or when a potential future problem may occur in a well drilling operation. The method begins and proceeds to step 4402 where a data trend analyzer 4110 receives well drilling operation data from a drilling rig electronic data recorder 4106 and/or from drilling rig sensors 4108. In step 4404 the data trend analyzer 4110 receives condition data reported by sensors 4130/4140 of elements of a material separation system.

In step 4406 the data trend analyzer 4110 identifies a potential drilling operation that may have occurred based on the received condition data. In step 4408 the data trend analyzer 4110 determines a predicted point in time at which the drilling operation would have occurred, which takes into account the current time-to-surface interval. In step 4410 the data trend analyzer reviews the drilling operation data to determine if a drilling operation that correlates to the potential drilling operation identified based on the condition data, and to determine if that drilling operation occurred at approximately the predicted point in time. If so, the method ends. If the check performed in step 4410 indicates that there is no recorded drilling operation at approximately the predicted point in time, then in step 4412 and alert is issued to the drilling operators. The alert could identify the discrepancy. The alert might also recommend a course of corrective action based on the determined discrepancy.

Similarly, the data trend analyzer 4110 can be configured to monitor the drilling data over time. When certain drilling operations occur, the data trend analyzer 4110 can predict when the conditions at the solids processing system are likely to change, and what the changes should be. If there is no corresponding change in the conditions being experienced by the solids processing system at the predicted time, an alert regarding an actual or potential problem can be issued.

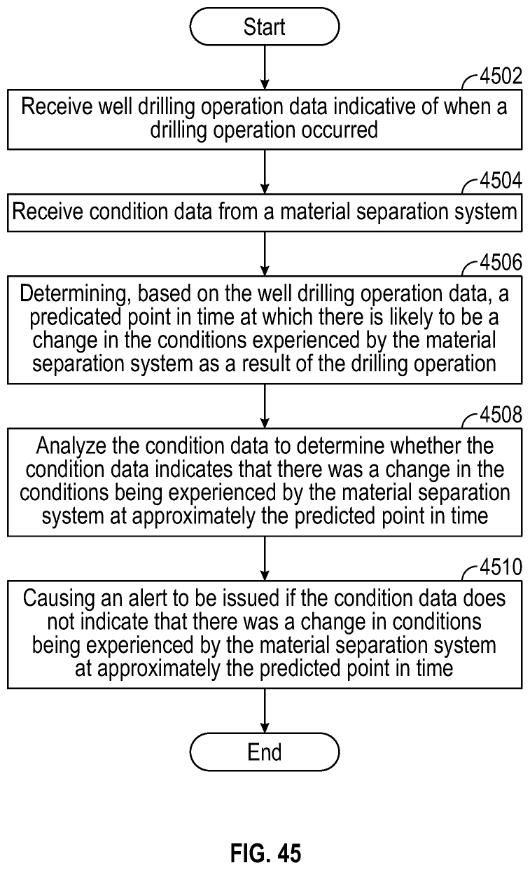

FIG. 45 illustrates steps of a second method for identifying when an actual problem has arisen or when a potential future problem may occur in a well drilling operation. The method beings and proceeds to step 4502 where a data trend analyzer 4110 receives well drilling operation data from a drilling rig electronic data recorder 4106 and/or from drilling rig sensors 4108. In step 4504 the data trend analyzer 4110 receives condition data reported by sensors 4130/4140 of elements of a material separation system.

In step 4506, the data trend analyzer determines, based on the well drilling operation data, a predicted point in time at which there should be a change in the conditions experienced by the material separation system as a result of the well drilling operation. In step 4508 the data trend analyzer determines whether the received condition data indicates the expected change in conditions at approximately the predicted point in time. If so, the method ends. If not, the method includes step 4510 where the data trend analyzer causes an alert to be issued to the well drilling operators indicating that an actual problem may have occurred or that a future problem may be imminent.

In the foregoing examples, the data trend analyzer 4110 used the load being experienced by a material separation system, in combination with information about when certain drilling operations occurred to identify actual or potential future problems in drilling operations. In alternate embodiments, information in addition to loading data could also be taken into account by the data trend analyzer 4110 in identifying current or potential future problems with drilling operations. For example, data from imaging devices 4134, density sensors 4136, moisture sensors 4138 and/or temperature sensors 4139 associated with a vibratory screening machine may also be used by the data trend analyzer 4110 to identify current or potential future drilling problems. Likewise, the data trend analyzer 4110 may also use data reported from torque sensors 4142, moisture sensors 4144 and/or density sensors 4146 associated with a centrifuge to identify current or potential future drilling problems. Moreover, in addition to collecting data on drilling operations from the drilling rig EDR 4106, the data trend analyzer 4110 may also receive and use data from one or more drilling rig sensors 4108 to help identify current or potential future drilling problems.

In an embodiment, the data trend analyzer 4110 may use a hole cleaning efficiency algorithm to examine data reported from various sensors of a solids processing system to identify trending changes in the conditions being experienced by the solids processing system as they relate to drilling parameters like torque, pressure(s), ROP, etc. The basic concept is to use input on actual drilling conditions to predict when and how the conditions being experienced by the solids processing system will change. If there is a difference between expected changes in the conditions and the actual conditions being experienced by the solids processing system, a hole cleaning alert is given.

In some instances, the data trend analyzer 4110 may use both conditions being experienced by the solids processing system, as reflected in the data reported from its sensors, together with data from the drilling rig sensors to identify actual or potential problems. For example, if the data trend analyzer 4110 notes that the load on a vibratory screening machine increases above a rolling average load by a specified threshold amount at the same time that torque on the drill bit increases above an average torque by a threshold amount, the data trend analyzer 4110 may cause an alert to be sent. Note, the data about the load on the vibratory screening machine must be correlated to the data regarding torque on the drill bit using the time-to-surface value. Thus, the data trend analyzer 4110 would be looking for the increase in torque on the drill bit to occur at a first point in time that is before a second point in time at which the load on the vibratory screening machine increases. Those two events would be separated in time by the time-to-surface value, but they would correlate with one another.

In the foregoing description, the data trend analyzer 4110 correlated changes in the conditions being experienced by a solids processing system, such as changes in a load on a vibratory screening machine loading to the occurrences of various drilling operations/events, such as sweeps and connections. The data trend analyzer 4110 could be configured to correlate changes in conditions being experienced by a solids processing system to various other types of drilling operations/events. Thus, the foregoing description should in no way be considered limiting as to the types of drilling operations that could be identified or taken into consideration or the types of alerts that could be issued.

In an embodiment, one or more of the algorithms utilized by the data trend analyzer 4110 may be based on a Linear regression using drilling parameters such as: Drilling Depth, Weight on Bit. Rotary RPM, Convertible Torque, Differential Pressure, Mud Density, Rate of Penetration, Standpipe Pressure and Circulation Rate. Of course other drilling parameters could also be used, so the foregoing list should not be considered limiting.

In an embodiment, the time-to-surface could be proportional to the Current Hole Volume/Average Circulation Rate.

The use of a data trend analyzer 4110 that is configured to correlate conditions being experienced by a solids processing system to various drilling operations/events allows for improved decision making. That is, drillers have better inputs for decision making and/or various decisions may be automated.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The specification and annexed drawings disclose examples of systems, apparatus, devices, and techniques that may provide control and optimization of separation equipment. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A method for determining when an abnormal condition in a well drilling operation may have occurred or may soon occur, the method comprising:
receiving drilling operation data from a well drilling rig that is indicative of when one or more well drilling operations occurred during the drilling of a well;
receiving condition data that is indicative of at least one condition being experienced by a material separation system that processes cuttings generated by the well drilling rig to separate solids from well drilling fluid;
analyzing the condition data to determine when the condition data appears to indicate the occurrence of a first drilling operation and to determine a predicted point in time at which the first drilling operation would have occurred;
determining whether the drilling operation data indicates that a drilling operation corresponding to the first drilling operation identified in the analyzing step occurred approximately at the predicted point in time; and
causing an alert to be issued when the determining step indicates a drilling operation corresponding to the first drilling operation did not occur approximately at the predicted point in time.

2. The method of claim 1, wherein the analyzing step takes into account a time-to-surface time interval to determine the predicted point in time at which the first drilling operation occurred.

3. The method of claim 1, wherein the first drilling operation comprises a connection, and wherein analyzing the condition data comprises determining when the condition data indicates that a loading being experienced by the material separation system falls below an average loading by a threshold amount.

4. The method of claim 1 wherein the first well drilling operation comprises a sweep, and wherein analyzing the condition data comprises determining when the condition data indicates that a loading being experienced by the material separation system rises above an average loading by a threshold amount.

5. The method of claim 1 wherein the determining step comprises determining whether the drilling operation data indicates that a drilling operation corresponding to the first drilling operation identified in the analyzing step occurred within a threshold time period before or after the predicted point in time.

6. The method of claim 1, wherein the condition data is indicative of an acceleration being experienced by a portion of a vibratory screening machine that processes cuttings generated by the well drilling rig to separate solids from well drilling fluid.

7. The method of claim 6, wherein the condition data is received from one or more inertial sensors mounted on a portion of the vibratory screening machine that is vibrated to separate solids from well drilling fluid.

8. The method of claim 1, wherein the condition data is received from one or more sensors configured to detect acceleration of a portion of a machine that separates solids from well drilling fluid.

9. The method of claim 1, wherein the condition data is received from one or more sensors configured to detect density and/or temperature of material in a machine that separates solids from well drilling fluid.

10. The method of claim 1, wherein at least a portion of the condition data is received from one or more image detectors.

11. A method for determining when an abnormal condition in a well drilling operation may have occurred or may soon occur, the method comprising:
receiving drilling operation data from a well drilling rig that is indicative of when one or more drilling operations occurred during the drilling of a well;
receiving condition data that is indicative of at least one condition being experienced by a material separation system that processes cuttings generated by the well drilling rig to separate solids from well drilling fluid;
analyzing the drilling operation data to identify the occurrence of a first drilling operation and to predict a point in time when a change in at least one condition being experienced by the material separation system would likely occur due to the occurrence of the first drilling operation;
analyzing the condition data to determine whether a change in at least one condition being experienced by the material separation system occurred at approximately the predicted point in time; and
causing an alert to be issued when the analysis of the condition data indicates that there was not a change in at least one condition being experienced by the material separation system at approximately the predicted point in time that corresponds to the first drilling operation.

12. The method of claim 11, wherein analyzing the drilling operation data comprises identifying the occurrence of a connection, and wherein analyzing the condition data comprises determining whether a reduction in a loading of the material separation system occurred at the predicted point in time.

13. The method of claim 11, wherein analyzing the drilling operation data comprises identifying the occurrence of a connection, and wherein analyzing the condition data comprises determining whether a loading of the material separation system decreased by more than a threshold amount below an average loading at approximately the predicted point in time.

14. The method of claim 11, wherein analyzing the drilling operation data comprises identifying the occurrence of a sweep, and wherein analyzing the condition data comprises determining whether an increase in a loading of the material separation system occurred at approximately the predicted point in time.

15. The method of claim 11, wherein analyzing the drilling operation data comprises identifying the occurrence of a sweep, and wherein analyzing the condition data comprises determining whether a loading of the material separation system increased by more than a threshold amount above an average loading at approximately the predicted point in time.

16. The method of claim 11, wherein analyzing the drilling operation data includes taking into account a time-to-surface in predicting the point in time when a change in a condition being experienced by the material separation system would likely occur due to the occurrence of the first drilling operation.

17. The method of claim 11, wherein analyzing the loading data to determine whether a change in a condition being experienced by the material separation system occurred at approximately the predicted point in time comprises determining whether the condition data changes in a way that corresponds to the first drilling operation within a threshold time period before or after the predicted point in time.

18. The method of claim 11, wherein the condition data is indicative of an acceleration being experienced by a portion of a vibratory screening machine that processes cuttings generated by the well drilling rig to separate solids from well drilling fluid.

19. The method of claim 18, wherein the condition data is received from one or more inertial sensors mounted on a portion of the vibratory screening machine that is vibrated to separate solids from well drilling fluid.

20. The method of claim 11, wherein the condition data is received from one or more sensors, the one or more sensors comprising sensors configured to detect acceleration of a portion of a machine that separates solids from well drilling fluid.

21. The method of claim 11, wherein the condition data is received from one or more sensors configured to detect density and/or temperature of material in a machine that separates solids from well drilling fluid.

22. The method of claim 11, wherein the at least a portion of the condition data is received from one or more image detectors.

23. A system for determining when an abnormal condition in a well drilling operation may have occurred or may soon occur, comprising:
at least one sensor that is configured to report data indicative of a condition being experienced by a material separation system that processes drilling cuttings from a well drilling operation; and
a data trend analyzer that receives drilling operation data from a well drilling rig that is indicative of when one or more well drilling operations occurred and that receives condition data from the at least one sensor, wherein the data trend analyzer is configured to:
analyze the condition data to determine when the condition data appears to indicate the occurrence of a first drilling operation and to determine a predicted point in time at which the first drilling operation would have occurred;
determine whether the drilling operation data indicates that a drilling operation corresponding to the first drilling operation identified in the analyzing step occurred approximately at the predicted point in time; and
cause an alert to be issued when the determining step indicates a drilling operation corresponding to the first drilling operation did not occur approximately at the predicted point in time.

24. A system for determining when an abnormal condition in a well drilling operation may have occurred or may soon occur, comprising:
at least one sensor that is configured to report data indicative of a condition being experienced by a material separation system that processes drilling cuttings from a well drilling operation; and
a data trend analyzer that receives drilling operation data from a well drilling rig that is indicative of when one or more well drilling operations occurred and that receives condition data from the at least one sensor, wherein the data trend analyzer is configured to:
analyze the drilling operation data to identify the occurrence of a first drilling operation;
predict a point in time when a change in at least one condition being experienced by the material separation system would likely occur due to the occurrence of the first drilling operation;
analyze the condition data reported by the at least one sensor to determine whether a change in at least one condition being experienced by the material separation system occurred at approximately the predicted point in time; and
cause an alert to be issued when the analysis of the condition data indicates that there was not a change in at least one condition being experienced by the material separation system at approximately the predicted point in time that corresponds to the first drilling operation.
